(19) United States
(12) Patent Application Publication
(10) Pub. No.: US 2026/0046082 A1
(43) Pub. Date: Feb. 12, 2026

(54) METHODS, DEVICES, AND MEDIUM FOR COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/100,230

(22) PCT Filed: Aug. 1, 2022
(86) PCT No.: PCT/CN2022/109553

§ 371 Date: Jan. 31, 2025

(51) Int. Cl. H04L 5/00; H04B 7/0456; H04B 7/06; H04W 24/10

(52) U.S. Cl. CPC H04L 5/0048; H04B 7/0456; H04B 7/0626; H04W 24/10

(57) ABSTRACT

Example embodiments of the present disclosure relate to an effective mechanism for processing the CSI reports. In this solution, the terminal device receives, from a network device, at least one configuration for channel state information (CSI) feedback; and transmitting, based on the at least one configuration, the CSI feedback to the network device, the CSI feedback comprising a plurality of partitions with different omission priorities, the plurality of partitions comprising parameters associated with one or more of a plurality of CSI-reference signal (RS) allocations. In this way, the priority rule for reporting the parameters may be updated to adaptable for the scenario where a multi-TRP is supported.

### FIELD

Example embodiments of the present disclosure generally relate to the field of communication techniques and in particular, to methods, devices, and medium for configuring and transmitting the channel state information (CSI) feedback.

### BACKGROUND

In order to meet the increasing wireless data traffic demand, a plurality of schemes have been proposed and implemented, where the multiple input multiple output (MIMO) technology is considered as one powerful scheme to achieve high data throughputs in the communication system. MIMO includes features that facilitate utilization of a large number of antenna elements at a network device (such as, a base station, BS) for both sub-6 GHz and over-6 GHz frequency bands.

Generally speaking, during the communication between the terminal device and the network device, the terminal device needs to report CSI feedback to the network device, such that the network device may understand the network condition and make a more proper subsequent schedule. Further, transmission via more than one transmission reception point (TRP) which also referred to as the multi-TRP transmission is expected to be supported. In case of the multi-TRP transmission, more parameters needed to be reported to the network device compared with single-TRP transmission. Thus, it is desirable to further discuss how to transmit the CSI feedback with more parameters to the network efficiently.

### SUMMARY

In general, embodiments of the present disclosure provide methods, devices and computer storage media of configuring and transmitting the CSI feedback.

In a first aspect, there is provided a method of communication performed by a terminal device. The method comprises: receiving, at a terminal device and from a network device, at least one configuration for CSI feedback; and transmitting, based on the at least one configuration, the CSI feedback to the network device, the CSI feedback comprising a plurality of partitions with different omission priorities, the plurality of partitions comprising parameters associated with one or more of a plurality of CSI-reference signal (RS) allocations.

In a second aspect, there is provided a method of communication performed by a network device. The method comprises: transmitting, at a network device to the terminal device, at least one configuration for CSI feedback; and receiving, based on the at least one configuration, the CSI feedback from the terminal device, the CSI feedback comprising a plurality of partitions with different omission priorities, the plurality of partitions comprising parameters associated with one or more of a plurality of CSI-RS allocations.

In a third aspect, there is provided a terminal device. The terminal device includes a processing unit; and a memory coupled to the processing unit and storing instructions thereon, the instructions, when executed by the processing unit, causing the device to perform the method according to the first aspect.

In a fourth aspect, there is provided a network device. The network device includes a processing unit; and a memory coupled to the processing unit and storing instructions thereon, the instructions, when executed by the processing unit, causing the device to perform the method according to the second aspect.

In a fifth aspect, there is provided a computer readable medium having instructions stored thereon, the instructions, when executed on at least one processor, causing the at least one processor to carry out the method according to any of the above first and second aspects.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example block of CSI report according to a traditional solution

FIG. 2A illustrates an example communication environment in which example embodiments of the present disclosure can be implemented;

FIG. 2B illustrates another example communication environment in which example embodiments of the present disclosure can be implemented;

FIG. 2C illustrates a schematic diagram of spatial domain, frequency domain and doppler/time domain basis;

FIG. 3 illustrates a signaling chart illustrating a process for communication according to some embodiments of the present disclosure;

FIGS. 4A and 4B illustrate example blocks of CSI feedback according to some embodiments of the present disclosure;

FIG. 5 illustrates an example method performed by the terminal device according to some embodiments of the present disclosure;

FIG. 6 illustrates an example method performed by the network device according to some embodiments of the present disclosure; and

FIG. 7 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, the CSI feedback is important in the wireless communication network. In the 3rd-generation partnership project (3GPP) release 18, some discussions for CSI enhancement are expected to be discussed, for example. It is expected that CSI enhancement for a high/medium velocity and for coherent joint transmission (CJT) will be specified and the maximum number of CSI-RS ports per resource will remain the same as release 17, i.e., 32.

Further, it is expected to specify CSI reporting enhancement for a high/medium velocity by exploiting time-domain (TD) correlation/doppler-domain (DD) information to assist downlink precoding, targeting frequency range 1 (FR 1), as follows:
Release 16/17 type-II codebook refinement, without modification to the spatial domain (SD) basis and frequency domain (FD) basis;
UE reporting of TD channel properties measured via CSI-reference signal (RS) for tracking.

In addition, it is expected to specify enhancements of CSI acquisition for CJT targeting FRI and up to 4 TRPs, assuming ideal backhaul and synchronization as well as the same number of antenna ports across TRPs, as follows:
Release 16/17 type-II codebook refinement for CJT multi-TRP targeting FDD and its associated CSI reporting, taking into account throughput-overhead trade-off;
sounding reference signal (SRS) enhancement to manage inter-TRP cross-SRS interference targeting time division duplex (TDD) CJT via SRS capacity enhancement and/or interference randomization, with the constraints: 1) without consuming additional resources for SRS; 2) reusing existing SRS comb structure; 3) without new SRS root sequences.

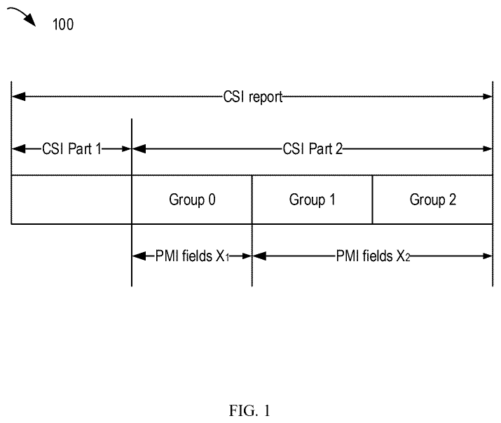

FIG. 1 illustrates an example block of CSI report 100. As shown in FIG. 1, a CSI report may be divided into two parts, i.e., part 1 and part 2, where par 2 is further divided into three groups, i.e., group 0 to group 2. In addition, a CSI report may comprise PMI fields X₁ and PMI fields X₂. For example, PMI fields X₁ may be comprised in CSI group 0. For another example, PMI fields X₂ may be comprised in CSI group 1 and CSI group 2. For another example, a subset of PMI fields X₂ may be comprised in CSI group 1, and the remaining of PMI fields X₂ may be comprised in CSI group 2.

Below table 1 illustrates an example mapping order of CSI fields of one CSI report, CSI part 1.

TABLE 1
an example mapping order of CSI fields of one CSI report, CSI part 1

| CSI report number | CSI fields |
|---|---|
| CSI report #n | Rank Indicator (RI), if reported |
| CSI part 1 | Wideband channel quality indicator (CQI) for the first transport |
| | block (TB), if reported |
| | Subband differential CQI for the first TB with increasing order of |
| | subband number, if reported, |
| | Subbands for given CSI report n indicated by the higher layer |
| | parameter csi-ReportingBand are numbered continuously in the |
| | increasing order with the lowest subband of csi-ReportingBand as |
| | subband 0 |
| | Indicator of the total number of non-zero coefficients summed |
| | across all layers K^{NZ}, if reported |

Below table 2 illustrates an example RI and CQI (defined by information element codebookType=typeII-r16 or typeII-PortSelection-r16).

TABLE 2
an example RI and CQI

| Field | Bitwidth |
|---|---|
| Rank Indicator (RI) | min (2, ┌log₂N_{RI}┐) |
| | where n_{RI} is the number of allowed rank indicator |
| | values |
| Wide-band CQI | 4 |
| Subband differential CQI | 2 |
| | ┌log₂ (K₀)┐ if max allowed rank is 1; |
| | ┌log₂ (K₀)┐ otherwise, |
| Indicator of the total number of non- zero coefficients summed across all layers K^{NZ} | ${K}_{0} = ⌈ 2 L ⌈ {p}_{1} \times \frac{{N}_{3}}{R} ⌉ β ⌉ , where {p}_{1} , {N}_{3} , R , and β are$ |
| | configured or determined by network device (for |
| | example, given by Clause 5.2.2.2.5 and 5.2.2.2.6 by |
| | TS 38.214). For example, p1 may be the parameter |
| | of pᵥ when v = 1. |

Further, the values of the rank indicator (RI) field are mapped to allowed rank indicator values with increasing order, where ‘0’ is mapped to the smallest allowed rank indicator value. The values of the K^{NZ} indicator field are mapped to the allowed values of K^{NZ}, according to Clauses 5.2.2.2.5 and 5.2.2.2.6 of TS 38.214, with increasing order, where ‘0’ is mapped to K^{NZ}=1.

In some embodiments, a parameter of number of allowed rank indicator values (e.g. n_{RI}) may be configured by the network device.

In some embodiments, v may be the number of layers or the value of rank indicator field. For example, the number of layers or the value of the RI field may be reported by the terminal device to the network device.

Below table 3 illustrate an example RI and CQI (defined by information element codebookType=typeII-PortSelection-r17).

TABLE 3
illustrates an example RI and CQI

| Field | Bitwidth |
|---|---|
| Rank Indicator (RI) | min(2, ┌log₂n_{RI}┐) |
| | where n_{RI} is the number of allowed |
| | rank indicator values |
| Wide-band CQI | 4 |
| Subband | 2 |
| differential CQI | |
| Indicator of the total | ┌log₂(K₀)┐ if max allowed rank is 1; |
| number of non-zero | ┌log₂(2K₀)┐ otherwise, |
| coefficients summed | K₀ = ┌K₁Mβ┐ , where K₁, M, and β are |
| across all layers | configured or determined by network device (for |
| K^{NZ} | example, given by Clause 5.2.2.2.7 by TS 38.214) |

The values of the rank indicator (RI) field are mapped to allowed rank indicator values with increasing order, where ‘0’ is mapped to the smallest allowed rank indicator value. The values of the K^{NZ} indicator field are mapped to the allowed values of K^{NZ}, according to Clauses 5.2.2.2.7 of TS 38.214, with increasing order, where ‘0’ is mapped to K^{NZ}=1.

In some embodiments, the terminal device may receive, from the network device, at least one configuration for CSI feedback, wherein the at least one configuration may include at least one of:
a plurality of CSI-RS resources,
a plurality of antenna ports for one CSI-RS resource,
at least one parameter for antenna port configuration, a configuration for codebook type,
a configuration for reporting type,
at least one parameter for codebook,
the number of physical resource blocks (PRBs) in a bandwidth part (BWP),
the number of a plurality of first subbands,
a size of one first subband,
the number of PRBs of one first subband,
the number of a plurality of second subbands (e.g. represented as N₃),
a size of one second subband,
the number of PRBs of one second subband,
the number of a plurality of time units (e.g. represented as N₄),
a size of one time unit (e.g. represented as Tᵤ or Tᵢ),
the number of slots/subslots/symbols of one time unit (e.g. represented as Tᵤ or Tᵢ),
the number of a plurality of second vectors (e.g. represented as L),
the number of a plurality of first vectors (e.g. represented as Mᵥ),
the number of a plurality of third vectors (e.g. represented as M_{d}),
a first parameter for codebook (e.g. represented as R),
a second parameter for codebook (e.g. represented as pᵥ),
a third parameter for codebook (e.g. represented as β),
a fourth parameter for codebook (e.g. represented as R_{d}),
a fifth parameter for codebook (e.g. represented as p_{v,d}),
a sixth parameter for codebook (e.g. represented as β_{d}) and
a seventh parameter for codebook (e.g. represented as M).

In some embodiments, the terminal device may be configured with a number of PRBs for a bandwidth part (BWP) or with a size for the BWP. In some embodiments, the number of PRBs for the BWP (e.g. represented as

$${N}_{BWP}^{size} )$$

may be a positive integer. For example, N_{BWP} may be a positive integer. For example,

$$24 \leq {N}_{BWP}^{size} \leq 275.$$

In some embodiments, the terminal device may be configured with a starting position of the BWP (e.g. represented as

$${N}_{BWP}^{start} ) .$$

For example

$${N}_{BWP}^{start}$$

may be a non-negative integer. For example,

$$0 \leq {N}_{BWP}^{start} \leq 275.$$

In some embodiments, the starting position of the BWP and the number of PRBs for the BWP may be configured in one higher layer parameter.

In some embodiments, first subband may correspond to a subband for CQI or CQI subband or CSI subband.

In some embodiments, the size of one first subband or the number of PRBs of one first subband may be represented as

$${N}_{PRB}^{SB} , and {N}_{PRB}^{SB}$$

is a positive integer. For example,

$$1 \leq {N}_{PRB}^{SB} \leq 32.$$

For example,

$${N}_{PRB}^{SB}$$

may be at least one of {4, 8, 16, 32}. In some embodiments,

$${N}_{PRB}^{SB}$$

may be based on the value of N_{BWP}. In some embodiments, if 24≤N_{BWP}≤72,

$${N}_{PRB}^{SB}$$

may be 4 or 8. For example,

$${N}_{PRB}^{SB}$$

may be configured to be 4 or 8 based on one higher layer parameter for subband. In some embodiments, if 73≤N_{BWP}≤144,

$${N}_{PRB}^{SB}$$

may be 8 or 16. For example,

$${N}_{PRB}^{SB}$$

may be configured to be 8 or 16 based on the higher layer parameter for subband. In some embodiments, if 145≤N_{BWP}≤275,

$${N}_{PRB}^{SB}$$

may be 16 or 32. For example,

$${N}_{PRB}^{SB}$$

may be configured to be 16 or 32 based on the higher layer parameter for subband.

In some embodiments, the at least one parameter for antenna port may comprise at least one of: a first plurality of antenna port groups, the number of the first plurality of antenna port groups, the number of antenna ports in one antenna port group, one or more subsets of antenna ports in one antenna port group, the number of the one or more subsets of antenna ports in one antenna port group, the number of antenna ports in one subset of antenna ports, a plurality of antenna ports in one subset of antenna ports, a plurality of antenna ports in one antenna port group, a first parameter of antenna port configuration and a second parameter of antenna port configuration. For example, one antenna port group may correspond to a TRP or antenna ports of a TRP. In some embodiments, one antenna port group may correspond to one CSI-RS resource. In some embodiments, the at least one configuration may comprise the first plurality of antenna port groups.

In some embodiments, the number of the first plurality of antenna port groups (e.g. represented as T₁) may be one of {1, 2, 3, 4} or {1, 2, 4} or {2, 3, 4} or {2, 4}. In some embodiments, the number of the second plurality of antenna port groups (e.g. represented as Tₛ.) may be one of {1, 2, 3, 4} or {1, 2, 4} or {2, 3, 4} or {2, 4}. In some embodiments, the number of the second plurality of antenna port groups Tₛ may be 1≤Tₛ≤T₁. For example, if T₁=2, Tₛ may be 1 or 2. For another example, if T₁=4, Tₛ may be 1 or 2 or 4. For another example, if T₁=4, Tₛ may be 1 or 2 or 3 or 4. For another example, if T₁=4, Tₛ may be 1 or 4. For another example, if T₁=3, Tₛ may be 1 or 2 or 3. For another example, if T₁=3, Tₛ may be 1 or 3.

In some embodiments, the at least one configuration may comprise the plurality of antenna ports in one antenna port group. In some embodiments, the number of the plurality of antenna ports in one antenna port group (e.g. represented as P) may be one of {1, 2, 4, 6, 8, 12, 16}. In some embodiments, number of antenna ports in each antenna port group may be same. For example, P may be a positive integer. For example, P may be one of {1, 2, 4, 6, 8, 12, 16}.

In some embodiments, there may be one or more reference signals, wherein a number of antenna ports for one of the one or more reference signals may equal to the number of the first plurality of antenna port groups multiplies the number of the plurality of antenna ports in one antenna port group. In some embodiments, the reference signal may be at least one of: a channel state information reference signal (CSI-RS), a sounding reference signal (SRS), a demodulation reference signal (DMRS), a CSI-RS for tracking and a phase tracking reference signal (PTRS). In some embodiments, the number of antenna ports for one of the one or more reference signals (e.g. represented as Pₜₒₜ) may be a positive integer. For example, Pₜₒₜ may be a positive integer. For example, 2<=Pₜₒₜ<=32. In some embodiments, Pₜₒₜ may be one of {2, 4, 8, 12, 16, 24, 32}. In some embodiments, Pₜₒₜ=P*T₁.

In some embodiments, the terminal device may receive the reference signal based on the number of antenna ports for the reference signal.

In some embodiments, an index of one antenna port group may be represented as t, t may be a non-negative integer. For example, 1≤t≤T₁. For another example, 0≤t≤T₁−1. For another example, 0≤t≤Tₛ−1. For another example, 1≤t≤Tₛ. In some embodiments, the antenna port group with index t may comprise Pₜ antenna ports. For example, Pₜ may be a positive integer. For example, Pₜ may be one of {1, 2, 4, 6, 8, 12, 16}. In some embodiments, for different values of t or for different antenna port groups with different indexes, the values of Pₜ may be different. In some embodiments, for each antenna port group, the values of Pₜ may be same. For example, Pₜ=P. In some embodiments,

$${P}_{tot} = {\sum }_{t = 0}^{T - 1} {P}_{t} .$$

In some embodiments, the antenna port group with index t may comprise N_{g,t} subsets of antenna ports. For example, N_{g,t} may be a positive integer. For example, N_{g,t} may be one of {1, 2, 3, 4}. For example, each subset of antenna ports may correspond to a panel or antenna ports of a panel. In some embodiments, for different values of t or for different antenna port groups with different indexes, the values of N_{g,t} may be different. In some embodiments, for each antenna port group, the values of N_{g,t} may be same. In some embodiments, each subset of antenna ports may comprise Pt antenna ports. In some embodiments,

$${P}_{tot} = {\sum }_{t = 0}^{T - 1} {N}_{g , t} \cdot {P}_{t} .$$

In some embodiments, a value of the first parameter of antenna port configuration may be represented as N₁. For example, N₁ may be a positive integer. For example, N₁ may be one of {2, 3, 4, 6, 8, 12, 16}. In some embodiments, a value of the second parameter of antenna port configuration may be represented as N₂. For example, N₂ may be a positive integer. For example, N₂ may be one of {1, 2, 3, 4}. In some embodiments, the first parameter of antenna port configuration and the second parameter of antenna port configuration may be configured in one higher layer parameter.

In some embodiments, the number of antenna ports in one antenna port group may be determined based on the first parameter of antenna port configuration and a second parameter of antenna port configuration. In some embodiments, the number of antenna ports in one antenna port group may be Pₜ=N_{g,t}·N₁·N₂·2 or P=N_{g,t}·N₁·N₂·2.

In some embodiments, the number of antenna ports in one subset of antenna ports of one antenna port group may be determined based on the first parameter of antenna port configuration and a second parameter of antenna port configuration. In some embodiments, the number of antenna ports in one subset of antenna ports of one antenna port group may be Pₜ=N₁·N₂·2 or P=N₁·N₂·2. In some embodiments, the number of antenna ports in one antenna port group may be Pₜ=N₁·N₂·2 or P=N₁·N₂·2.

In some embodiments, the number of antenna ports for the reference signal may be determined based on the first parameter of antenna port configuration and a second parameter of antenna port configuration. In some embodiments, the number of antenna ports for the reference signal may be Pₜₒₜ=N₁·N₂·2 or Pₜₒₜ=T₁·N₁·N₂·2.

In some embodiments, there may be a parameter “O₁”, and “O₁” may represent a first discrete fourier transform (DFT) oversampling in the first dimension. For example, “Of” may be one of {1, 2, 4}. For another example, “Of” may be 2 or 4. In some embodiments, there may be a parameter “O₂”, and “O₂” may represent a second DFT oversampling in the second dimension. For example, “O₂” may be one of {1, 2, 4}. For another example, “O₂” may be 2 or 4.

In some embodiments, one configuration of (N₁, N₂) may correspond to one configuration of (O₁, O₂). In some embodiments, one configuration of (O₁, O₂) may correspond to one configuration of (N₁, N₂).

In some embodiments, the example configurations of (N₁, N₂) and (O₁, O₂) and/or P may be at least one of row and/or column in the following Table 4.

TABLE 4
example configurations

| Pₜₒₜ or Pₜ or P | (N₁, N₂) | (O₁, O₂) |
|---|---|---|
| 2 | (1, 1) or (N/A, N/A) | (1, 1) or (N/A, N/A) |
| 4 | (2, 1) | (4, 1) |
| 8 | (2, 2) | (4, 4) |
| 8 | (4, 1) | (4, 1) |
| 12 | (3, 2) | (4, 4) |
| 12 | (6, 1) | (4, 1) |
| 16 | (4, 2) | (4, 4) |
| 16 | (8, 1) | (4, 1) |
| 24 | (4, 3) | (4, 4) |
| 24 | (6, 2) | (4, 4) |
| 24 | (12, 1) | (4, 1) |
| 32 | (4, 4) | (4, 4) |
| 32 | (8, 2) | (4, 4) |
| 32 | (16, 1) | (4, 1) |

In some embodiments, N/A may represent no value or no configuration of a parameter.

In some embodiments, one configuration of (N_{g,t}, N₁, N₂) may correspond to one configuration of (O₁, O₂). In some embodiments, one configuration of (O₁, O₂) may correspond to one configuration of (N_{g,t}, N₁, N₂).

In some embodiments, the configurations of (N_{g,t}, N₁, N₂) and (O₁, O₂) and/or Pₜₒₜ or Pₜ or P may be at least one of row and/or column in the following Table 5.

TABLE 5
example configurations

| Pₜₒₜ or Pₜ or P | (N_{g, t}, N₁, N₂) | (O₁, O₂) |
|---|---|---|
| 8 | (2, 2, 1) | (4, 1) |
| 16 | (2, 4, 1) | (4, 1) |
| 16 | (4, 2, 1) | (4, 1) |
| 16 | (2, 2, 2) | (4, 4) |
| 32 | (2, 8, 1) | (4, 1) |
| 32 | (4, 4, 1) | (4, 1) |
| 32 | (2, 4, 2) | (4, 4) |
| 32 | (4, 2, 2) | (4, 4) |

In some embodiments, the configurations of T₁ and/or (N₁, N₂) and/or (O₁, O₂) and/or Pₜₒₜ and/or Pₜ or P may be at least one of row and/or column in the following Table 6. For example, Pₜ=N₁·N₂·2 or P=N₁·N₂·2.

TABLE 6
example configurations

| Pₜₒₜ | Pₜ or P | T₁ | (N₁, N₂) | (O₁, O₂) |
|---|---|---|---|---|
| 4 | 2 | 2 | (1, 1) or (N/A, N/A) | (1, 1) or (N/A, N/A) |
| 8 | 2 | 4 | (1, 1) or (N/A, N/A) | (1, 1) or (N/A, N/A) |
| 8 | 4 | 2 | (2, 1) | (4, 1) |
| 12 | 4 | 3 | (2, 1) | (4, 1) |
| 16 | 4 | 4 | (2, 1) | (4, 1) |
| 16 | 8 | 2 | (4, 1) | (4, 1) |
| 16 | 8 | 2 | (2, 2) | (4, 4) |
| 24 | 8 | 3 | (4, 1) | (4, 1) |
| 24 | 8 | 3 | (2, 2) | (4, 4) |
| 24 | 12 | 2 | (6, 1) | (4, 1) |
| 24 | 12 | 2 | (3, 2) | (4, 4) |
| 32 | 8 | 4 | (4, 1) | (4, 1) |
| 32 | 8 | 4 | (2, 2) | (4, 4) |
| 32 | 16 | 2 | (8, 1) | (4, 1) |
| 32 | 16 | 2 | (4, 2) | (4, 4) |

In some embodiments, the configurations of T₁ and/or (N₁, N₂) and/or (O₁, O₂) and/or Pₜₒₜ and/or Pₜ or P may be at least one of row and/or column in the following Table 7. For example, Pₜₒₜ=N₁·N₂·2.

TABLE 7
example configurations

| Pₜₒₜ | Pₜ or P | T₁ | (N₁, N₂) | (O₁, O₂) |
|---|---|---|---|---|
| 4 | 2 | 2 | (2, 1) | (4, 1) |
| 8 | 2 | 4 | (4, 1) | (4, 1) |
| 8 | 2 | 4 | (2, 2) | (4, 4) |
| 8 | 4 | 2 | (4, 1) | (4, 1) |
| 8 | 4 | 2 | (2, 2) | (4, 4) |
| 12 | 4 | 3 | (3, 2) | (4, 4) |
| 12 | 4 | 3 | (6, 1) | (4, 1) |
| 16 | 4 | 4 | (4, 2) | (4, 4) |
| 16 | 4 | 4 | (8, 1) | (4, 1) |
| 16 | 8 | 2 | (4, 2) | (4, 4) |
| 16 | 8 | 2 | (8, 1) | (4, 1) |
| 24 | 8 | 3 | (4, 3) | (4, 4) |
| 24 | 8 | 3 | (6, 2) | (4, 4) |
| 24 | 8 | 3 | (12, 1) | (4, 1) |
| 24 | 12 | 2 | (4, 3) | (4, 4) |
| 24 | 12 | 2 | (6, 2) | (4, 4) |
| 24 | 12 | 2 | (12, 1) | (4, 1) |
| 32 | 8 | 4 | (4, 4) | (4, 4) |
| 32 | 8 | 4 | (8, 2) | (4, 4) |
| 32 | 8 | 4 | (16, 1) | (4, 1) |
| 32 | 16 | 2 | (4, 4) | (4, 4) |
| 32 | 16 | 2 | (8, 2) | (4, 4) |
| 32 | 16 | 2 | (16, 1) | (4, 1) |

In some embodiments, the configurations of T₁ and/or (N₁, N₂) and/or (O₁, O₂) and/or Pₜₒₜ and/or Pₜ or P may be at least one of row and/or column in the following Table 8. For example, Pₜₒₜ=N₁·N₂·2.

TABLE 8
example configurations

| Pₜₒₜ | Pₜ or P | T₁ | (N₁, N₂) | (O₁, O₂) |
|---|---|---|---|---|
| 8 | 4 | 2 | (2, 2) | (4, 4) or (4, 1) or (4, 2) |
| 12 | 4 | 3 | (3, 2) | (4, 4) or (1, 4) or (2, 4) |
| 16 | 4 | 4 | (4, 2) | (4, 4) or (4, 1) or (4, 2) |
| 16 | 8 | 2 | (4, 2) | (4, 4) or (4, 1) or (4, 2) |
| 24 | 8 | 3 | (4, 3) | (4, 4) or (4, 1) or (4, 2) |
| 24 | 12 | 2 | (6, 2) | (4, 4) or (4, 1) or (4, 2) |
| 24 | 12 | 2 | (12, 1) | (4, 1) |
| 32 | 8 | 4 | (4, 4) | (4, 4) or (4, 1) or (4, 2) |
| 32 | 16 | 2 | (8, 2) | (4, 4) or (4, 1) or (4, 2) |
| 32 | 16 | 2 | (16, 1) | (4, 1) |

In some embodiments, the configurations of T₁ and/or (N_{g,t}, N₁, N₂) and/or (O₁, O₂) and/or Pₜₒₜ and/or Pₜ or P may be at least one of row and/or column in the following Table 9.

TABLE 9
example configurations

| Pₜₒₜ | T₁ | (N_{g, t}, N₁, N₂) | (O₁, O₂) |
|---|---|---|---|
| 8 | 2 | (2, 1, 1) or (2, N/A, N/A) | (1, 1) or (N/A, N/A) |
| 16 | 2 | (2, 2, 1) | (4, 1) |
| 32 | 4 | (2, 2, 1) | (4, 1) |
| 32 | 2 | (2, 4, 1) | (4, 1) |
| 32 | 2 | (4, 2, 1) | (4, 1) |
| 32 | 2 | (2, 2, 2) | (4, 4) |

In some embodiments, there may be a vector urn. In some embodiments, uₘ may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, if N₂=1, uₘ=1. In some embodiments, m may be a non-negative integer. For example, 0≤m≤O₂N₂. For another example, m may be one of {0, 2, 4, 6, 8}. For another example, m may be one of {0, 1, 2, 3}. For another example, m may be 0 or 1. For another example, m may be 0. In some embodiments, there may be a vector v_{l,m}. In some embodiments,

$${v}_{l , m} = {[ {u}_{m} , {u}_{m} * {e}^{j \frac{2 π l}{{O}_{1} {N}_{1}}} , … , {u}_{m} * {e}^{j \frac{2 π l ( {N}_{1} - 1 )}{{O}_{1} {N}_{1}}} ]}^{T} .$$

In some embodiments if N₁=2 and N₂=2,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and N₂=1,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤O₁N₁. For another example, l may be one of {0, 2, 4, 6, 8}. For another example, l may be one of {0, 1, 2, 3}. For another example, l may be 0 or 1. In some embodiments, [ ]^{T} may represent a transposition of a vector or a matrix.

In some embodiments, the terminal device may determine or report a number of layers and at least one codebook indicator based on the at least one configuration to the network device. In some embodiments, the number of layers (e.g. represented as vᵣᵢ) may be one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤vᵣᵢ. For example, r may be one of {1, 2, . . . vᵣᵢ} or {1, 2} or {1, 2, 3, 4} or {1, 2, 3, 4, 5, 6, 7, 8}.

In some embodiments, the at least one codebook indicator may comprise at least one of: one or more indicators (or a field) for a first plurality of antenna port groups, one or more indicators (or a field) for a second plurality of antenna port groups, one or more indicators (or a field) for a plurality of first vectors, one or more indicators (or one or more fields) for a plurality of second vectors, one or more indicators (or a field) for a first plurality of rotations for the plurality of first vectors, one or more indicators (or one or more fields) for a second plurality of rotations for the plurality of second vectors, one or more indicators (or a field) for a plurality of third vectors, one or more indicators (or a field) for a plurality of third vectors corresponding to one TRP index (or a CSI-RS resource index or an index of a group of CSI-RS ports or a CSI-RS allocation index), an indicator (or a field) for a strongest coefficient, one or more indicators (or one or more indexes or one or more fields) for a first antenna port group, one or more indicators (or a field) for a plurality of first amplitude coefficients, one or more indicators (or a field) for a plurality of first phase coefficients, one or more indicators (or a field) for a plurality of second amplitude coefficients, one or more indicators (or a field) for a plurality of second phase coefficients, one or more indicators (or a field) for a plurality of third amplitude coefficients, one or more indicators (or a field) for a plurality of third phase coefficients, a first number of nonzero coefficients, one or more indicators (or one or more bitmaps) for indicating nonzero coefficients.

In some embodiments, the one or more indicators (or one or more bitmaps) for indicating nonzero coefficients may indicate indexes of third amplitude coefficients and/or indicating indexes of third phase coefficients, and values of the third amplitude coefficients corresponding to the indexes and/or the third phase coefficients corresponding to the indexes may be nonzero. In some embodiments, the one or more indicators (or one or more bitmaps) for indicating nonzero coefficients may indicate which coefficients in the one or more indications or in the field for the plurality of third amplitude coefficients are nonzero or reported. In some embodiments, the one or more indicators (or one or more bitmaps) for indicating nonzero coefficients may indicate which coefficients in the one or more indications or in the field for the plurality of third phase coefficients are nonzero or reported.

In some embodiments, one or more of the at least one codebook indicator may be same or applied for each layer of the number of layers, for example, layer common. In some embodiments, one or more of the at least one codebook indicator may correspond to one layer with an index, for example, layer specific.

In some embodiments, the one or more indicators (or the field) for the second plurality of antenna port groups may be same or applied for each layer of the number of layers, for example, layer common. In some embodiments, the one or more indicators (or the field) for the second plurality of antenna port groups may correspond to one layer with an index, for example, layer specific.

In some embodiments, the one or more indicators (or the field) for the plurality of first vectors may be same or applied for each layer of the number of layers, for example, layer common. In some embodiments, the one or more indicators (or the field) for the plurality of first vectors may correspond to one layer with an index, for example, layer specific.

In some embodiments, the one or more indicators (or the field) for the plurality of second vectors may be same or applied for each layer of the number of layers, for example, layer common. In some embodiments, the one or more indicators (or the field) for the plurality of second vectors may correspond to one layer with an index, for example, layer specific.

In some embodiments, the one or more indicators (or the field) for the first plurality of rotations for the plurality of first vectors may be same or applied for each layer of the number of layers, for example, layer common. In some embodiments, the one or more indicators (or the field) for the first plurality of rotations for the plurality of first vectors may correspond to one layer with an index, for example, layer specific.

In some embodiments, the one or more indicators (or the field) for the second plurality of rotations for the plurality of second vectors may be same or applied for each layer of the number of layers, for example, layer common. In some embodiments, the one or more indicators (or the field) for the second plurality of rotations for the plurality of second vectors may correspond to one layer with an index, for example, layer specific.

In some embodiments, the one or more indicators (or the field) for the plurality of third vectors may be same or applied for each layer of the number of layers, for example, layer common. In some embodiments, the one or more indicators (or the field) for the plurality of third vectors may correspond to one layer with an index, for example, layer specific.

In some embodiments, the one or more indicators (or the field) for the plurality of fourth vectors may be same or applied for each layer of the number of layers, for example, layer common. In some embodiments, the one or more indicators (or the field) for the plurality of fourth vectors may correspond to one layer with an index, for example, layer specific.

In some embodiments, the indicator (or the field) for the strongest coefficient may be same or applied for each layer of the number of layers, for example, layer common. In some embodiments, the indicator (or the field) for the strongest coefficient may correspond to one layer with an index, for example, layer specific.

In some embodiments, the one or more indicators (or the field) for the plurality of first amplitude coefficients may be same or applied for each layer of the number of layers, for example, layer common. In some embodiments, the one or more indicators (or the field) for the plurality of first amplitude coefficients may correspond to one layer with an index, for example, layer specific.

In some embodiments, the one or more indicators (or the field) for the plurality of first phase coefficients may be same or applied for each layer of the number of layers, for example, layer common. In some embodiments, the one or more indicators (or the field) for the plurality of first phase coefficients may correspond to one layer with an index, for example, layer specific.

In some embodiments, the one or more indicators (or the field) for the plurality of second amplitude coefficients may be same or applied for each layer of the number of layers, for example, layer common. In some embodiments, the one or more indicators (or the field) for the plurality of second amplitude coefficients may correspond to one layer with an index, for example, layer specific.

In some embodiments, the one or more indicators (or the field) for the plurality of second phase coefficients may be same or applied for each layer of the number of layers, for example, layer common. In some embodiments, the one or more indicators (or the field) for the plurality of second phase coefficients may correspond to one layer with an index, for example, layer specific.

In some embodiments, the one or more indicators (or the field) for the plurality of third amplitude coefficients may correspond to one layer with an index, for example, layer specific. In some embodiments, the one or more indicators (or the field) for the plurality of third phase coefficients may correspond to one layer with an index, for example, layer specific.

In some embodiments, the one or more indicators (or the field) for indicating nonzero coefficients may be same or applied for each layer of the number of layers, for example, layer common. In some embodiments, the one or more indicators (or the field) for indicating nonzero coefficients may correspond to one layer with an index, for example, layer specific.

In some embodiments, the first number of nonzero coefficients may be same or applied for each layer of the number of layers, for example, layer common. In some embodiments, the first number of nonzero coefficients may correspond to one layer with an index, for example, layer specific.

In some embodiments, the number of the plurality of first vectors, the second parameter for codebook and the third parameter for codebook may be configured or indicated in one higher layer parameter. In some embodiments, the fifth parameter for codebook and the sixth parameter for codebook may be configured or indicated in one higher layer parameter.

In some embodiments, the first parameter for codebook may be same with the fourth parameter for codebook. In some embodiments, the second parameter for codebook may be same with the fifth parameter for codebook. In some embodiments, the third parameter for codebook may be same with the sixth parameter for codebook.

In some embodiments, the second parameter for codebook may be one of {½, ¼, ⅛}. In some embodiments, the third parameter for codebook may be one of {¼, ½, ¾}. In some embodiments, the number of the plurality of first vectors (e.g. represented as L) may be one of {2, 4, 6} or at least one of {2, 4, 6, 8, 12, 16, 24, 32}. In some embodiments, L may be a positive integer. In some embodiments, L may be one of {2, 4, 6} or one of {2, 4, 6, 8, 12, 16, 24, 32}. In some embodiments, the number of the plurality of second vectors (e.g. represented as Lₜ) may be one of {2, 4, 6} or at least one of {2, 4, 6, 8}. In some embodiments, Lₜ may be a positive integer. In some embodiments, Lₜ may be one of {2, 4, 6}.

In some embodiments, the third parameter for codebook may further be based on number of layers. In some embodiments, one higher layer parameter may indicate L=2 and β=¼, and if number of layers is 1 or 2, pᵥ=¼, and if number of layers is 3 or 4, pᵥ=⅛. In some embodiments, one higher layer parameter may indicate L=2 and β=½, and if number of layers is 1 or 2, pᵥ=¼, and if number of layers is 3 or 4, pᵥ=⅛. In some embodiments, one higher layer parameter may indicate L=4 and β=¼, and if number of layers is 1 or 2, pᵥ=¼, and if number of layers is 3 or 4, pᵥ=⅛. In some embodiments, one higher layer parameter may indicate L=4 and β=½, and if number of layers is 1 or 2, pᵥ=¼, and if number of layers is 3 or 4, pᵥ=⅛. In some embodiments, one higher layer parameter may indicate L=4 and β=¾, and pᵥ=¼. In some embodiments, one higher layer parameter may indicate L=4 and β=½, and if number of layers is 1 or 2, pᵥ=½, and if number of layers is 3 or 4, pᵥ=¼. In some embodiments, one higher layer parameter may indicate L=6 and β=½, and pᵥ=¼. For example, the number of layers is 1 or 2. In some embodiments, one higher layer parameter may indicate L=6 and β=¾, and pᵥ=¼. For example, the number of layers is 1 or 2.

In some embodiments, one higher layer parameter may indicate Lₜ=2 and β=¼, and if number of layers is 1 or 2, pᵥ=¼, and if number of layers is 3 or 4, pᵥ=⅛. In some embodiments, one higher layer parameter may indicate Lₜ=2 and β=½, and if number of layers is 1 or 2, pᵥ=¼, and if number of layers is 3 or 4, pᵥ=⅛. In some embodiments, one higher layer parameter may indicate Lₜ=4 and β=¼, and if number of layers is 1 or 2, pᵥ=¼, and if number of layers is 3 or 4, pᵥ=⅛. In some embodiments, one higher layer parameter may indicate Lₜ=4 and β=½, and if number of layers is 1 or 2, pᵥ=¼, and if number of layers is 3 or 4, pᵥ=⅛. In some embodiments, one higher layer parameter may indicate Lₜ=4 and β=¾, and pᵥ=¼. In some embodiments, one higher layer parameter may indicate Lₜ=4 and β=½, and if number of layers is 1 or 2, pᵥ=½, and if number of layers is 3 or 4, pᵥ=¼. In some embodiments, one higher layer parameter may indicate Lₜ=6 and β=½, and pᵥ=¼. For example, the number of layers is 1 or 2. In some embodiments, one higher layer parameter may indicate Lₜ=6 and β=¾, and pᵥ=¼. For example, the number of layers is 1 or 2.

In some embodiments, the number of the plurality of first vectors may be based on the number of the plurality of second vectors and either one of the number of the first plurality of antenna port groups or the number of the second plurality of antenna port groups. In some embodiments, L=Lₜ*T₁. In some embodiments, L=Lₜ*Tₛ.

In some embodiments, the first parameter for codebook (for example, represented as R) may be a positive integer. For example, R may be a positive integer. For example, R may be one of {1, 2}. In some embodiments, a number of precoding matrices may be determined based on the first parameter for codebook, the number of the plurality of first subbands. In some embodiments, the first parameter for codebook may control the total number of precoding matrices indicated by the PMI as a function of the number of configured first subbands or the number of the plurality of first subbands, the size of one first subband and of the number of PRBs for the BWP.

In some embodiments, second subband may correspond to a subband for precoding matrix indicator (PMI) or PMI subband.

In some embodiments, the size of one second subband or the number of PRBs of one second subband may be represented as N_{PMI}, and N_{PMI} is a positive integer. For example, 1≤N_{PMI}≤32. For example, N_{PMI} may be one of {2, 4, 8, 16, 32}. In some embodiments, N_{PMI} may be based on

$${N}_{P R B}^{S B}$$

and R. For example,

$${N}_{PMI} = {N}_{P R B}^{S B} / R .$$

In some embodiments, the number of the plurality of second subbands N₃ or the size or the length of one third vector may be a positive integer. For example, 9≤N₃≤36. For example,

$${N}_{3} = R * {N}_{B W P}^{s i z e} / {N}_{P R B}^{S B} .$$

For another example,

$${N}_{3} = R * ⌊ {N}_{B W P}^{s i z e} / {N}_{P R B}^{S B} ⌋ .$$

For another example,

$${N}_{3} = R * ⌈ {N}_{B W P}^{s i z e} / {N}_{P R B}^{S B} ⌉ .$$

For another example,

$${N}_{3} = R * ⌊ {N}_{B W P}^{s i z e} / {N}_{P R B}^{S B} ⌋ + 1.$$

For another example,

$${N}_{3} = R * ⌊ {N}_{B W P}^{s i z e} / {N}_{P R B}^{S B} ⌋ + 2.$$

For another example,

$${N}_{3} = R * ⌊ {N}_{B W P}^{s i z e} / {N}_{P R B}^{S B} ⌋ + 3.$$

For another example,

$${N}_{3} = R * ⌊ {N}_{B W P}^{s i z e} / {N}_{P R B}^{S B} ⌋ + 4.$$

In some embodiments, when R=1, there may be one precoding matrix indicated for each first subband. In some embodiments, when R=2, for one first subband that is not the first/beginning one or the last/ending one of the plurality of first subbands in the BWP, there may be two precoding matrixes indicated for the one of the plurality of first subbands. For example, the first precoding matrix corresponds to the first

$${N}_{P R B}^{S B} / 2 PRBs$$

of the one of the plurality of first subbands, and the second precoding matrix corresponds to the last

$${N}_{PRB}^{SB} / 2 PRBs$$

of the one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) \geq \frac{{N}_{PRB}^{SB}}{2} ,$$

there may be one precoding matrix indicated corresponding to the first/beginning one of the plurality of first subbands.

In some embodiments, when R=2, for one first subband that is the first/beginning one or the last/ending one of the plurality of first subbands in the BWP, if

$$( {N}_{BWP}^{start} mod {N}_{PRB}^{SB} ) < \frac{{N}_{PRB}^{SB}}{2} ,$$

there may be two precoding matrices indicated corresponding to the first/beginning one of the plurality of first subbands. For example, the first precoding matrix may correspond to the first

$$\frac{{N}_{PRB}^{SB}}{2} - ( {N}_{BWP}^{start} mod {N}_{PRB}^{SB} ) PRBs$$

of the first/beginning one of the plurality of first subbands and the second precoding matrix corresponds to the last

$$\frac{{N}_{PRB}^{SB}}{2} PRBs$$

of the first/beginning one of the plurality of first subbands.

In some embodiments, when R=2, for one first subband that is the first/beginning one or the last/ending one of the plurality of first subbands in the BWP, if

$$1 + ( {N}_{BWP}^{start} + {N}_{BWP}^{size} - 1 ) mod {N}_{PRB}^{SB} \leq \frac{{N}_{PRB}^{SB}}{2} ,$$

there may be one precoding matrix indicated corresponding to the last/ending one of the plurality of first subbands.

In some embodiments, when R=2, for one first subband that is the first/beginning one or the last/ending one of the plurality of first subbands, if

$$1 + ( {N}_{BWP}^{start} + {N}_{BWP}^{size} - 1 ) mod {N}_{PRB}^{SB} > \frac{{N}_{PRB}^{SB}}{2} ,$$

there may be two precoding matrices indicated corresponding to the last/ending one of the plurality of first subbands. For example, the first precoding matrix may correspond to the first

$$\frac{{N}_{PRB}^{SB}}{2} PRBs$$

of the last/ending one of the plurality of first subbands and the second precoding matrix may correspond to the last

$$1 + ( {N}_{BWP , i}^{start} + {N}_{BWP , i}^{size} - 1 ) mod {N}_{PRB}^{SB} - \frac{{N}_{PRB}^{SB}}{2} PRBs$$

of the last/ending one of the plurality of first subbands.

In some embodiments, the number of the plurality of third vectors Mᵥ may be a positive integer. For example,

$${M}_{v} = ⌈ {p}_{v} \frac{{N}_{3}}{R} ⌉ .$$

For example, Mᵥ may be one of {1, 2, 3, 4, 5, 6, 7, 8, 9, 10}.

In some embodiments, the value of the first parameter R for codebook may be determined based on the number of second plurality of antenna port groups (or based on value of Tₛ). In some embodiments, if the number of second plurality of antenna port groups is 1 or Tₛ=1, the value of the first parameter R may be one of {1, 2}. In some embodiments, if the number of the second plurality of antenna port groups is larger than 1 or Tₛ>1 (for example, Tₛ=2 or 3 or 4, the value of the first parameter R may be one of {2, 4} or {2, 3} or {1, 3} or {1, 4} or {1,2,3,4} or {3, 4}. In some embodiments, if the number of the second plurality of antenna port groups is 4 (for example, Tₛ=4, the value of the first parameter R may be one of {2, 4} or {3,4}.

In some embodiments, a plurality of precoding matrices may be determined from L+Mᵥ vectors or Lₜ+Mᵥ vectors or T·Lₜ+Mᵥ vectors or Tₛ·Lₜ+Mᵥ vectors.

In some embodiments, the bit size of the one or more indicators (or the field) for the second plurality of antenna port groups may be ceil(log 2(nchoosek(T₁, Tₛ))). In some embodiments, the bit size of the one or more indicators (or the field) for the second plurality of antenna port groups may be ceil(log 2(T₁!/(T₁−Tₛ)!)).

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a.

In some embodiments, the one or more indicators (or the field) for the second plurality of antenna port groups may be comprised in the PMI or in the first part of the PMI.

In some embodiments, a number of the one or more indicators (or one or more indexes or one or more fields) for a first antenna port group may be same as the number of layers. In some embodiments, the number of the one or more indicators (or one or more indexes or one or more fields) for a first antenna port group may be 1. For example, common for each layer of the number of layers. In some embodiments, the one or more indicators (or one or more indexes or one or more fields) for a first antenna port group may be same for each layer of the number of layers.

In some embodiments, the index of the first antenna port group may be Tₘ. For example, Tₘ may be a non-negative integer. For example, 1≤T≤T₁. For another example, 0≤T≤T₁−1. For another example, 1≤Tₘ<Tₛ. For another example, 0≤T≤Tₛ−1.

In some embodiments, the bit size for the one or more indicators (or one or more indexes or one or more fields) for the first antenna port group may be based on the number of the first plurality of antenna port groups. In some embodiments, the bit size for the one or more indicators (or one or more indexes or one or more fields) for the first antenna port group may be ceil(log 2(T₁)). In some embodiments, the bit size for the one or more indicators (or one or more indexes or one or more fields) for the first antenna port group may be ceil(log 2(Tₛ). In some embodiments, the one or more indicators (or one or more indexes or one or more fields) for the first antenna port group may be comprised in the PMI or in the first part of the PMI or in the second part of the PMI.

In some embodiments, the one or more indicators (or the field) for the second plurality of antenna port groups may indicate an order of the second plurality of antenna port groups. In some embodiments, the first one of the indicated second plurality of antenna port groups may be same as the index (or indicator) of the first antenna port group.

In some embodiments, one second vector of the plurality of second vectors may be represented as

$${v}_{{l}_{t}^{( i )} , {m}_{t}^{( i )}} .$$

In some embodiments,

$${v}_{{l}_{t}^{( i )} , {m}_{t}^{( i )}} = {[ {u}_{{m}_{t}^{( i )}} , {u}_{{m}_{t}^{( i )}} * {e}^{j \frac{2 π {l}_{t}^{( i )}}{{O}_{1} {N}_{1}}} , ... , {u}_{{m}_{t}^{( i )}} * {e}^{j \frac{2 π {l}_{t}^{( i )} * ( {N}_{1} - 1 )}{{O}_{1} {N}_{1}}} ]}^{T} .$$

In some embodiments,

$${u}_{{m}_{t}^{( i )}} = \{ \begin{matrix}[ 1 , {e}^{j \frac{2 π {m}_{t}^{( i )}}{{O}_{2} {N}_{2}}} , ... , {e}^{j \frac{2 π {m}_{t}^{( i )} ( {N}_{2} - 1 )}{{O}_{2} {N}_{2}}} ] & {N}_{2} > 1 \\ 1 & {N}_{2} = 1\end{matrix} .$$

In some embodiments,

$${l}_{t}^{( i )} ∈ \{ 0 , 1 , ... {O}_{1} {N}_{1} - 1 \} .$$

In some embodiments,

$${m}_{t}^{( i )} ∈ \{ 0 , 1 , ... {O}_{2} {N}_{2} - 1 \} .$$

In some embodiments,

$${l}_{t}^{( i )} = {O}_{1} {n}_{1 , t}^{( i )} + {q}_{1 , t} , {m}_{t}^{( i )} = {O}_{2} {n}_{2 , t}^{( i )} + {q}_{2 , t} .$$

In some embodiments, i=0, 1, . . . Lₜ−1. In some embodiments, t=0, 1, . . . T₁−1. In some embodiments, t=0, 1, . . . Tₛ−1.

In some embodiments, q_{1,t} and q_{2,t} may be rotations of the second plurality of rotations for the plurality of second vectors. For example, the q_{1,t} and q_{2,t} may be the rotations corresponding to antenna port group with index t. In some embodiments, q_{1,t}∈{0, 1, . . . O₁−1}. In some embodiments, q_{2,t}∈{0, 1, . . . O₂−1}.

In some embodiments, the length of one first vector may be based on the number of the second plurality of antenna port groups. In some embodiments, the length of one first vector may be the number of the plurality of antenna ports in one antenna port group multiplies the number of the second plurality of antenna port groups and divided by 2 or based on the fifth value. In some embodiments, the length of one first vector may be P*Tₛ or P*T₁/2 or Pₜ*Tₛ/2 or Pₜ*T₁/2.

In some embodiments, the length of one second vector may be based on the number of antenna ports in one antenna port group. In some embodiments, the length of one second vector may be P/2 or Pₜ/2.

In some embodiments, the number of one or more indicators (or the field) for the plurality of first amplitude coefficients may be based on the number of the first plurality of antenna port groups or the number of the second plurality of antenna port groups. In some embodiments, the number of one or more indicators (or the field) for the plurality of first amplitude coefficients may be based on the number of the first plurality of antenna port groups minus 1 or the number of the second plurality of antenna port groups minus 1.

In some embodiments, the number of one or more indicators (or the field) for the plurality of first amplitude coefficients may be K_{b1}*(T−1) or K_{b1}*(T₁−1) or K_{b1}*(Tₛ−1) or

$${K}_{b 1} * {\sum }_{t = 0 , and t \neq {T}_{m}}^{T - 1} {N}_{g , t} .$$

In some embodiments, K_{b1} may be the bit size for each of the first amplitude coefficients. For example, K_{b1} may be 2 or 3 or 4 bits.

In some embodiments, the number of one or more indicators (or the field) for the plurality of first amplitude coefficients may be based on the number of the plurality of fourth vectors and either one of: the number of the first plurality of antenna port groups; or the number of the second plurality of antenna port groups.

In some embodiments, the number of one or more indicators (or the field) for the plurality of first amplitude coefficients may be K_{b1}*(T−1)*M_{w} or K_{b1}*(T₁−1)*M_{w} or K_{b1}*(T_{S}−1)*M_{w} or

$${K}_{b 1} * {M}_{w} * {\sum }_{t = 0 , and t \neq {T}_{m}}^{T - 1} {N}_{g , t} .$$

In some embodiments, the one or more indicators (or the field) for the plurality of first amplitude coefficients may be comprised in the PMI or in the first part of the PMI or in the second part of the PMI.

In some embodiments, the number of one or more indicators (or the field) for the plurality of first phase coefficients may be based on the number of the first plurality of antenna port groups or the number of the second plurality of antenna port groups. In some embodiments, the number of one or more indicators (or the field) for the plurality of first phase coefficients may be based on the number of the first plurality of antenna port groups minus 1 or the number of the second plurality of antenna port groups minus 1.

In some embodiments, the number of one or more indicators (or the field) for the plurality of first phase coefficients may be K_{b2}*(T−1) or K_{b2}*(T₁−1) or K_{b2}*(Tₛ−1) or

$${K}_{b 2} * {\sum }_{t = 0 , and t \neq {T}_{m}}^{T - 1} {N}_{g , t} .$$

In some embodiments, K_{b2} may be the bit size for each of the first phase coefficients. For example, K_{b2} may be 2 or 3 or 4 bits.

In some embodiments, the number of one or more indicators (or the field) for the plurality of first phase coefficients may be based on the number of the plurality of fourth vectors and either one of: the number of the first plurality of antenna port groups; or the number of the second plurality of antenna port groups.

In some embodiments, the number of one or more indicators (or the field) for the plurality of first phase coefficients may be K_{b2}*(T−1)*M_{w} or K_{b2}*(T₁−1)*M_{w} or

$${K}_{b 2} * ( {T}_{s} - 1 ) * {M}_{w} or {K}_{b 2} * {M}_{w} * {\sum }_{t = 0 , and t \neq {T}_{m}}^{T - 1} {N}_{g , t} .$$

In some embodiments, one first vector may be represented as vᵢ,

$${v}_{i} = [ \begin{matrix}{v}_{{l}_{0}^{( i )} , {m}_{0}^{( i )}} * {P}_{0}^{( 0 )} * {φ}_{0}^{( 0 )} \\ {v}_{{l}_{1}^{( i )} , {m}_{1}^{( i )}} * {P}_{1}^{( 0 )} * {φ}_{1}^{( 0 )} \\ ⋮ \\ {v}_{{l}_{T - 1}^{( i )} , {m}_{T - 1}^{( i )}} * {P}_{T - 1}^{( 0 )} * {φ}_{T - 1}^{( 0 )}\end{matrix} ]$$

In some embodiments,

$${P}_{t}^{( 0 )}$$

may be a first amplitude coefficient for antenna port group with index t. In some embodiments,

$${φ}_{t}^{( 0 )}$$

may be a first phase coefficient for antenna port group with index t.

In some embodiments, T may be based on the number of first plurality of antenna port groups T₁. In some embodiments, T=T₁. In some embodiments, T may be based on the number of second plurality of antenna port groups Tₛ. In some embodiments, T=Tₛ.

In some embodiments,

$${W}_{1} = [ \begin{matrix}B & 0 \\ 0 & B\end{matrix} ] ,$$

wherein B=v₀v₁ . . . v_{L}_{ₜ}₋₁. For example, size of W₁ may be (2*N₁*N₂*T)*(2*Lₜ) or (2*N₁*N₂*Tₛ)*(2*Lₜ). For example, a size of each element in W₁ may be (N₁*N₂*T)*Lₜ, “0” in W₁ may be a zero matrix with size (N₁*N₂*T)*Lₜ.

In some embodiments,

$${W}_{1} = [ \begin{matrix}{v}_{0} {v}_{1} … {v}_{{L}_{t} - 1} & 0 \\ 0 & {v}_{0} {v}_{1} … {v}_{{L}_{t} - 1}\end{matrix} ] .$$

In some embodiments, W₁=W₀₁*W₀₂.

In some embodiments,

$${W}_{01} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] ,$$

In some embodiments, the size of W₀₁ may be (2*N₁*N₂)*(2*Lₜ).

In some embodiments,

$${B}^{( t )} = [ {v}_{{l}_{t}^{( 0 )} , {m}_{t}^{( 0 )}} {v}_{{l}_{t}^{( 1 )} , {m}_{t}^{( 1 )}} … {v}_{{l}_{t}^{( {L}_{t} - 1 )} , {m}_{t}^{( {L}_{t} - 1 )}} ] .$$

In some embodiments,

$${W}_{02} = [ \begin{matrix}{P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )} \\ {P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )}\end{matrix} ]$$

In some embodiments,

$${W}_{1} = [ \begin{matrix}B & 0 \\ 0 & B\end{matrix} ] = {W}_{01} * {W}_{02} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] * [ \begin{matrix}{P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )} \\ {P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )}\end{matrix} ]$$

In some embodiments, for W2 corresponding to layer with index r:

$${\tilde{W}}_{2} = [ \begin{matrix}{P}_{r , 0}^{( 1 )} * {P}_{r , 0 , 0 , 0}^{( 2 )} * {φ}_{r , 0 , 0 , 0}^{( 2 )} & {P}_{r , 0}^{( 1 )} * {P}_{r , 0 , 1}^{( 2 )} * {φ}_{r , 0 , 0 , 1}^{( 2 )} & & {P}_{r , 0}^{( 1 )} * {P}_{r , 0 , {M}_{v} - 1}^{( 2 )} * {φ}_{r , 0 , 0 , {M}_{v} - 1}^{( 2 )} \\ {P}_{r , 0}^{( 1 )} * {P}_{r , 1 , 0 , 0}^{( 2 )} * {φ}_{r , 1 , 0 , 0}^{( 2 )} & {P}_{r , 0}^{( 1 )} * {P}_{r , 1 , 0 , 1}^{( 2 )} * {φ}_{r , 1 , 0 , 1}^{( 2 )} & & {P}_{r , 0}^{( 1 )} * {P}_{r , 1 , 0 , {M}_{v} - 1}^{( 2 )} * {φ}_{r , 1 , 0 , {M}_{v} - 1}^{( 2 )} \\ ⋮ & ⋮ & & ⋮ \\ {P}_{r , 0}^{( 1 )} * {P}_{r , {L}_{t} - 1 , 0 , 0}^{( 2 )} * {φ}_{r , {L}_{t} - 1 , 0 , 0}^{( 2 )} & {P}_{r , 0}^{( 1 )} * {P}_{r , {L}_{t} - 1 , 0 , 1}^{( 2 )} * {φ}_{r , {L}_{t} - 1 , 0 , 1}^{( 2 )} & … & {P}_{r , 0}^{( 1 )} * {P}_{r , {L}_{t} - 1 , 0 , {M}_{v} - 1}^{( 2 )} * {φ}_{r , {L}_{t} - 1 , 0 , {M}_{v} - 1}^{( 2 )} \\ {P}_{r , 1}^{( 1 )} * {P}_{r , 0 , 1 , 0}^{( 2 )} * {φ}_{r , 0 , 1 , 0}^{( 2 )} & {P}_{r , 1}^{( 1 )} * {P}_{r , 0 , 1 , 1}^{( 2 )} * {φ}_{r , 0 , 1 , 1}^{( 2 )} & & {P}_{r , 1}^{( 1 )} * {P}_{r , 0 , 1 , {M}_{v} - 1}^{( 2 )} * {φ}_{r , 0 , 1 , {M}_{v} - 1}^{( 2 )} \\ {P}_{r , 1}^{( 1 )} * {P}_{r , 1 , 1 , 0}^{( 2 )} * {φ}_{r , 1 , 1 , 0}^{( 2 )} & {P}_{r , 1}^{( 1 )} * {P}_{r , 1 , 1 , 1}^{( 2 )} * {φ}_{r , 1 , 1 , 1}^{( 2 )} & & {P}_{r , 1}^{( 1 )} * {P}_{r , 1 , 1 , {M}_{v} - 1}^{( 2 )} * {φ}_{r , 1 , 1 , {M}_{v} - 1}^{( 2 )} \\ ⋮ & ⋮ & & ⋮ \\ {P}_{r , 1}^{( 1 )} * {P}_{r , {L}_{t} - 1 , 1 , 0}^{( 2 )} * {φ}_{r , {L}_{t} - 1 , 1 , 0}^{( 2 )} & {P}_{r , 1}^{( 1 )} * {P}_{r , {L}_{t} - 1 , 1 , 1}^{( 2 )} * {φ}_{r , {L}_{t} - 1 , 1 , 1}^{( 2 )} & & {P}_{r , 1}^{( 1 )} * {P}_{r , {L}_{t} - 1 , 1 , {M}_{v} - 1}^{( 2 )} * {φ}_{r , {L}_{t} - 1 , 1 , {M}_{v} - 1}^{( 2 )}\end{matrix} ]$$

In some embodiments, f may be an index of one third vector. For example, f=0, 1, . . . Mᵥ−1.

In some embodiments,

$${P}_{r , s}^{( 1 )}$$

may be the second amplitude coefficient corresponding to layer with index r. In some embodiments,

$${P}_{r , s}^{( 1 )}$$

may not be needed. In some embodiments,

$${P}_{r , s}^{( 1 )}$$

may be fixed to be 1.

In some embodiments,

$${P}_{r , i , s , f}^{( 2 )}$$

may be third amplitude coefficient corresponding to the layer with index r and corresponding to one first vector with index i and corresponding to third vector with index f.

In some embodiments,

$${φ}_{r , i , s , f}^{( 2 )}$$

may be third amplitude coefficient corresponding to the layer with index r and corresponding to a first vector with index i and corresponding to third vector with index f.

In some embodiments, s may be 0 and/or 1. For example, s may be for two polarizations. In some embodiment, s may be for different groups of vectors.

In some embodiments, for third vectors (e.g. represented as W_{f}) corresponding to layer with index r,

$${W}_{f} = [ \begin{matrix}{F}_{{n}_{3 , r}^{( 0 )}} & {F}_{{n}_{3 , r}^{( 1 )}} & ... & {{F}_{{n}_{3 , r}^{( {M}_{v} - 1 )}} ]}^{T} .\end{matrix}$$

In some embodiments, the size of W_{f} may be Mᵥ*N₃.

In some embodiments,

$${n}_{3 , l}^{( f )} ∈ \{ 0 , 1 , ... , {N}_{3} - 1 \} .$$

In some embodiments,

$${F}_{{n}_{3 , r}^{( f )}} = [ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} & ... & {{e}^{j \frac{2 π * ( {N}_{3} - 1 ) * {n}_{3 , r}^{( f )}}{{N}_{3}}} ]}^{T} .\end{matrix}$$

In some embodiments,

$${y}_{z , r}^{( f )} = {e}^{j \frac{2 π * z * {n}_{3 , r}^{( f )}}{{N}_{3}}} .$$

In some embodiments, z may be an index of a second subband. For example, z={0, 1, . . . N₃−1}

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{i = 0}^{{L}_{t} - 1} {v}_{i} {P}_{r , 0}^{( 1 )} {\sum }_{f = 0}^{{M}_{v} - 1} {y}_{z , r}^{( f )} {P}_{r , i , 0 , f}^{( 2 )} {φ}_{r , i , 0 , f}^{( 2 )} \\ {\sum }_{i = 0}^{{L}_{t} - 1} {v}_{i} {P}_{r , 1}^{( 1 )} {\sum }_{f = 0}^{{M}_{v} - 1} {y}_{z , r}^{( f )} {P}_{r , i , 1 , f}^{( 2 )} {φ}_{r , i , 1 , f}^{( 2 )}\end{matrix} ]$$

In some embodiments, γ_{z,r} may be a variant for power calculation or power normalization.

In some embodiments, γ_{z,r} may be based on the plurality of third amplitude coefficients, the plurality of third phase coefficients and at least one of. the plurality of first amplitude coefficients, the plurality of second amplitude coefficients, the plurality of first phase coefficients and the plurality of second phase coefficients. In some embodiments, γ_{z,r} may be based on the number of the plurality of third vectors and at least one of: the number of the plurality of first vectors, the number of the plurality of second vectors and the number of the plurality of fourth vectors.

In some embodiments,

$${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2} .$$

In some embodiments, for bits or codepoints or values of the one or more indicators (or one or more bitmaps) for indicating nonzero coefficients with value to be 0, the third amplitude coefficient and/or the third phase coefficient corresponding to the bits or codepoints or values may be set to 0.

In some embodiments, the number of the plurality of first vectors may be based on the number of the plurality of second vectors and at least one of: the number of the first plurality of antenna port groups; the number of the second plurality of antenna port groups; and values of the plurality of first amplitude coefficients.

In some embodiments,

$${W}_{1} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] .$$

In some embodiments,

$${B}^{( t )} = [ \begin{matrix}{v}_{{l}_{t}^{( 0 )} , {m}_{t}^{( 0 )}} & {v}_{{l}_{t}^{( 1 )} , {m}_{t}^{( 1 )}} & ... & {v}_{{l}_{t}^{( {L}_{t} - 1 )} , {m}_{t}^{( {L}_{t} - 1 )}}\end{matrix} ] .$$

In some embodiments, corresponding to a layer with index r,

$${\tilde{W}}_{2} = [ \begin{matrix}{P}_{0}^{( 0 )} * {φ}_{0}^{( 0 )} * {P}_{r , 0 , 0}^{( 1 )} * {P}_{r , 0 , 0 , 0 , 0}^{( 2 )} * {φ}_{r , 0 , 0 , 0 , 0}^{( 2 )} & & {P}_{0}^{( 0 )} * {φ}_{0}^{( 0 )} * {P}_{r , 0 , 0}^{( 1 )} * {P}_{r , 0 , 0 , 0 , {M}_{v} - 1}^{( 2 )} * {φ}_{r , 0 , 0 , 0 , {M}_{v} - 1}^{( 2 )} \\ {P}_{0}^{( 0 )} * {φ}_{0}^{( 0 )} * {P}_{r , 0 , 0}^{( 1 )} * {P}_{r , 0 , 1 , 0 , 0}^{( 2 )} * {φ}_{r , 0 , 1 , 0 , 0}^{( 2 )} & & {P}_{0}^{( 0 )} * {φ}_{0}^{( 0 )} * {P}_{r , 0 , 0}^{( 1 )} * {P}_{r , 0 , 1 , 0 , {M}_{v} - 1}^{( 2 )} * {φ}_{r , 0 , 1 , 0 , {M}_{v} - 1}^{( 2 )} \\ ⋮ & & ⋮ \\ {P}_{0}^{( 0 )} * {φ}_{0}^{( 0 )} * {P}_{r , 0 , 0}^{( 1 )} * {P}_{r , 0 , {L}_{0} - 1 , 0 , 0}^{( 2 )} * {φ}_{r , 0 , {L}_{0} - 1 , 0 , 0}^{( 2 )} & & {P}_{0}^{( 0 )} * {φ}_{0}^{( 0 )} * {P}_{r , 0 , 0}^{( 1 )} * {P}_{r , 0 , {L}_{0} - 1 , 0 , {M}_{v} - 1}^{( 2 )} * {φ}_{r , 0 , {L}_{0} - 1 , 0 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 0}^{( 1 )} * {P}_{r , T - 1 , 0 , 0 , 0}^{( 2 )} * {φ}_{r , T - 1 , 0 , 0 , 0}^{( 2 )} & & {P}_{T - 1}^{( 0 )} * {φ}_{T - 1}^{( 0 )} * {P}_{r , T - 1 , 0}^{( 1 )} * {P}_{r , T - 1 , 0 , 0 , {M}_{v} - 1}^{( 2 )} * {φ}_{r , T - 1 , 0 , 0 , {M}_{v} - 1}^{( 2 )} \\ {P}_{T - 1}^{( 0 )} * {φ}_{T - 1}^{( 0 )} * {P}_{r , T - 1 , 0}^{( 1 )} * {P}_{r , T - 1 , 1 , 0 , 0}^{( 2 )} * {φ}_{r , T - 1 , 1 , 0 , 0}^{( 2 )} & & {P}_{T - 1}^{( 0 )} * {φ}_{T - 1}^{( 0 )} * {P}_{r , T - 1 , 0}^{( 1 )} * {P}_{r , T - 1 , 1 , 0 , {M}_{v} - 1}^{( 2 )} * {φ}_{r , T - 1 , 1 , 0 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 0 , 0}^{( 2 )} * {φ}_{r , T - 1 , {L}_{T - 1} - 1 , 0 , 0}^{( 2 )} & … & {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 0 , {M}_{v} - 1}^{( 2 )} * {φ}_{r , T - 1 , {L}_{T - 1} - 1 , 0 , {M}_{v} - 1}^{( 2 )} \\ {P}_{0}^{( 0 )} * {φ}_{0}^{( 0 )} * {P}_{r , 0 , 1}^{( 1 )} * {P}_{r , 0 , 0 , 1 , 0}^{( 2 )} * {φ}_{r , 0 , 0 , 1 , 0}^{( 2 )} & & {P}_{0}^{( 0 )} * {φ}_{0}^{( 0 )} * {P}_{r , 0 , 1}^{( 1 )} * {P}_{r , 0 , 0 , 1 , {M}_{v} - 1}^{( 2 )} * {φ}_{r , 0 , 0 , 1 , {M}_{v} - 1}^{( 2 )} \\ {P}_{0}^{( 0 )} * {φ}_{0}^{( 0 )} * {P}_{r , 0 , 1}^{( 1 )} * {P}_{r , 0 , 1 , 1 , 0}^{( 2 )} * {φ}_{r , 0 , 1 , 1 , 0}^{( 2 )} & & {P}_{0}^{( 0 )} * {φ}_{0}^{( 0 )} * {P}_{r , 0 , 1}^{( 1 )} * {P}_{r , 0 , 1 , 1 , {M}_{v} - 1}^{( 2 )} * {φ}_{r , 0 , 1 , 1 , {M}_{v} - 1}^{( 2 )} \\ ⋮ & & ⋮ \\ {P}_{0}^{( 0 )} * {φ}_{0}^{( 0 )} * {P}_{r , 0 , 1}^{( 1 )} * {P}_{r , 0 , {L}_{0} - 1 , 1 , 0}^{( 2 )} * {φ}_{r , 0 , {L}_{0} - 1 , 1 , 0}^{( 2 )} & & {P}_{0}^{( 0 )} * {φ}_{0}^{( 0 )} * {P}_{r , 0 , 1}^{( 1 )} * {P}_{r , 0 , {L}_{0} - 1 , 1 , {M}_{v} - 1}^{( 2 )} * {φ}_{r , 0 , {L}_{0} - 1 , 1 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , 0 , 1 , 0}^{( 2 )} * {φ}_{r , T - 1 , 0 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , 0 , 1 , {M}_{v} - 1}^{( 2 )} * {φ}_{r , T - 1 , 0 , 1 , {M}_{v} - 1}^{( 2 )} \\ {P}_{T - 1}^{( 0 )} * {φ}_{T - 1}^{( 0 )} * {P}_{r , T - 1 , 1}^{( 1 )} * {P}_{r , T - 1 , 1 , 1 , 0}^{( 2 )} * {φ}_{r , T - 1 , 1 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , 1 , 1 , {M}_{v} - 1}^{( 2 )} * {φ}_{r , T - 1 , 1 , 1 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 1 , 0}^{( 2 )} * {φ}_{r , T - 1 , {L}_{T - 1} - 1 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 1 , {M}_{v} - 1}^{( 2 )} * {φ}_{r , T - 1 , {L}_{T - 1} - 1 , 1 , {M}_{v} - 1}^{( 2 )}\end{matrix} ]$$

In some embodiments,

$${P}_{t}^{( 0 )}$$

may be the first amplitude coefficient for antenna port group with index t. In some embodiments,

$${P}_{t}^{( 0 )}$$

may not be needed. In some embodiments,

$${P}_{t}^{( 0 )}$$

may be fixed to be 1.

In some embodiments,

$${φ}_{t}^{( 0 )}$$

may be the first phase coefficient for antenna port group with index t. In some embodiments,

$${φ}_{t}^{( 0 )}$$

may not be needed. In some embodiments,

$${φ}_{t}^{( 0 )}$$

may be fixed to be 1.

In some embodiments,

$${P}_{r , t , s}^{( 1 )}$$

may be the second amplitude coefficient corresponding to antenna port group with index t and corresponding to layer with index r. In some embodiments,

$${P}_{r , t , s}^{( 1 )}$$

may not be needed. In some embodiments,

$${P}_{r , t , s}^{( 1 )}$$

may be fixed to be 1.

In some embodiments,

$${P}_{r , t , i , s , f}^{( 2 )}$$

may be third amplitude coefficient for antenna port group with index t and corresponding to the layer with index r and corresponding to one first vector with index i and corresponding to third vector with index f.

In some embodiments,

$${φ}_{r , t , i , s , f}^{( 2 )}$$

may be third amplitude coefficient for antenna port group with index t and corresponding to the layer with index r and corresponding to a first vector with index i and corresponding to third vector with index f.

In some embodiments, for third vectors (e.g. represented as W_{f}) corresponding to layer with index r,

$${W}_{f} = [ \begin{matrix}{F}_{{n}_{3 , r}^{( 0 )}} & {F}_{{n}_{3 , r}^{( 1 )}} & ... & {{F}_{{n}_{3 , r}^{( {M}_{v} - 1 )}} ]}^{T} .\end{matrix}$$

In some embodiments, the size of W_{f} may be Mᵥ*N₃.

In some embodiments,

$${n}_{3 , l}^{( f )} ∈ \{ 0 , 1 , ... , {N}_{3} - 1 \} .$$

In some embodiments,

$${F}_{{n}_{3 , r}^{( f )}} = [ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} & ... & {{e}^{j \frac{2 π * ( {N}_{3} - 1 ) * {n}_{3 , r}^{( f )}}{{N}_{3}}} ]}^{T} .\end{matrix}$$

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{t = 0}^{T - 1} {P}_{t}^{( 0 )} {φ}_{t}^{( 0 )} {\sum }_{i = 0}^{{L}_{t} - 1} {v}_{{l}_{t}^{( i )} , {m}_{t}^{( i )}} {P}_{r , t , 0}^{( 1 )} {\sum }_{f = 0}^{{M}_{v} - 1} {y}_{z , r}^{( f )} {P}_{r , t , i , 0 , f}^{( 2 )} {φ}_{r , t , i , 0 , f}^{( 2 )} \\ {\sum }_{t = 0}^{T - 1} {P}_{t}^{( 0 )} {φ}_{t}^{( 0 )} {\sum }_{i = 0}^{{L}_{t} - 1} {v}_{{l}_{t}^{( i )} , {m}_{t}^{( i )}} {P}_{r , t , 1}^{( 1 )} {\sum }_{f = 0}^{{M}_{v} - 1} {y}_{z , r}^{( f )} {P}_{r , t , i , 1 , f}^{( 2 )} {φ}_{r , t , i , 1 , f}^{( 2 )}\end{matrix} ] .$$

In some embodiments, a value of one first amplitude coefficient may be one of {0,

$$\frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \\ \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one first amplitude coefficient may be 4 bits. In some embodiments, a value of an indicator or a field for one first amplitude coefficient may be one of {0, 1, 2, 3, 4, 5, 6, 7, 8, 9, 10, 11, 12, 13, 14, 15}.

In some embodiments, an indicator or a field for one first amplitude coefficient with value 0 may correspond to the first amplitude coefficient with value 0. In some embodiments, an indicator or a field for one first amplitude coefficient with value 1 may correspond to the is first amplitude coefficient with value

$$\frac{1}{\sqrt{128}} .$$

In some embodiments, an indicator or a field for one first amplitude coefficient with value 2 may correspond to the first amplitude coefficient with value

$${( \frac{1}{8192} )}^{1 / 4} .$$

In some embodiments, an indicator or a field for one first amplitude coefficient with value 3 may correspond to the first amplitude coefficient with value ⅛. In some embodiments, an indicator or a field for one first amplitude coefficient with value 4 may correspond to the first amplitude coefficient with value

$${( \frac{1}{2048} )}^{1 / 4} .$$

In some embodiments, an indicator or a field for one first amplitude coefficient with value 5 may correspond to the first amplitude coefficient with value

$$\frac{1}{2 \sqrt{8}} .$$

In some embodiments, an indicator or a field for one first amplitude coefficient with value 6 may correspond to the first amplitude coefficient with value

$${( \frac{1}{512} )}^{1 / 4} .$$

In some embodiments, an indicator or a field for one first amplitude coefficient with value 7 may correspond to the first amplitude coefficient with value ¼. In some embodiments, an indicator or a field for one first amplitude coefficient with value 8 may correspond to the first amplitude coefficient with value

$${( \frac{1}{128} )}^{1 / 4} .$$

In some embodiments, an indicator or a field for one first amplitude coefficient with value 9 may correspond to the first amplitude coefficient with value

$$\frac{1}{\sqrt{8}} .$$

In some embodiments, an indicator or a field for one first amplitude coefficient with value 10 may correspond to the first amplitude coefficient with value

$${( \frac{1}{32} )}^{1 / 4} .$$

In some embodiments, an indicator or a field for one first amplitude coefficient with value 11 may correspond to the first amplitude coefficient with value ½. In some embodiments, an indicator or a field for one first amplitude coefficient with value 12 may correspond to the first amplitude coefficient with value

$${( \frac{1}{8} )}^{1 / 4} .$$

In some embodiments, an indicator or a field for one first amplitude coefficient with value 13 may correspond to the first amplitude coefficient with value

$$\frac{1}{\sqrt{2}} .$$

In some embodiments, an indicator or a field for one first amplitude coefficient with value 14 may correspond to the first amplitude coefficient with value

$${( \frac{1}{2} )}^{1 / 4} .$$

In some embodiments, an indicator or a field for one first amplitude coefficient with value 15 may correspond to the first amplitude coefficient with value 1.

In some embodiments, a value of one first amplitude coefficient may be one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one first amplitude coefficient may be 4 bits. In some embodiments, a value of an indicator or a field for one first amplitude coefficient may be one of {0, 1, 2, 3, 4, 5, 6, 7}.

In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{64}} .$$

In some embodiments, an indicator or a field for one first amplitude coefficient with value 2 may correspond to the first amplitude coefficient with value

$$\frac{1}{\sqrt{32}} .$$

In some embodiments, an indicator or a field for one first amplitude coefficient with value 3 may correspond to the first amplitude coefficient with value ¼. In some embodiments, an indicator or a field for one first amplitude coefficient with value 4 may correspond to the first amplitude coefficient with value

$$\frac{1}{\sqrt{8}} .$$

In some embodiments, an indicator or a field for one first amplitude coefficient with value 5 may correspond to the first amplitude coefficient with value ½. In some embodiments, an indicator or a field for one first amplitude coefficient with value 6 may correspond to the first amplitude coefficient with value

$$\frac{1}{\sqrt{2}} .$$

In some embodiments, an indicator or a field for one first amplitude coefficient with value 7 may correspond to the first amplitude coefficient with value 1.

In some embodiments, the value of the first amplitude coefficient corresponding to the first antenna port group (for example, the antenna port group with index Tₘ) may be 1. In some embodiments, the value of the indicator or the field for the first amplitude coefficient corresponding to the first antenna port group (for example, the antenna port group with index Tₘ) may be 15. In some embodiments, the value of the first amplitude coefficient or the indicator or the field for the first amplitude coefficient corresponding to the first antenna port group (for example, the antenna port group with index Tₘ) may not be reported in the PMI.

In some embodiments, the value of the first amplitude coefficient corresponding to the antenna port group which is not included in the second plurality of antenna port groups may be 0. In some embodiments, the value of the indicator or the field for the first amplitude coefficient corresponding to the antenna port group which is not included in the second plurality of antenna port groups may be 0. In some embodiments, the value of the first amplitude coefficient or the indicator or the field for the first amplitude coefficient corresponding to the antenna port group which is not included in the second plurality of antenna port groups may not be reported in the PMI.

In some embodiments, a value of one second amplitude coefficient may be one of

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one second amplitude coefficient may be 4 bits. In some embodiments, a value of an indicator or a field for one second amplitude coefficient may be one of {1, 2, 3, 4, 5, 6, 7, 8, 9, 10, 11, 12, 13, 14, 15}.

In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{128}} .$$

In some embodiments, an indicator or a field for one second amplitude coefficient with value 2 may correspond to the second amplitude coefficient with value

$${( \frac{1}{8192} )}^{1 / 4} .$$

In some embodiments, an indicator or a field for one second amplitude coefficient with value 3 may correspond to the second amplitude coefficient with value ⅛. In some embodiments, an indicator or a field for one second amplitude coefficient with value 4 may correspond to the second amplitude coefficient with value

$${( \frac{1}{2048} )}^{1 / 4} .$$

In some embodiments, an indicator or a field for one second amplitude coefficient with value 5 may correspond to the second amplitude coefficient with value

$$\frac{1}{2 \sqrt{8}} .$$

In some embodiments, an indicator or a field for one second amplitude coefficient with value 6 may correspond to the second amplitude coefficient with value

$${( \frac{1}{512} )}^{1 / 4} .$$

In some embodiments, an indicator or a field for one second amplitude coefficient with value 7 may correspond to the second amplitude coefficient with value ¼.

In some embodiments, an indicator or a field for one second amplitude coefficient with value 8 may correspond to the second amplitude coefficient with value

$${( \frac{1}{128} )}^{1 / 4} .$$

In some embodiments, an indicator or a field for one second amplitude coefficient with value 9 may correspond to the second amplitude coefficient with value

$$\frac{1}{\sqrt{8}} .$$

In some embodiments, an indicator or a field for one second amplitude coefficient with value 10 may correspond to the second amplitude coefficient with value

$${( \frac{1}{32} )}^{1 / 4} .$$

In some embodiments, an indicator or a field for one second amplitude coefficient with value 11 may correspond to the second amplitude coefficient with value ½. In some embodiments, an indicator or a field for one second amplitude coefficient with value 12 may correspond to the second amplitude coefficient with value

$${( \frac{1}{8} )}^{1 / 4} .$$

In some embodiments, an indicator or a field for one second amplitude coefficient with value 13 may correspond to the second amplitude coefficient with value

$$\frac{1}{\sqrt{2}} .$$

In some embodiments, an indicator or a field for one second amplitude coefficient with value 14 may correspond to the second amplitude coefficient with value

$${( \frac{1}{2} )}^{1 / 4} .$$

In some embodiments, an indicator or a field for one second amplitude coefficient with value 15 may correspond to the second amplitude coefficient with value 1.

In some embodiments, a value of one second amplitude coefficient may be one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one second amplitude coefficient may be 4 bits. In some embodiments, a value of an indicator or a field for one second amplitude coefficient may be one of {0, 1, 2, 3, 4, 5, 6, 7}.

In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{64}} .$$

In some embodiments, an indicator or a field for one second amplitude coefficient with value 2 may correspond to the second amplitude coefficient with value In some

$$\frac{1}{\sqrt{32}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{\sqrt{8}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1.

In some embodiments, a value of one second amplitude coefficient may be one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one second amplitude coefficient may be 3 bits. In some embodiments, a value of an indicator or a field for one second amplitude coefficient may be one of {0, 1, 2, 3, 4, 5, 6, 7}.

In some embodiments, an indicator or a field for one second amplitude coefficient with value 0 may correspond to the second amplitude coefficient with value

$$\frac{1}{8 \sqrt{2}} .$$

In some embodiments, an indicator or a field for one second amplitude coefficient with value 1 may correspond to the second amplitude coefficient with value ⅛.

In some embodiments, an indicator or a field for one second amplitude coefficient with value 2 may correspond to the second amplitude coefficient with value

$$\frac{1}{4 \sqrt{2}} .$$

In some embodiments, an indicator or a field for one second amplitude coefficient with value 3 may correspond to the second amplitude coefficient with value ¼.

In some embodiments, an indicator or a field for one second amplitude coefficient with value 4 may correspond to the second amplitude coefficient with value

$$\frac{1}{2 \sqrt{2}} .$$

In some embodiments, an indicator or a field for one second amplitude coefficient with value 5 may correspond to the second amplitude coefficient with value ½.

In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1. In some embodiments, one second amplitude coefficient may be a differential value corresponding to one first amplitude coefficient.

In some embodiments, a value of one second amplitude coefficient may be one of

$$\{ \frac{1}{\sqrt{2}} , 1 \} .$$

In some embodiments, the bit size for one second amplitude coefficient may be 1 bit. In some embodiments, a value of an indicator or a field for one second amplitude coefficient may be one of {0, 1}. In some embodiments, an indicator or afield for one second amplitude coefficient with value 0 may correspond to the second amplitude coefficient with value

$$\frac{1}{\sqrt{2}} .$$

In some embodiments, an indicator or a field for one second amplitude coefficient with value 1 may correspond to the second amplitude coefficient with value 1. In some embodiments, one second amplitude coefficient may be a differential value corresponding to one first amplitude coefficient.

In some embodiments, the value of the second amplitude coefficient corresponding to the antenna port group which is not included in the second plurality of antenna port groups may be 0. In some embodiments, the value of the indicator or the field for the second amplitude coefficient corresponding to the antenna port group which is not included in the second plurality of antenna port groups may be 0. In some embodiments, the value of the second amplitude coefficient or the indicator or the field for the second amplitude coefficient corresponding to the antenna port group which is not included in the second plurality of antenna port groups may not be reported in the PMI.

In some embodiments, a value of one third amplitude coefficient may be one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one third amplitude coefficient may be 3 bits. In some embodiments, a value of an indicator or a field for one third amplitude coefficient may be one of {0, 1, 2, 3, 4, 5, 6, 7}.

In some embodiments, an indicator or a field for one third amplitude coefficient with value 0 may correspond to the third amplitude coefficient with value

$$\frac{1}{8 \sqrt{2}} .$$

In some embodiments, an indicator or a field for one third amplitude coefficient with value 1 may correspond to the third amplitude coefficient with value ⅛.

In some embodiments, an indicator or a field for one third amplitude coefficient with value 2 may correspond to the third amplitude coefficient with value

$$\frac{1}{4 \sqrt{2}} .$$

In some embodiments, an indicator or a field for one third amplitude coefficient with value 3 may correspond to the third amplitude coefficient with value ¼. In some embodiments, an indicator or a field for one third amplitude coefficient with value 4 may correspond to the third amplitude coefficient with value

$$\frac{1}{2 \sqrt{2}} .$$

In some embodiments, an indicator or a field for one third amplitude coefficient with value 5 may correspond to the third amplitude coefficient with value ½. In some embodiments, an indicator or a field for one third amplitude coefficient with value 6 may correspond to the third amplitude coefficient with value

$$\frac{1}{\sqrt{2}} .$$

In some embodiments, an indicator or a field for one third amplitude coefficient with value 7 may correspond to the third amplitude coefficient with value 1. In some embodiments, one third amplitude coefficient may be a differential value corresponding to one first amplitude coefficient and/or one second amplitude coefficient.

In some embodiments, a value of one third amplitude coefficient may be one of

$$\{ \frac{1}{\sqrt{2}} , 1 \} .$$

In some embodiments, the bit size for one third amplitude coefficient may be 1 bit. In some embodiments, a value of an indicator or a field for one third amplitude coefficient may be one of {0, 1}. In some embodiments, an indicator or a field for one third amplitude coefficient with value 0 may correspond to the third amplitude coefficient with value

$$\frac{1}{\sqrt{2}} .$$

In some embodiments, an indicator or a field for one third amplitude coefficient with value 1 may correspond to the third amplitude coefficient with value 1.

In some embodiments, for bits or codepoints or values of the one or more indicators (or one or more bitmaps) for indicating nonzero coefficients with value to be 0, the value of the first amplitude coefficient corresponding to the bits or codepoints or values may be set to be 0 and/or the value of an indicator or afield for the first amplitude coefficient corresponding to the bits or codepoints or values may be set to be 0. In some embodiments, the value of the first amplitude coefficient corresponding to the bits or codepoints or values and/or the value of an indicator or a field for the first amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the second amplitude coefficient corresponding to the bits or codepoints or values may be set to be 0 and/or the value of an indicator or a field for the second amplitude coefficient corresponding to the bits or codepoints or values may be set to be 0. In some embodiments, the value of the second amplitude coefficient corresponding to the bits or codepoints or values and/or the value of an indicator or a field for the second amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the third amplitude coefficient corresponding to the bits or codepoints or values may be set to be 0 and/or the value of an indicator or a field for the third amplitude coefficient corresponding to the bits or codepoints or values may be set to be 0. In some embodiments, the value of the third amplitude coefficient corresponding to the bits or codepoints or values and/or the value of an indicator or a field for the third amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of at least one of the first phase coefficient, the second phase coefficient and the third phase coefficient corresponding to the bits or codepoints or values may be set to be 0 and/or the value of an indicator or a field for at least one of the first phase coefficient, the second phase coefficient and the third phase coefficient corresponding to the bits or codepoints or values may be set to be 0. In some embodiments, the value of at least one of the first phase coefficient, the second phase coefficient and the third phase coefficient corresponding to the bits or codepoints or values and/or the value of an indicator or a field for at least one of the first phase coefficient, the second phase coefficient and the third phase coefficient corresponding to the bits or codepoints or values may not be reported in the PMI.

In some embodiments, a value of one first phase coefficient may be e^{j2π·}^{ₚ}^{/N}^{_{PSK}}. In some embodiments, cₚ may be a value of one indicator or one field for the first phase coefficient. In some embodiments, a value of one second phase coefficient may be e^{j2π·}^{ₚ}^{/N}^{_{PSK}}. In some embodiments, cₚ may be a value of one indicator or one field for the second phase coefficient. In some embodiments, a value of one third phase coefficient may be e^{j2π·}^{ₚ}^{/N}^{_{PSK}}. In some embodiments, cₚ may be a value of one indicator or one field for the third phase coefficient. In some embodiments, cₚ may be a non-negative integer. In some embodiments, cₚ may be one of {0,1,2,3} or {0,1,2,3,4,5,6,7} or {0,1,2,3,4,5,6,7,8,9,10,11,12,13,14,15}. In some embodiments, N_{PSK} may be the size for indication of c_{P}. In some embodiments, N_{PSK} may be a positive integer. In some embodiments, N_{PSK} may be one of {2, 4, 8, 16}.

In some embodiments, the number of one or more indicators (or the field) for the plurality of first amplitude coefficients may be K_{b1}*(T−1) or K_{b1}*(T₁−1) or K_{b1}*(Tₛ−1) or

$${K}_{b 1} * {\sum }_{t = 0 , and t \neq {T}_{m}}^{T - 1} {N}_{g , t} .$$

In some embodiments, K_{b1} may be the bit size for each of the first amplitude coefficients. For example, K_{b1} may be 2 or 3 or 4 bits.

In some embodiments, the number of one or more indicators (or the field) for the plurality of first amplitude coefficients may be based on the number of the plurality of fourth vectors and either one of. the number of the first plurality of antenna port groups; or the number of the second plurality of antenna port groups.

In some embodiments, the number of one or more indicators (or the field) for the plurality of first amplitude coefficients may be K_{b1}*(T−1)*M_{w} or K_{b1}*(T₁−1)*M_{w} or K_{b1}*(T−1)*M_{w} or

$${K}_{b 1} * {M}_{w} * {\sum }_{t = 0 , and t \neq {T}_{m}}^{T - 1} {N}_{g , t} .$$

In some embodiments, the one or more indicators (or the field) for the plurality of first amplitude coefficients may be comprised in the PMI or in the first part of the PMI or in the second part of the PMI.

In some embodiments, the number of one or more indicators (or the field) for the plurality of first phase coefficients may be based on the number of the first plurality of antenna port groups or the number of the second plurality of antenna port groups. In some embodiments, the number of one or more indicators (or the field) for the plurality of first phase coefficients may be based on the number of the first plurality of antenna port groups minus 1 or the number of the second plurality of antenna port groups minus 1.

In some embodiments, the number of one or more indicators (or the field) for the plurality of first phase coefficients may be K_{b2}*(T−1) or K_{b2}*(T₁−1) or K_{b2}*(Tₛ−1) or

$${K}_{b 2} * {\sum }_{t = 0 , and t \neq {T}_{m}}^{T - 1} {N}_{g , t} .$$

In some embodiments, K_{b2} may be the bit size for each of the first phase coefficients. For example, K_{b2} may be 2 (e.g. N_{PSK}=4) or 3 (e.g. N_{PSK}=8) or 4 bits (e.g. N_{PSK}=16).

In some embodiments, the number of one or more indicators (or the field) for the plurality of first phase coefficients may be based on the number of the plurality of fourth vectors and either one of: the number of the first plurality of antenna port groups; or the number of the second plurality of antenna port groups.

In some embodiments, the number of one or more indicators (or the field) for the plurality of first phase coefficients may be K_{b2}*(T−1)*M_{w} or K_{b2}*(T₁−1)*M_{w} or K_{b2}·(Tₛ−1)M_{w} or

$${K}_{b 2} * {M}_{w} * {\sum }_{t = 0 , and t \neq {T}_{m}}^{T - 1} {N}_{g , t} .$$

In some embodiments, a first vector may be after a schimidt orthogonalization based on the first vectors in this disclosure.

In some embodiments, antenna ports of the first plurality of antenna port groups may be in one CSI-RS resource. In some embodiments, each antenna port group may be at least one of: antenna ports within one code domain multiplexing (CDM) group in the CSI-RS resource; and a subset of antenna ports for the CSI-RS resource. In some embodiments, each antenna port group in the first and/or second plurality of antenna port groups may correspond to one CSI-RS resource. In some embodiments, different antenna port groups in the first and/or second plurality of antenna port groups may correspond to different CSI-RS resources.

In some embodiments, the terminal device may determine and/or report a first set of codebook indicators and a second set of codebook indicators in one CSI report or in one PMI report. In some embodiments, the first set of codebook indicators may correspond to a first value of the number of the second plurality of antenna port groups, and the second set of codebook indicators may correspond to a second value of number of the second plurality of antenna port groups. In some embodiments, at least one parameter or indicator corresponding to the first set of codebook indicators may be different from at least one parameter or indicator corresponding to the second set of codebook indicators.

In some embodiments, the value of N3 corresponding to the first set of codebook indicators may be no larger than or less than the value of N3 corresponding to the second set of codebook indicators. In some embodiments, a value of the first parameter and/or a value of the fourth parameter corresponding to the first set of codebook indicators may be no larger than or less than a value of the first parameter and/or a value of the fourth parameter corresponding to the second set of codebook indicators. In some embodiments, the first value of the number of the second plurality of antenna port groups may be 1. In some embodiments, the second value of the number of the second plurality of antenna port groups may be 2 or 3 or 4. In some embodiments, the first set of codebook indicators may be single-TRP hypothesis. In some embodiments, the second set of codebook indicators may be multi-TRP hypothesis.

In some embodiments, the bit size of the one or more indicators or fields for the plurality of third amplitude coefficients and/or the bit size of the one or more indicators or fields for the plurality of third phase coefficients corresponding to the first set of codebook indicators may be less than the bit size of the one or more indicators or fields for the plurality of third amplitude coefficients and/or the bit size of the one or more indicators or fields for the plurality of third phase coefficients corresponding to the second set of codebook indicators.

In some embodiments, the bit size of the one or more indicators for the plurality of first vectors and/or the bit size of the one or more indicators for the plurality of second vectors may be based on ceil(log 2(nchoosek(N₁N₂, L))) or ceil(log 2(nchoosek(N₁N₂, Lₜ*T))) or ceil(log 2(nchoosek(N₁N₂, Lₜ*T₁))) or ceil(log 2(nchoosek(N₁N₂, Lₜ*Tₛ))).

In some embodiments, an indicator or a field for the plurality of first vectors may indicate a group of first vectors or a group of second vectors. For example, the number of first vectors or the number of second vectors in the group may be L or L or Lₜ*_{T} or Lₜ*Tₛ. In some embodiments, an indicator or a field for the plurality of second vectors may indicate a group of second vectors. For example, the number of second vectors in the group may be Lₜ or L or Lₜ*T₁ or Lₜ*T_{S}.

Below table 10 illustrates an example mapping order of CSI fields of one CSI report, CSI part 2 (defined by information element codebookType=typeII-r16 or typeII-PortSelection-r16)

TABLE 10
One example of mapping order of CSI fields of one CSI report, CSI part 2

| CSI report number | CSI fields |
|---|---|
| CSI report #n | PMI fields X₁, if reported |
| CSI part 2, group 0 | |
| CSI report #n | The following PMI fields X₂, from left to right,: {i_{2,3,l}: l = |
| CSI part 2, group 1 | 1, ... , υ} i_{1,5}, {i_{1,6,l} = 1, ... , υ} and |
| | $max ( 0 , ⌈ \frac{{K}^{NZ}}{2} ⌉ - υ ) \times 3 highest priority bits of \{ {i}_{2 , 4 , l} : l =$ |
| | $1 , … , υ \} , max ( 0 , ⌈ \frac{{K}^{NZ}}{2} ⌉ - υ ) \times 4 highest priority bits of$ |
| | {i_{2,5,l}: l = 1, ... , υ} and ν * 2LM_{υ} − └K^{NZ}/2┘ highest |
| | priority bits of {i_{1,7,l}: l = 1, ... , υ}, in decreasing order of |
| | priority based on the corresponding function Pri(l, i, f) |
| | (for example, defined by clause 5.2.3 of TS38.214), if |
| | reported |
| CSI report #n | The following PMI fields X₂, from left to right : |
| CSI part 2, group 2 | $min ( {K}^{N Z} - ν , ⌊ \frac{{K}^{NZ}}{2} ⌋ ) \times 3 lowest priority bits of$ |
| | $\{ {i}_{2 , 4 , l} : l = 1 , … , υ \} , min ( {K}^{N Z} - v , ⌊ \frac{{K}^{NZ}}{2} ⌋ ) \times 4 lowest$ |
| | priority bits of {i_{2,5,l}:l = 1, ... , υ} and └K^{NZ}/2┘ lowest |
| | priority bits of {i_{1,7,l}:l = 1, ... , υ}, in decreasing order of |
| | priority based on the corresponding function Pri(l, i, f) |
| | (for example, defined by clause 5.2.3 of TS38.214), if |
| | reported |

Below table 11 illustrates an example mapping order of CSI fields of one CSI report, CSI part 2 (defined by information element c codebookType=typeII-PortSelection-r17).

TABLE 11
Another example of mapping order of CSI fields of one CSI report, CSI part 2

| CSI report number | CSI fields |
|---|---|
| CSI report #n | PMI fields X₁, if reported |
| CSI part 2, group 0 | |
| CSI report #n | The following PMI fields X₂, from left to right,: |
| CSI part 2, group 1 | $\{ {i}_{2 , 3 , l} : l = 1 , … , υ \} ( max ( 0 , ⌈ \frac{{K}^{NZ}}{2} ⌉ - υ ) ) \times 3 highest priority bits of$ |
| | $\{ {i}_{2 , 4 , l} : l = 1 , … , υ \} , ( max ( 0 , ⌈ \frac{{K}^{NZ}}{2} ⌉ - υ ) ) \times 4 highest$ |
| | priority bits of {[i_{2,5,l}: l = 1, ... , υ} and v * K₁M − [K^{NZ}/2] |
| | highest priority bits of {i_{1,7,l}: l = 1, ... , υ}, in decreasing |
| | order of priority based on the corresponding function |
| | Pri(l, i, f) (for example, defined in clause 5.2.3 of |
| | TS38.214), if reported |
| CSI report #n | The following PMI fields X₂, from left to right: |
| CSI part 2, group 2 | $( min ( {K}^{NZ} - v , ⌊ \frac{{K}^{NZ}}{2} ⌋ ) ) \times 3 lowest priority bits of$ |
| | $\{ {i}_{2 , 4 , l} : l = 1 , … , υ \} , ( min ( {K}^{NZ} - v , ⌊ \frac{{K}^{NZ}}{2} ⌋ ) ) \times 4 lowest$ |
| | priority bits of {[i_{2,5,l}: l = 1, ... , υ} and [K^{NZ}/2] lowest |
| | priority bits of {[i_{1,7,l}: l = 1, ... , υ}, in decreasing order of |
| | priority based on the corresponding function Pri(l, i, f) |
| | (for example, defined in clause 5.2.3 of TS38.214), if |
| | reported |

As discussed above, the multi-TRP transmission is expected to be supported. In case of the multi-TRP transmission, more parameters needed to be reported to the network device compared with single-TRP transmission. For example, the terminal device needs to report a CSI report for a new codebook. In case of a CSI for CJT, there may be SD/FD bases and/or phase/amplitude coefficients per TRP to be reported. However, the CSI report defined in release 16 and release 17 does not support reporting a CSI for a new codebook at a TRP level.

Embodiments of the present disclosure provide a solution for configuring and transmitting the CSI feedback. In the present solution, CSI feedback comprises a plurality of partitions with different omission priorities, and parameters associated with one or more of a plurality of CSI-RS allocations may be included in plurality of partitions. In this way, the priority rule for reporting the parameters may be updated to adaptable for the scenario where a multi-TRP is supported.

For ease of discussion, some terms used in the following description are listed as below:
An omission priority: a priority for controlling dropping or omitting. Specifically, different partitions/information groups in the CSI feedback may be configured with different omission priorities. In case that the transmission resource is insufficient, the partition(s)/information group(s) (including the related parameters) with lower omission priority(ies) would be dropped or omitted first.
A CSI-RS allocation: refers to a CSI-RS unit, a CSI-RS resource, a group of CSI-RS resources, or a group of CSI-RS ports. In some embodiments, one CSI-RS allocation may correspond to a TRP.
A first CSI-RS allocation: refers to a specific CSI-RS allocation, such as a CSI-RS allocation corresponding to a primary TRP, a TRP with index value of 0, a TRP with strongest amplitude coefficient, or a TRP with the maximum power.
A first TRP: refers to a specific TRP, such as, a primary TRP, a TRP with index value of 0, a TRP with strongest amplitude coefficient, or a TRP with the maximum power.
A first group of CSI-RS ports: refers to a specific group of CSI-RS ports, such as a group of CSI-RS ports corresponding to a first CSI-RS allocation, a primary TRP, a TRP with index value of 0, a TRP with strongest amplitude coefficient, or a TRP with the maximum power.

In the context of the present application, the terms “transmission occasions”, “reception occasions”, “repetitions”, “transmission”, “reception”, “physical downlink shared channel (PDSCH) transmission occasions”, “PDSCH repetitions”, “physical uplink shared channel (PUSCH) transmission occasions”, “PUSCH repetitions”, “physical uplink control channel (PUCCH) occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably.

In the context of the present application, the terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably.

The terms “precoding matrix”, “precoding”, “beam”, “beamforming” and “precoder” may be used interchangeably. The terms “vector”, “bases” and “basis” can be used interchangeably.

In the context of the present application, the terms “single TRP”, “single TCI state”, “single TCI”, “S-TCI”, “single CORESET”, “single control resource set pool”, “S-TRP” and “S-TCI state” can be used interchangeably.

The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

In the context of the present application, the terms “pool”, “set”, “subset”, “group”, “unit” and “subgroup” can be used interchangeably.

In the context of the present application, the terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field” and “field size” can be used interchangeably.

In the context of the present application, the terms “first vector”, “first beam”, “first bases”, “spatial domain/SD basis vectors”, “spatial domain/SD vectors”, “spatial domain/SD basis”, “spatial domain/SD bases” and “first basis” can be used interchangeably.

In the context of the present application, the terms “second vector”, “second beam”, “beam”, “second bases”, “spatial domain/SD basis vectors corresponding to a TRP index”, “spatial domain/SD vectors corresponding to a TRP index”, “spatial domain/SD basis corresponding to a TRP index”, “spatial domain/SD bases corresponding to a TRP index” “second basis corresponding to a TRP index” and “second basis” can be used interchangeably.

In the context of the present application, the terms “third vector”, “third bases”, “frequency domain/FD basis vectors”, “frequency domain/FD vectors”, “frequency domain/FD basis”, “frequency domain/FD bases”, “third basis”, “third vector corresponding to a TRP index”, “third bases corresponding to a TRP index”, “frequency domain/FD basis vectors corresponding to a TRP index”, “frequency domain/FD vectors corresponding to a TRP index”, “frequency domain/FD basis corresponding to a TRP index”, “frequency domain/FD bases corresponding to a TRP index”, and “third basis corresponding to a TRP index” can be used interchangeably.

In the context of the present application, the terms “a TRP”, “a TRP group”, “a CSI-RS resource” and “a group of CSI-RS ports” can be used interchangeably.

In the context of the present application, the terms “a TRP index”, “a TRP group index”, “a CSI-RS resource index” and “a group of CSI-RS ports index” can be used interchangeably.

In the context of the present application, the terms “element of indication field”, “parameter”, “indication” can be used interchangeably.

Principles and implementations of the present disclosure will be described in detail below with reference to the figures.

### Example of Communication Network

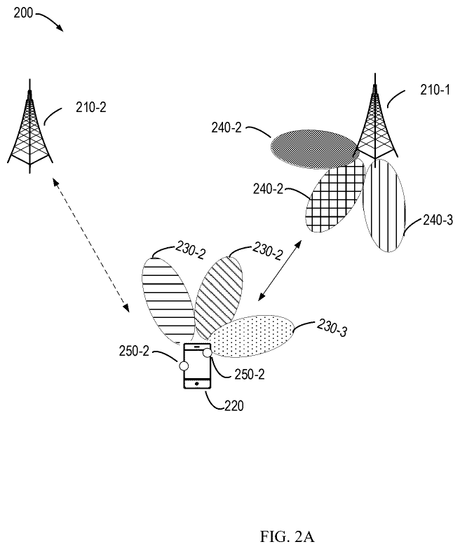

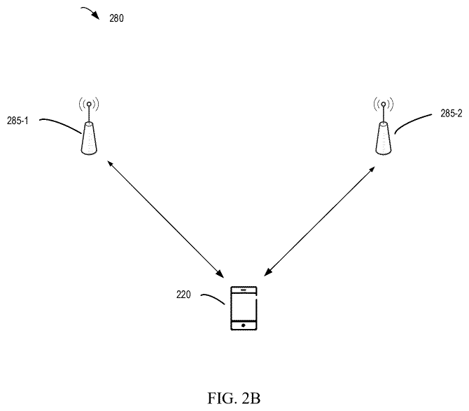

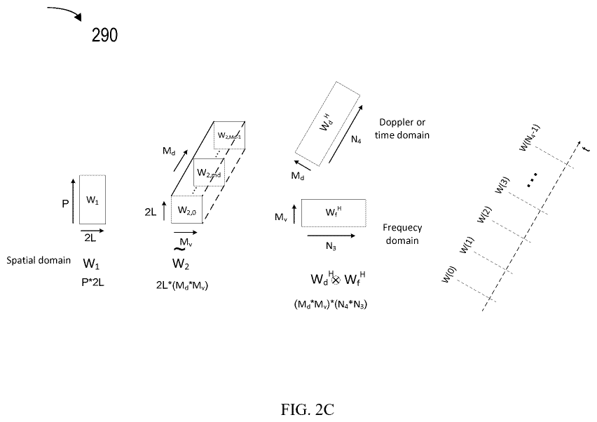

FIG. 2A shows an example communication environment 200 in which example embodiments of the present disclosure can be implemented.

The communication environment 200 includes a network device 210-1 and a terminal device 220, and further the network device 210-1 can communicate with the terminal device 220 via physical communication channels or links. Additionally, the network device 210-1 may provide more than one serving area.

Optionally, in some embodiments, the communication environment 200 also comprises another network device 210-2, which also may communicate with the terminal device 220. For purpose of discussion, the network devices 210-1 and 210-2 are collectively or individually referred to as network device 210, respectively.

In the specific example of communication environment 200, a link from the terminal device 220 to the network device 210-1 is referred to as uplink, while a link from the network device 210-1 to the terminal device 220 is referred to as a downlink. Further, the MIMO is supported in the communication environment 200, such that the network device 210-1 and the terminal device 220 may communicate with each other via different beams to enable a directional communication. In downlink, the network device 210-1 is a transmitting (TX) device (or a transmitter) and the terminal device 220 is a receiving (RX) device (or a receiver), and the network device 210-1 may transmit downlink transmission to the terminal device 220 via one or more beams. As illustrated in FIG. 2A, the network device 210-1 transmits downlink transmission to the terminal device 220 via the beams 240-1 to 240-3.

Correspondingly, in uplink, the network device 210-1 is a RX device (or a receiver) and the terminal device 220 is a TX device (or a transmitter), and the terminal device 220 may transmit uplink transmission to the network device 210-1 via one or more beams. As illustrated in FIG. 2A, the terminal device 220 transmits uplink transmission to the network device 210-1 via the beams 230-1 to 230-3. For purpose of discussion, the beams 230-1 to 230-3 or beams 240-1 to 240-3 are collectively or individually referred to as beam 230 or beam 240, respectively.

In addition, the terminal device 220 may be deployed with more than one panel.

As illustrated in FIG. 2A, the terminal device 220 is deployed with panels 250-1 and 250-2.

In the following, the panels 250-1 and 250-2 may be referred to as the first panel 250-1 and the second panel 250-2, respectively. In some embodiments, panels 250-1 and 250-2 may correspond to different sets of capability parameters, respectively.

In some embodiments, one panel may be associated with one or more CSI-RS allocations/beams. In this way, the terminal device 220 may use a specific panel to transmit the directional signal to the network device 210-1 via specific beam(s) associated with the CSI-RS allocations.

In some embodiments, different panels correspond to different panel types/capability value sets. For example, the panels 250-1 and 250-2 may correspond to different number of SRS ports, frequency resource (frequency band, CC, beam and so on) and any other suitable capability parameters (such as, capability value sets).

Further, in the specific example of FIG. 2A, the network device 210-1 may transmit configuration(s) for CSI feedback to the terminal device 220, and the terminal device 220 also may transmit the CSI feedback to the network device 210-1.

In some embodiments, the CSI feedback is transmitted on PUSCH. Alternatively, in some other embodiments, the CSI feedback is transmitted on PUCCH.

Further, the terminal device 220 may communicate with the network device 210 via one or more TRPs. FIG. 2B shows an example scenario of the communication network 280.

In the specific example of FIG. 2B, a first TRP 285-1 and the second TRP 285-2 may be used for the communication between the terminal device 220 and the network device(s) 210.

In some embodiments, the network device 210 may communicate with the terminal device 220 via a first TRP and/or a second TRP and/or a third TRP and/or a fourth TRP. For example, the first TRP and/or the second TRP and/or the third TRP and/or the fourth TRP may be included in a same serving cell or different serving cells provided by the network device 210. Although some embodiments of the present disclosure are described with reference to the first TRP and/or the second TRP and/or the third TRP and/or the fourth TRP within same serving cell provided by the network device 210, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

FIG. 2C illustrates a schematic diagram 290 of spatial domain, frequency domain and Doppler/time domain basis. As illustrated in FIG. 2C, in a plurality of codebooks or precoding matrices which comprises spatial domain, frequency domain and doppler/time domain vectors. In some embodiments, in each time point or time unit in the doppler/time domain, such as t=0, 1, 2, 3, . . . , N₄−1, there is a corresponding W(t), as illustrated in FIG. 2C. Parameter W(t) may be obtained by below equation (1):

$$W ( t ) = {W}_{1} * * {( {W}_{f} ⊗ {W}_{d} )}^{H} , t = \{ 0 , 1 , … {N}_{4} - 1 \} \qquad ( 1 )$$

In some embodiments, the work scope of type-II codebook refinement for CJT multi-TRP includes down-selecting at least one or merging from a predefined codebook structure:

In some embodiments, one example of the predefined codebook structure is enabled through per-TRP (port-group or resource) SD/FD basis selection and relative co-phasing/amplitude (including wideband and/or sunbband). Example formulation (N=number of TRPs or TRP groups) is as below:

$$[ \begin{matrix}( {a}_{1} {p}_{1} ) \times {W}_{1 , 1} {\tilde{W}}_{2 , 1} {W}_{f , 1}^{H} \\ ⋮ \\ ( {a}_{{N}_{T R P}} {p}_{{N}_{T R P}} ) \times {W}_{1 , {N}_{T R P}} {\tilde{W}}_{2 , {N}_{T R P}} {W}_{f , {N}_{T R P}}^{H}\end{matrix} ]$$

where aᵣ=co-amplitude and pᵣ=co-phase. Further, include special case of aᵣ=pᵣ=1 (no co-scaling) or aᵣ=0.

In some embodiments, another example of the predefined codebook structure is enabled through per-TRP (port-group or resource) joint SD-FD basis selection and relative co-phasing/amplitude (including wideband and/or sunbband). Example formulation (N=number of TRPs or TRP groups):

$$[ \begin{matrix}( {a}_{1} {p}_{1} ) \times {W}_{SF , 1} {\tilde{W}}_{2 , 1} \\ ⋮ \\ ( {a}_{{N}_{T R P}} {p}_{{N}_{T R P}} ) \times {W}_{SF , {N}_{T R P}} {\tilde{W}}_{2 , {N}_{T R P}}\end{matrix} ]$$

where aᵣ=co-amplitude and pᵣ=co-phase. Further, include special case of aᵣ=pᵣ=1 (no co-scaling) or aᵣ=O.

In some embodiments, a further example of the predefined codebook structure is enabled through per-TRP (port-group or resource) SD basis selection and joint (across N TRPs) FD basis selection. Example formulation (N=number of TRPs or TRP groups):

$$[ \begin{matrix}{W}_{1 , 1} & 0 & 0 & 0 \\ 0 & ⋱ & 0 & 0 \\ 0 & 0 & {W}_{1 , {N}_{T R P}} & \\ 0 & 0 & & \end{matrix} ] {\tilde{W}}_{2} {W}_{f}^{H}$$

It is to be understood that the number of devices and their connections in FIG. 2A and FIG. 2B are given for the purpose of illustration without suggesting any limitations to the present disclosure. The communication environment 200 and communication network 280 may include any suitable number of network devices and/or terminal devices and/or TRPs adapted for implementing implementations of the present disclosure.

In some embodiments, the terminal device 220 and the network device 210 may communicate with each other via a channel such as a wireless communication channel on an air interface (e.g., Uu interface). The wireless communication channel may comprise a PUCCH, a PUSCH, a physical random-access channel (PRACH), a physical downlink control channel (PDCCH), a PDSCH and a physical broadcast channel (PBCH). Of course, any other suitable channels are also feasible.

The communications in the communication environment 200 and communication 1s network 280 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example of Processes

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 220 and the network device 210 (such as, exchanging configuration (s) and so on). It is to be understood that the interactions may be implemented either in one single signaling/message or multiple signaling/messages, including system information, radio resource control (RRC) message, downlink control information (DCI) message, uplink control information (UCI) message, media access control (MAC) control element (CE) and so on. The present disclosure is not limited in this regard.

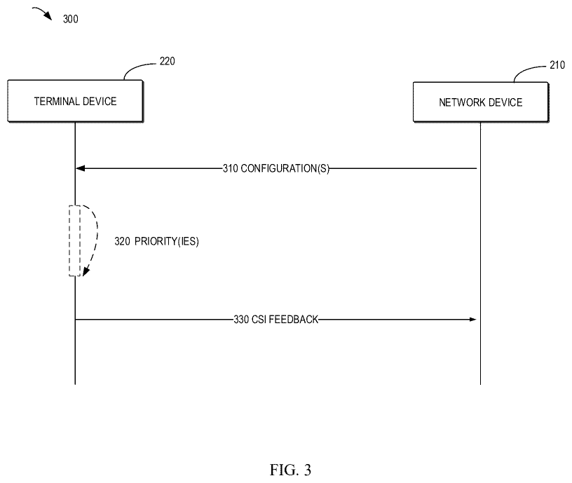

Principle and implementations of the present disclosure will be described in detail below with reference to FIG. 3, which shows a signaling chart illustrating a process 300 of communication according to some example embodiments of the present disclosure. For the purpose of discussion, the process 300 will be described with reference to FIG. 2A and FIG. 2B. The process 300 may involve the terminal device 220 and the network device 210.

In some embodiments, there may be a plurality of TRPs, for example N TRPs/TRP groups, where N is larger than 2. Further, each TRP/TRP group may be indexed by t, t∈{0, 1, . . . N−1} or t∈{1, 2, . . . N}).

In some embodiments, each TRP/TRP group corresponds to a CSI-RS allocation, such as, a CSI-RS unit, a CSI-RS resource, a group of CSI-RS resources, or a group of CSI-RS ports.

In one specific embodiment, there are a plurality of ports used for CSI-RS. The number of the plurality of ports is represented to be P, where P may be one of {2, 4, 8, 12, 16, 24, 32}. The P ports may be partitioned into N port groups, N may be 1 or 2 or 3 or 4, such that each TRP/TRP group may correspond to a group of CSI-RS ports.

In some embodiments, a value of the first parameter of antenna port configuration may be represented as N1. For example, N1 may be a positive integer. For example, N1 may be at least one of {2, 3, 4, 6, 8, 12, 16}. In some embodiments, a value of the second parameter of antenna port configuration may be represented as N2. For example, N2 may be a positive integer. For example, N2 may be at least one of {1, 2, 3, 4}. In some embodiments, the first parameter of antenna port configuration and the second parameter of antenna port configuration may be configured in one higher layer parameter.

In some embodiments, the number of antenna ports in one antenna port group may be determined based on the first parameter of antenna port configuration and a second parameter of antenna port configuration. In some embodiments, each port group may include P_t ports, where, P_t=N1*N2*2 or P t=N1*N2*2/N.

Alternatively, or in addition, in another specific embodiment, the terminal device 220 may be configured with K CSI-RS allocations, wherein each CSI-RS allocation may correspond to one TRP/TRP group, and K may be same as N. In some embodiments, each CSI-RS allocation may include P ports, P=N1*N2*2.

In case of CJT scenario, for each TRP/TRP group, the number of SD bases may be Lₜ, the total number of SD bases for the plurality of TRPs may be L=N*Lt. Alternatively, for a first TRP, the number of SD bases may be Lₛ, the total number of SD bases for the plurality of TRPs may be L=N*Ls.

In some embodiments, the network device 210 may configure the terminal device 220 to report CSI feedback. As shown in FIG. 3, the terminal device 220 receives 310 from a network device, configuration(s) for the CSI feedback.

Next, the terminal device 220 transmits 330 the CSI feedback to the network device 210 based on the at least one configuration.

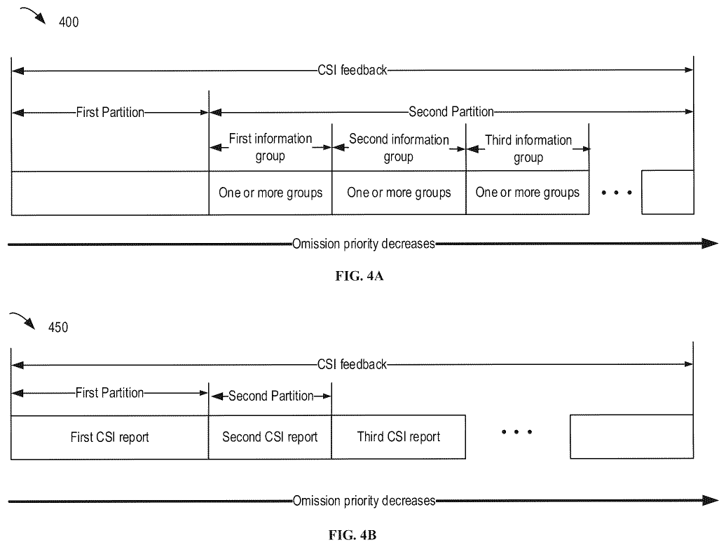

In some embodiments, the CSI feedback comprises a plurality of partitions with different omission priorities. FIG. 4A and FIG. 4B illustrate example blocks of CSI feedback 400 and 450 according to some embodiments of the present disclosure. It is to be understood that the specific structures illustrated in FIG. 4A and FIG. 4B are only for the purpose of illustration without suggesting any limitations. In other words, the numbers of partitions, information groups may be changed.

In some embodiments, the plurality of partitions comprises parameters associated with one or more of a plurality of CSI-RS allocations. In case that a plurality of CSI-RS allocations are available (i.e., a multi-TRP is supported), the parameters may be transmitted according to different omission priorities, such that the priority rule for reporting the CSI parameters is updated to adaptable for the scenario where a multi-TRP is supported.

In some embodiments, the terminal device 220 determines 320 priorities and includes the parameters into the plurality of partitions of the CSI feedback based on the priorities. In some embodiments, the terminal device 220 determines a respective first priority for a CSI-RS allocation of the plurality of CSI-RS allocations. In this way, the parameters may be transmitted in a priority order of CSI-RS allocations. Alternatively, in some other embodiments, the terminal device 220 determines a respective second priority for a parameter of the parameters comprised in the CSI feedback. In this way, the dropping risk of the parameters with a higher priority may be reduced.

In some embodiments, the priorities may be determined based on one or more factors. One example factor is an index of a CSI-RS resource. Another example factor is an index of a CSI-RS resource group. A further example factor is an index of group of CSI-RS ports. The other factors, include but are not limited to, an index of an SD basis (such as, an index of an SD basis corresponding to a CSI-RS allocation).

It is to be understood that the above examples of factors are illustrated only for the purpose of illustration without suggesting any limitations. In other example embodiments, other factors may be defined. The present disclosure is not limited in this regard.

Additionally, in some embodiments, different factors are configured with different contributions when determining the priorities. In this way, the priority rule is more flexible.

In some embodiments, the terminal device 220 prioritizes parameters associated with the first CSI-RS allocation of the plurality of CSI-RS allocations. Merely for the purpose of illustration without suggesting any limitations, the first CSI-RS allocation corresponds to one of the following:
a primary TRP,
a TRP with index value of 0,
a TRP with strongest amplitude coefficient, or
a TRP with the maximum power.

In this way, the dropping risk for the parameters corresponding to a relative important TRP is reduced. That is, even if some CSI parameters with lower priority are dropped, (e.g. maybe not suitable for multi-TRP CJT), the network device 210 still may obtain the complete CSI parameters for a specific TRP, such that the communication between the network device 210 and the terminal device 200 would not be suspended, because at least a single-TRP transmission may be performed.

Alternatively, or in addition, in some embodiments, the terminal device 220 prioritizes parameters associated with a first CSI-RS resource group comprising the first CSI-RS allocation.

Alternatively, or in addition, in some embodiments, the terminal device 220 prioritizes parameters associated with a first group of CSI-RS ports corresponding to the first CSI-RS allocation.

In this way, CSI parameters (or a first subset of PMI fields and/or CQI) corresponding to one TRP/TRP group (represented as the first TRP/TRP group) has a higher priority than CSI parameters (or other subsets of PMI fields and/or CQI) corresponding to other TRPs (i.e., a subset of TRPs/TRP groups with the first TRP/TRP group excluded, for example, N−1 TRPs/TRP groups excluding the first TRP/TRP group).

According to some embodiments, even if CSI parameters with lower priority are dropped, (e.g. parameters that are not suitable for multi-TRP CJT), at least single-TRP transmission can still work well to guarantee the communication between the terminal device 220 and the network device 210.

In the following text, some examples of priority rule are listed as below for better understanding. In some embodiments, for given CSI feedback (such as, a CSI report #n), each reported element of indication fields (such as, the bitmap, the amplitude coefficients and the phase coefficients) indexed by one or more parameters as below:
r, layer index,
i, SD basis index among the plurality of TRPs (e.g. an index of a first basis),
iₜ, SD basis index corresponding to a TRP with index t, (e.g. an index of a second basis),
t, TRP index,
f, FD basis index (e.g. an index of a third basis), and
fₜ, FD basis index corresponding to a TRP with index t, (e.g. an index of a third basis).

In some embodiments, the indexes of SD bases may be indexed among the plurality of TRPs, and the order may be in increasing order of the plurality of TRPs, such as, {L₀, L₁, . . . L_{N-1}}, where Li is an index of the TRP, i={0, 1, . . . , N−1}.

Alternatively, in some other embodiments, the indexes of SD bases corresponding to the strongest/first TRP may be indexed first, and then the indexes of SD bases corresponding to the other TRPs (i.e., a subset of TRPs excluding the strongest/first TRP) may be indexed an increasing order of the other TRPs. In this event, the order may be {Lₛ, L₀, . . . L_{N-1}}, where Ls is the index of the first TRP.

In one specific example, a priority associated with each reported element (such as, a parameter) is determined by below equation (2A) or (2B).

$$Pri ( l , i , f ) = 2 \cdot L \cdot {υ}_{r i} \cdot π ( f ) + {υ}_{r i} \cdot i + r , \qquad ( 2 A )$$

$$Pri ( l , i , {f}_{t} ) = 2 \cdot L \cdot {υ}_{r i} \cdot π ( {f}_{t} ) + {υ}_{r i} \cdot i + r , \qquad ( 2 B ) .$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r} or π ( f ) = f .$$

In some embodiments,

$$π ( {f}_{t} ) = min ( 2 \cdot {n}_{3 , r}^{( {f}_{t} )} , 2 \cdot ( {N}_{3} - {n}_{3 , r}^{( f )} - 1 ) or π ( {f}_{t} ) = {n}_{3 , r}^{( {f}_{t} )} or π ( {f}_{t} ) = {f}_{t} .$$

In some embodiments, r=1, 2, . . . , vᵣᵢ. In some embodiments, i=0, 1, . . . , 2L−1. In some embodiments, f=0, 1, . . . , Mᵥ−1. In some embodiments, fₜ=0, 1, . . . , Mᵥ−1. In some embodiments, t=0, 1, . . . , N−1. In some embodiments, t=1, 2, . . . , N.

In another specific example, a priority associated with each reported element (such as, a parameter) (such as, a parameter) is determined by below equation (3A) or 3B.

$$Pri ( l , i , f , t ) = 2 \cdot {L}_{t} \cdot {v}_{r i} \cdot N \cdot π ( f ) + {v}_{r i} \cdot {i}_{t} \cdot N + {v}_{r i} \cdot t + r , \qquad ( 3 A )$$

$$Pri ( l , i , {f}_{t} , t ) = 2 \cdot {L}_{t} \cdot {v}_{r i} \cdot N \cdot π ( {f}_{t} ) + {v}_{r i} \cdot {i}_{t} \cdot N + {v}_{r i} \cdot t + r , \qquad ( 3 B )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r} or π ( f ) = f .$$

In some embodiments,

$$π ( {f}_{t} ) = min ( 2 \cdot {n}_{3 , r}^{( {f}_{t} )} , 2 \cdot ( {N}_{3} - {n}_{3 , r}^{( {f}_{t} )} ) - 1 ) or π ( {f}_{t} ) = {n}_{3 , r} or π ( {f}_{t} ) = {f}_{t} .$$

In some embodiments, r=1, 2, . . . , vᵣᵢ. In some embodiments, iₜ=0, 1, . . . , 2Lₜ−1. In some embodiments, f=0, 1, . . . , Mᵥ−1. In some embodiments, fₜ=0, 1, . . . , Mᵥ−1. In some embodiments, t=0, 1, . . . , N−1. In some embodiments, t=1, 2, . . . , N.

According to the above equation (3A) or (3B), the order of contribution for the priority (such as, a parameter) may be {an FD basis index or an FD basis index corresponding to a TRP index, an SD basis index corresponding to a TRP index, a TRP index, a layer index}. For example, the order may be from lower priority to higher priority.

In a further specific example, a priority associated with each reported element (such as, a parameter) is determined by below equation (4A) or (4B).

$$Pri ( l , i , f , t ) = 2 \cdot {L}_{t} \cdot {v}_{r i} \cdot N \cdot π ( f ) + {v}_{r i} \cdot t \cdot 2 \cdot {L}_{t} + {v}_{r i} \cdot {i}_{t} + r , \qquad ( 4 A )$$

$$Pri ( l , i , {f}_{t} , t ) = 2 \cdot {L}_{t} \cdot {v}_{r i} \cdot N \cdot π ( {f}_{t} ) + {v}_{r i} \cdot t \cdot 2 \cdot {L}_{t} + {v}_{r i} \cdot {i}_{t} + r \qquad ( 4 B )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r} or n ( f ) = f .$$

In some embodiments,

$$π ( {f}_{t} ) = min ( 2 \cdot {n}_{3 , r}^{( {f}_{t} )} , 2 \cdot ( {N}_{3} - {n}_{3 , r}^{( {f}_{t} )} - 1 ) or π ( {f}_{t} ) = {n}_{3 , r}^{( {f}_{t} )} or π ( {f}_{t} ) = {f}_{t} .$$

In some embodiments, r=1, 2, . . . , vᵣᵢ. In some embodiments, iₜ=0, 1, . . . , 2Lₜ−1. In some embodiments, f=0, 1, . . . , Mᵥ−1. In some embodiments, fₜ=0, 1, . . . , Mᵥ−1. In some embodiments, t=0, 1, . . . , N−1. In some embodiments, t=1, 2, . . . , N.

According to the above equation (4A) or (4B), the order of contribution for the priority may be {an FD basis index or an FD basis index corresponding to a TRP index, a TRP index, an SD basis index corresponding to a TRP index, a layer index}. For example, the order may be from lower priority to higher priority.

In a further specific example, a priority associated with each reported element (such as, a parameter) is determined by below equation (5A) or (5B) or (5C) or (5D).

$$Pri ( l , i , f , t ) = t \cdot 2 \cdot {L}_{t} \cdot {v}_{r i} \cdot {\sum }_{f = 0}^{{M}_{v} - 1} ( π ( f ) ) + 2 \cdot {L}_{t} \cdot {v}_{r i} \cdot π ( f ) + {v}_{r i} \cdot {i}_{t} + r \qquad ( 5 A )$$

$$Pri ( l , i , f , t ) = t \cdot 2 \cdot {L}_{t} \cdot {v}_{r i} \cdot max ( π ( f ) ) + 2 \cdot {L}_{t} \cdot {v}_{r i} \cdot π ( f ) + {v}_{r i} \cdot {i}_{t} + r \qquad ( 5 B )$$

$$Pri ( l , i , {f}_{t} , t ) = t \cdot 2 \cdot {L}_{t} \cdot {v}_{r i} \cdot {\sum }_{f = 0}^{{M}_{v} - 1} ( π ( {f}_{t} ) ) + 2 \cdot {L}_{t} \cdot {v}_{r i} \cdot π ( {f}_{t} ) + {v}_{r i} \cdot {i}_{t} + r \qquad ( 5 C )$$

$$Pri ( l , i , {f}_{t} , t ) = t \cdot 2 \cdot {L}_{t} \cdot {v}_{r i} \cdot max ( π ( {f}_{t} ) ) + 2 \cdot {L}_{t} \cdot {v}_{r i} \cdot π ( {f}_{t} ) + {v}_{r i} \cdot {i}_{t} + r \qquad ( 5 D )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r} or π ( f ) = f .$$

In some embodiments,

$$π ( {f}_{t} ) = min ( 2 \cdot {n}_{3 , r}^{( {f}_{t} )} , 2 \cdot ( {N}_{3} - {n}_{3 , r}^{( {f}_{t} )} ) - 1 ) or π ( {f}_{t} ) = {n}_{3 , r}^{( {f}_{t} )} or π ( {f}_{t} ) = {f}_{t} .$$

In some embodiments, r=1, 2, . . . , vᵣᵢ. In some embodiments, iₜ=0, 1, . . . , 2Lₜ−1. In some embodiments, f=0, 1, . . . , Mᵥ−1. In some embodiments, fₜ=0, 1, . . . , Mᵥ−1. In some embodiments, t=0, 1, . . . , N−1. In some embodiments, t=1, 2, . . . , N.

According to the above equation (5A) or (5B) or (5C) or (5D), the order of contribution for the priority may be {a TRP index, an FD basis index or an FD basis index corresponding to a TRP index, an SD basis index corresponding to a TRP index, a layer index}.

In a further specific example, a priority associated with each reported element is determined by below equation (6A) or (6B) or (6C) or (6D).

$$Pri ( l , i , f , t ) = \{ \begin{matrix}2 \cdot {L}_{\text{?}} \cdot {v}_{\text{?}} \cdot π ( f ) + {v}_{\text{?}} \cdot {i}_{\text{?}} + r , & if t = s , \\ \begin{matrix}t \cdot 2 \cdot {L}_{\text{?}} \cdot {v}_{\text{?}} \cdot {\sum }_{f = 0}^{{M}_{\text{?} - 1}} ( π ( f ) ) + 2 \cdot {L}_{\text{?}} \cdot {v}_{\text{?}} \cdot \\ π ( f ) + {v}_{\text{?}} \cdot {i}_{\text{?}} + r + 2 \cdot {L}_{\text{?}} \cdot {v}_{\text{?}} \cdot \\ {\sum }_{f = 0}^{{M}_{\text{?} - 1}} ( π ( f ) ) + {v}_{\text{?}} \cdot 2 \cdot {L}_{s} + {v}_{\text{?}} ,\end{matrix} & if t \neq s\end{matrix} , \qquad ( 6 A )$$

$$Pri ( l , i , f , t ) = \{ \begin{matrix}2 \cdot {L}_{s} \cdot {v}_{ri} \cdot π ( f ) + {v}_{ri} \cdot {i}_{s} + r , & if t = s , \\ \begin{matrix}t \cdot 2 \cdot {L}_{t} \cdot {v}_{ri} \cdot max ( π ( f ) ) + 2 \cdot {L}_{t} \cdot {v}_{ri} \cdot \\ π ( f ) + {v}_{ri} \cdot {i}_{t} + r + 2 \cdot {L}_{s} \cdot {v}_{ri} \cdot \\ max ( π ( f ) ) + {v}_{ri} \cdot 2 \cdot {L}_{s} + {v}_{ri} ,\end{matrix} & if t \neq s\end{matrix} , \qquad ( 6 B )$$

$$Pri ( l , i , f , t ) = \{ \begin{matrix}2 \cdot {L}_{s} \cdot {v}_{ri} \cdot π ( {f}_{t} ) + {v}_{ri} \cdot {i}_{s} + r , & if t = s , \\ \begin{matrix}t \cdot 2 \cdot {L}_{t} \cdot {v}_{ri} \cdot {\sum }_{f = 0}^{{M}_{v - 1}} ( π ( {f}_{t} ) ) + 2 \cdot {L}_{t} \cdot {v}_{ri} \cdot \\ π ( {f}_{t} ) + {v}_{ri} \cdot {i}_{t} + r + 2 \cdot {L}_{s} \cdot {v}_{ri} \cdot \\ {\sum }_{f = 0}^{{M}_{v - 1}} ( π ( {f}_{t} ) ) + {v}_{ri} \cdot 2 \cdot {L}_{s} + {v}_{ri} ,\end{matrix} & if t \neq s\end{matrix} , \qquad ( 6 C )$$

$$Pri ( l , i , f , t ) = \{ \begin{matrix}2 \cdot {L}_{s} \cdot {v}_{ri} \cdot π ( {f}_{t} ) + {v}_{ri} \cdot {i}_{s} + r , & if t = s , \\ \begin{matrix}t \cdot 2 \cdot {L}_{t} \cdot {v}_{ri} \cdot max ( π ( {f}_{t} ) ) + 2 \cdot {L}_{t} \cdot {v}_{ri} \cdot \\ π ( {f}_{t} ) + {v}_{ri} \cdot {i}_{t} + r + 2 \cdot {L}_{s} \cdot {v}_{ri} \cdot \\ max ( π ( {f}_{t} ) ) + {v}_{ri} \cdot 2 \cdot {L}_{s} + {v}_{ri} ,\end{matrix} & if t \neq s\end{matrix} , \qquad ( 6 D )$$

$$\text{?} \text{indicates text missing or illegible when filed}$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r}^{( f )} or π ( f ) = f .$$

In some embodiments,

$$π ( {f}_{t} ) = min ( 2 \cdot {n}_{3 , r}^{( {f}_{t} )} , 2 \cdot ( {N}_{3} - {n}_{3 , r}^{( {f}_{t} )} ) - 1 ) or π ( {f}_{t} ) = {n}_{3 , r}^{( {f}_{t} )} or π ( {f}_{t} ) = {f}_{t} .$$

In some embodiments, r=1, 2, . . . , vᵣᵢ. In some embodiments, iₜ=0, 1, . . . , 2Lₜ−1. In some embodiments, f=0, 1, . . . , Mᵥ−1. In some embodiments, fₜ=0, 1, . . . , Mᵥ−1. In some embodiments, t=0, 1, . . . , N−1. In some embodiments, t=1, 2, . . . , N.

According to the above equation (6A) or (6B) or (6C) or (6D), the parameters corresponding to the first TRP may have the highest priority.

It is to be understood that all the above discussed example embodiments are only for the purpose of illustration without suggesting any limitations. The specific manner for determining the priority may be modified based on the teaching of the above discussed example embodiments, such modified embodiment should also be considered within the scope of this disclosure.

Moreover, in some other embodiments, it is unnecessary to determine a priority for each parameter. As discussed above, the terminal device 220 determines a respective first priority for a CSI-RS allocation of the plurality of CSI-RS allocations. In this event, the is terminal device 22 may include the parameters into the plurality of partitions of the CSI feedback based on the respective first priorities. In this way, the priority rule is more concise.

In the following text, examples regarding how to include the parameters into the different partitions of the feedback will be discussed with reference to FIG. 4A and FIG. 4B.

It is to be clarified that the following examples are discussed only for the purpose of illustration without suggesting any limitations. Moreover, although some specific parameters are discussed to be included in some specific partitions, in the other embodiments, all the discussed parameters and the discussed partitions may be changed based on the teaching of the below discussed example embodiments, such changes should also be considered within the scope of this disclosure.

As illustrated in FIG. 4A and FIG. 4B, the CSI feedback at least comprises a first partition (such as, CSI part 1) and a second partition (such as, CSI part 2). In some embodiments, the first partition is configured with a higher omission priority compared with the second partition. Alternatively, or in addition, in some embodiments, a payload size of the second partition is based on at least one indication in the first partition. Alternatively, or in addition, in some embodiments, a second partition comprises a plurality of information groups, a first information group of the plurality of information groups is configured with a higher omission priority compared with the other information groups of the plurality of information groups.

In some embodiments, the number of information groups comprised in the second partition may be larger than or equal to three. In case that the number of information groups is equal to 3, the CSI feedback may reuse the structure of current CSI report. Alternatively, in case that the number of information groups is larger than three, the structure of the CSI feedback may be more feasible.

Because the first partition or the first information group of the second partition has a relative higher omission priority, some relative important parameters may be included the first partition or the first information group.

Examples of the relative important parameters include but are not limited to:
a first index of a first allocation of the plurality of CSI-RS allocations,
a second index of a first CSI-RS resource group comprising the first allocation,
a plurality of respective third indexes of the plurality of CSI-RS allocation,
a first number of the non-zero coefficients corresponding to the first allocation,
a second number of the non-zero coefficients corresponding to the first CSI-RS group allocation,
a third number of the non-zero coefficients corresponding to the plurality of CSI-RS allocations, or
a fourth number indication indicating the number of the plurality of CSI-RS allocations.

In case that the relative important parameters are included in the first partition, the relative important parameters may enjoy the highest omission priority. In case that the relative important parameters are included in the first information group of the second partition, the first partition of the CSI feedback may reuse the current structure of CSI part 1.

In some embodiment, the first information group of the second partition may further include other parameters, include but are not limited to:
a strongest coefficient for a layer corresponding to the first CSI-RS allocation,
respective strongest coefficient for a layer corresponding to the plurality of CSI-RS allocations,
at least one SD basis corresponding to the first CSI-RS allocation,
at least one SD rotation factor corresponding to the first CSI-RS allocation, or
a fifth number of the non-zero coefficients corresponding to the plurality of CSI-RS allocations with the first CSI-RS allocation excluded.

In some embodiments, some relative secondary parameters may be included in the other information groups (rather than the first information group, such as, the second information group and the third information group as shown in FIG. 4A) of the second partition.

Examples of the relative secondary parameters include but are not limited to:
at least one co-amplitude coefficient associated with the plurality of CSI-RS allocations with the first CSI-RS allocation included or excluded,
at least one co-phasing coefficient associated with the plurality of CSI-RS allocations with the first CSI-RS allocation included or excluded,
respective strongest coefficient for a layer corresponding to the plurality of CSI-RS allocations with the first allocation excluded,
at least one SD basis corresponding to each of the plurality of CSI-RS allocations with the first allocation excluded, or
at least one SD rotation factor corresponding to each of the plurality of CSI-RS allocations with the first allocation excluded.

In some embodiments, non-zero coefficient information also may be included in the other information groups (i.e., rather than the first information group, such as, the second information group and the third information group as shown in FIG. 4A) of the second partition. In some embodiment, the non-zero coefficient information indicates a bitmap indicating related non-zero coefficients, amplitude coefficients corresponding to the related non-zero coefficients, or phase coefficients corresponding to the related non-zero coefficients.

Additionally, the related non-zero coefficients may associate with a CSI-RS allocation/allocation group/allocation set. In one specific example embodiment, the non-zero coefficients are associated with the plurality of CSI-RS allocations (i.e., all the TRPs). Alternatively, in another specific example embodiment, the non-zero coefficients are associated with the first CSI-RS allocation of the plurality of CSI-RS allocations (i.e., the first TRP). Alternatively, in a further specific example embodiment, the non-zero coefficients are associated with the plurality of CSI-RS allocations with the first CSI-RS allocation excluded (also referred to as a subset of CSI-RS allocations). Alternatively, in a further specific example embodiment, the non-zero coefficients are associated with a first CSI-RS resource group comprising the first CSI-RS allocation, or a second CSI-RS allocation group different from the fist CSI-RS allocation group.

Further, the non-zero coefficients associated with one specific CSI-RS allocation/allocation group/allocation set may have different priority levels. In this event, parameters with different priority levels while associated with the same CSI-RS allocation/allocation group/allocation set may be included into different information groups.

As one specific example, the other information groups comprise a second information group and a third information group with a lower omission priority compared is with the second information group, as shown in FIG. 4A. In this event, the second information group indicates first non-zero coefficient information corresponding to non-zero coefficients with higher priorities, and the third information group indicates second non-zero coefficient information corresponding to non-zero coefficients with lower priorities.

For better understanding, some examples regarding the CSI feedback are illustrated as below. In the following text, different partitions/information groups may be discussed separately, which causes that some parameters are included in more than one discussed partitions/information groups. However, it does not mean that such parameters need to be transmitted more than once, while it means that such parameters may be included in any of the partitions/information groups. In other words, in general rule for including the parameters into the partitions/information groups is that the parameters included in different partitions/information groups should not be overlapped or be repeated.

In some embodiments, the first partition (such as, CSI part 1) may indicate at least one of the following parameters:
Strongest TRP index,
The number of TRPs,
Indexes of the TRPs,
An indication of the overall number of non-zero amplitude/phase coefficients across layers corresponding to the first TRP (such as,

$${K}_{s}^{NZ} ) ,$$

An indication of the overall number of non-zero amplitude/phase coefficients across layers corresponding to the plurality of TRPs (such as, K^{NZ}).
Rank Indicator (such as, vᵣᵢ)
CQI, including wide-band CQI and subband differential CQI.

In some embodiments, the first information group of the second partition (such as, group 0 of CSI part 2) may indicate at least one of the following parameters:
Strongest TRP index,
The number of TRPs,
Indexes of the TRPs,
An indication of the overall number of non-zero amplitude/phase coefficients across layers corresponding to the first TRP (such as,

$${K}_{s}^{N Z} ) ,$$

An indication of the overall number of non-zero amplitude/phase coefficients across layers corresponding to the plurality of TRPs (such as, K^{NZ}),
Strongest coefficient for each layer corresponding to the first TRP, where a field size is determined by ceil(log 2(C(Pt/2, 2*Ls))), Ls is the number of SD bases corresponding to the first TRP, Pt=N1*N2*2 or Pt=N1*N2*2/N;
Strongest coefficient for each layer among the plurality of TRPs, where a field size is determined by ceil(log 2(C(P/2, 2*L))), L is the total number of SD bases, P is the number of ports and may be one of {2, 4, 8, 12, 16, 24, 32},
SD basis indicator (i.e., i_{1,2,t}) and/or SD rotation factors (i.e., i_{1,1,t}) corresponding to the first TRP,
SD basis indicator (i.e., i_{1,2}) corresponding to the plurality of TRPs,
SD rotation factors (i.e., i_{1,1}) corresponding to the plurality of TRPs,
An indication of the overall number of non-zero amplitude/phase coefficients corresponding to the subset of TRPs (such as,

$${K}_{N - 1}^{N Z} ) .$$

i.e., the plurality of TRPs with the first TRP excluded.

In some embodiments, the second information group of the second partition (such as, group 0 of CSI part 2) may indicate at least one of the following parameters:
Relative co-phasing coefficient and/or relative amplitude coefficient between TRPs (or for the plurality of TRPs with the first TRP excluded) may be included in group 1,
Strongest coefficient for each layer corresponding to one or all the subset of TRPs may be included in group 1 (in case of per TRP SCI reporting),
SD basis indicator (i_{1,2,t}) and/or SD rotation factors (i_{1,1,t}) corresponding to the plurality of TRPs with the first TRP excluded.

As discussed above, the non-zero coefficient information may be indicated in other information groups (i.e., rather than the first information group, such as, the second information group and the third information group as shown in FIG. 4A). In the following, some examples for the other information groups will be discussed.

In some embodiments, one of the other information groups (such as, the second information group, for example, group 1 of CSI part 2) may indicate at least one of the following parameters/elements:
A plurality of highest priority elements of a first bitmap (i.e., i_{1,7,r}) (corresponding to the plurality of TRPs, i.e., all the TRPs),
   where the bitmap indicates whether the corresponding amplitude/phase coefficient corresponding to the plurality of TRPs is reported, and the field size may be 2*L*vᵣᵢ*Mᵥ*N,
   where the number of the plurality of highest priority elements of the bitmap may be Y_{1_1_1}, e.g. Y_{1_1_1}=2*L*vᵣᵢ*Mᵥ*N−└K^{NZ}/2┘,
A plurality of highest priority elements of an amplitude coefficient indicator (i.e., i_{2,4,r}) (e.g. a subset of a plurality of amplitude coefficients corresponding to the plurality of TRPs),
   where the number of the plurality of highest priority elements of the subset of the plurality of amplitude coefficients may be Y_{2_1_1}, e.g.

$${Y}_{2 \_ 1 \_ 1} = max ( 0 , ⌈ \frac{{K}^{N Z}}{2} ⌉ - {v}_{r i} )$$

(SCI among TRPs) or

$${Y}_{2 \_ 1 \_ 1} = max ( 0 , ⌈ \frac{{K}^{N Z}}{2} ⌉ - N * {v}_{r i} )$$

(per TRP SCI reporting)
A plurality of highest priority elements of a phase coefficient indicator (i.e., i_{2,5,r}) (e.g. a subset of a plurality of phase coefficients corresponding to the plurality of TRPs).
   where the number of the plurality of highest priority elements of the subset of the plurality of phase coefficients may be Y_{3_1_1}, e.g.

$${Y}_{3 \_ 1 \_ 1} = max ( 0 , ⌈ \frac{{K}^{N Z}}{2} ⌉ - {v}_{r i} )$$

(SCI among TRPs) or

$${Y}_{3 \_ 1 \_ 1} = max ( 0 , ⌈ \frac{{K}^{N Z}}{2} ⌉ - N * {v}_{r i} )$$

(per TRP SCI reporting)

Alternatively, in some embodiments, one other information group (such as, the second information group, for example, group 1 of CSI part 2) may indicate at least one of the following parameters/elements:
A plurality of highest priority elements of a bitmap (i_{1,7,r,s}) (corresponding to the first TRP);
   where the bitmap is to indicate whether the corresponding amplitude/phase coefficient corresponding to the first TRP is reported, and the field size may be 2*Lₛ*vᵣᵢ*Mᵥ,
   where the number of the plurality of highest priority elements of the bitmap may be

$${Y}_{1 \_ 2 \_ 1} , e . g . {Y}_{1 \_ 2 \_ 1} = 2 * {L}_{s} * {v}_{r i} * {M}_{v} - ⌊ {K}_{s}^{N Z} / 2 ⌋ ;$$

A plurality of highest priority elements of an amplitude coefficient indicator (i_{2,4,r,s}) (e.g. a subset of a plurality of amplitude coefficients corresponding to the first TRP);
   where the number of the plurality of highest priority elements of the subset of the plurality of amplitude coefficients may be Y_{2_2_1}, e.g.

$${Y}_{2 \_ 2 \_ 1} = max ( 0 , ⌈ \frac{{K}_{s}^{N Z}}{2} ⌉ - {v}_{r i} ) ;$$

where

$${K}^{N Z} = {K}_{s}^{N Z} + {K}_{N - 1}^{N Z} ,$$

A plurality of highest priority elements of a phase coefficient indicator (i_{2,5,r,s}) (e.g. a subset of a plurality of phase coefficients corresponding to the first TRP);
   where the number of the plurality of highest priority elements of the subset of the plurality of phase coefficients may be Y_{3_2_1}, e.g.

$${Y}_{3 \_ 2 \_ 1} = max ( 0 , ⌈ \frac{{K}_{s}^{N Z}}{2} ⌉ - {v}_{r i} ) .$$

Alternatively, in some embodiments, one other information group (such as, the second information group, for example, group 1 of CSI part 2) may indicate at least one of the following parameters/elements:
All elements of the bitmap (i_{1,7,r,s}) (corresponding to the first TRP);
   where the bitmap is to indicate whether the corresponding amplitude/phase coefficient corresponding to the first TRP is reported, and the field size may be 2*Lₛ*vᵣᵢ*Mᵥ,
The amplitude coefficient indicator (i_{2,4,r,s}) (e.g. the plurality of amplitude coefficients corresponding to the first TRP);
   where the number of the plurality of amplitude coefficients may be Y_{2_4_1}, e.g.

$${Y}_{2 \_ 4 \_ 1} = {K}_{s}^{N Z} - {v}_{r i} or max ( 0 , {K}_{s}^{N Z} - {v}_{r i} ) ;$$

The phase coefficient indicator (i_{2,5,r,s}) (e.g. the plurality of phase coefficients corresponding to the first TRP);
   where the number of the plurality of phase coefficients may be Y_{3_4_1}, e.g.

$${Y}_{3 \_ 4 \_ 1} = {K}_{s}^{N Z} - {v}_{r i} or max ( 0 , {K}_{s}^{N Z} - {v}_{r i} ) .$$

FD basis indicator for each layer (i_{1,6,r}),
Initial index for FD basis window (i_{1,5}),
Reference amplitude for weaker polarization for each layer (i_{2,3,r}).

In this way, all the non-zero coefficient information of the first TRP may be prioritized.

Alternatively, in some embodiments, one other information group (such as, the second information group, for example, group 1 of CSI part 2) may indicate at least one of the following parameters/elements:
A bitmap (i_{1,7,r,t1}) (corresponding to the first set of TRPs comprising the first TRP);
   where the bitmap is to indicate whether the corresponding amplitude/phase coefficient corresponding to the first set of TRPs is reported, and the field size may be

$$2 * {L}_{t} * ⌈ \frac{N}{2} ⌉ * {v}_{r i} * {M}_{v} or 2 * {L}_{t} * ⌊ \frac{N}{2} ⌋ * {v}_{r i} * {M}_{v} ;$$

An amplitude coefficient indicator (i_{2,4,r,t1}) (e.g. a plurality of amplitude coefficients corresponding to the first set of TRPs comprising the first TRP);
   where the number of the plurality of amplitude coefficients may be.

$${Y}_{2 \_ 5 \_ 1} = {K}_{t 1}^{N Z} - {v}_{r i} or max ( 0 , {K}_{t 1}^{N Z} - {v}_{r i} )$$

(SCI among TRPs) or

$${Y}_{2 \_ 5 \_ 1} = max ( 0 , {K}_{t 1}^{N Z} - ⌈ \frac{N}{2} ⌉ * {v}_{r i} ) or max ( 0 , {K}_{t 1}^{N Z} - ⌊ \frac{N}{2} ⌋ * {v}_{r i} )$$

(per TRP SCI reporting);

$${K}^{NZ} = {K}_{t 1}^{NZ} + {K}_{t 2}^{NZ} ;$$

A phase coefficient indicator (i_{2,5,r,t1}) (e.g. a plurality of phase coefficients corresponding to the first set of TRPs comprising the first TRP);
   where the number of the fourth plurality of phase coefficients may be Y_{3_5_1}, e.g.,

$${Y}_{3 \_ 5 \_ 1} = {K}_{t 1}^{NZ} - {v}_{r i} or max ( 0 , {K}_{t 1}^{NZ} - {v}_{r i} )$$

(SCI among TRPs) or

$${Y}_{3 \_ 5 \_ 1} = max ( 0 , {K}_{t 1}^{NZ} - ⌈ \frac{N}{2} ⌉ * {v}_{r i} ) or max ( 0 , {K}_{t 1}^{NZ} - ⌊ \frac{N}{2} ⌋ * {v}_{r i} )$$

(per TRP SCI reporting).
FD basis indicator for each layer (i_{1,6,r}),
Initial index for FD basis window (i_{1,5}),
Reference amplitude for weaker polarization for each layer (i_{2,3,r}).

In some embodiments, one other information group (such as, the third information group, for example, group 2 of CSI part 2) may indicate at least one of the following parameters/elements:
A plurality of lowest priority elements of the bitmap (i_{1,7,r}) (corresponding to the plurality of TRPs, i.e., all the TRPs);
   where the bitmap is to indicate whether the corresponding amplitude/phase coefficient corresponding to the plurality of TRPs is reported, and the field size may be 2*L*v_ri*M_v*N;
   where the number of the plurality of lowest priority elements of the bitmap may be Y_{1_1_2}, e.g. Y_{1_1_2}=└K^{NZ}/2┘.
A plurality of lowest priority elements of the amplitude coefficient indicator (i_{2,4,r}) (e.g. a subset of the plurality of amplitude coefficients corresponding to the plurality of TRPs);
where the number of the plurality of lowest priority elements of the subset of the plurality of amplitude coefficients may be Y_{2_1_2}, e.g.

$${Y}_{2 \_ 1 \_ 2} = min ( {K}^{NZ} - {v}_{ri} , ⌊ \frac{{K}^{NZ}}{2} ⌋ )$$

(SCI among TRPs) or

$${Y}_{2 \_ 1 \_ 2} = min ( {K}^{NZ} - N * {v}_{ri} , ⌊ \frac{{K}^{NZ}}{2} ⌋ )$$

(per TRP SCI reporting);
A plurality of lowest priority elements of the phase coefficient indicator (i_{2,5,r}) (e.g. a subset of the plurality of phase coefficients corresponding to the plurality of TRPs);
   where the number of the plurality of lowest priority elements of the of the plurality of phase coefficients may be Y_{3_1_2}, e.g.

$${Y}_{3 \_ 1 \_ 2} = min ( {K}^{NZ} - {v}_{ri} , ⌊ \frac{{K}^{NZ}}{2} ⌋ )$$

(SCI among TRPs) or

$${Y}_{3 \_ 1 \_ 2} = min ( {K}^{NZ} - N * {v}_{ri} , ⌊ \frac{{K}^{NZ}}{2} ⌋ )$$

(per TRP SCI reporting).

Alternatively, in some embodiments, one other information group (such as, the third information group, for example, group 2 of CSI part 2) may indicate at least one of the following parameters/elements:
A plurality of lowest priority elements of the bitmap (i_{1,7,r,s}) (corresponding to the first TRP);
   where the bitmap is to indicate whether the corresponding amplitude/phase coefficient corresponding to the first TRP is reported, and the field size may be 2*Lₛ*vᵣᵢ*Mᵥ
   where the number of the plurality of lowest priority elements of the bitmap may be Y_{1_2_2}, e.g.

$${Y}_{1 \_ 2 \_ 2} = ⌊ {K}_{s}^{NZ} / 2 ⌋$$

A plurality of lowest priority elements of the amplitude coefficient indicator (i_{2,4,r,s}) (e.g. a subset of the plurality of amplitude coefficients corresponding to the first TRP);
   where the number of the plurality of lowest priority elements of the subset of the plurality of amplitude coefficients may be Y_{2_2_2}, e.g.

$${Y}_{2 \_ 2 \_ 2} = min ( {K}_{s}^{NZ} - {v}_{ri} , ⌊ \frac{{K}_{s}^{NZ}}{2} ⌋ ) ;$$

A plurality of lowest priority elements of the phase coefficient indicator (i_{2,5,r,s}) (e.g. a subset of the plurality of phase coefficients corresponding to the first TRP);
   where the number of the plurality of lowest priority elements of the subset of the plurality of phase coefficients may be Y_{3_2_2}, e.g.

$${Y}_{3 \_ 2 \_ 2} = min ( {K}_{s}^{NZ} - {v}_{ri} , ⌊ \frac{{K}_{s}^{NZ}}{2} ⌋ ) ;$$

Alternatively, in some embodiments, one other information group (such as, the third information group, for example, group 2 of CSI part 2) may indicate at least one of the following parameters/elements:
A plurality of highest priority elements of a bitmap (i_{1,7,r,t}) (e.g. t≠s) (corresponding to the subset of TRPs, i.e., the plurality of TRP with the first TRP excluded) may be included in group 2;
   where the bitmap is to indicate whether the corresponding amplitude/phase coefficient corresponding to the subset of TRPs is reported, and the field size may be 2*L_t*(N−1)*v_ri*M_v;
   where the number of the plurality of highest priority elements of the bitmap may be Y_{1_3_1}, e.g.

$${Y}_{1 \_ 3 \_ 1} = 2 * {L}_{t} * ( N - 1 ) * {v}_{r i} * {M}_{v} - ⌊ {K}_{N - 1}^{NZ} / 2 ⌋ ;$$

A plurality of highest priority elements of an amplitude coefficient indicator (i_{2,4,r,t}) (e.g. t≠s) (e.g. a first subset of a plurality of amplitude coefficients corresponding to the subset of TRPs);
   where the number of the plurality of highest priority elements of the subset of the plurality of amplitude coefficients may be Y_{2_3_1}, e.g.

$${Y}_{2 \_ 3 \_ 1} = max ( 0 , ⌈ \frac{{K}_{N - 1}^{NZ}}{2} ⌉ - ( N - 1 ) * {v}_{r i} )$$

(per TRP SCI reporting) or

$$Y2\_ 3 \_ 1 = ⌈ \frac{{K}_{N - 1}^{NZ}}{2} ⌉$$

(SCI among TRPs)
A plurality of highest priority elements of a phase coefficient indicator (i_{2,5,r,t}) (e.g. t≠s) (e.g. a subset of a plurality of phase coefficients corresponding to the subset of TRPs);
   where the number of the; plurality of highest priority elements of the; subset of the plurality of phase coefficients may be Y_{3_3_1}, e.g.

$${Y}_{3 \_ 3 \_ 1} = max ( 0 , ⌊ \frac{{K}_{N - 1}^{NZ}}{2} ⌋ - ( N - 1 ) * {v}_{r i} )$$

(per TRP SCI reporting) or

$$Y3\_ 3 \_ 1 = ⌈ \frac{{K}_{N - 1}^{NZ}}{2} ⌉$$

(SCI among TRPs)

Alternatively, in some embodiments, one other information group (such as, the third information group, for example, group 2 of CSI part 2) may indicate at least one of the following parameters/elements:
The bitmap (i_{1,7,r,t}) (e.g. t≠s) (corresponding to the subset of TRPs, i.e., the plurality of TRP with the first TRP excluded);
   where the bitmap is to indicate whether the corresponding amplitude/phase coefficient corresponding to the subset of TRPs is reported, and the field size may be 2*Lₜ*(N−1)*vᵣᵢ*Mᵥ;
The amplitude coefficient indicator (i_{2,4,r,t}) (e.g. t≠s) (e.g. The plurality of amplitude coefficients corresponding to the subset of TRPs);
   where the number of the plurality of amplitude coefficients may be Y_{2_4_2}, e.g.

$${Y}_{2 \_ 4 \_ 2} = max ( 0 , {K}_{N - 1}^{NZ} - ( N - 1 ) * {v}_{ri} )$$

(per TRP SCI reporting) or

$${Y}_{2 \_ 4 \_ 2} = {K}_{N - 1}^{NZ}$$

(SCI among TRPs)
The phase coefficient indicator (i2,5,r,t) (e.g. t≠s) (e.g. The plurality of phase coefficients corresponding to the subset of TRPs);
   where the number of the plurality of phase coefficients may be Y_{3_4_2}, e.g.

$${Y}_{3 \_ 4 \_ 2} = max ( 0 , {K}_{N - 1}^{NZ} - ( N - 1 ) * {v}_{ri} )$$

(per TRP SCI reporting) or

$${Y}_{2 \_ 4 \_ 2} = {K}_{N - 1}^{NZ}$$

(SCI among TRPs).

Alternatively, in some embodiments, one other information group (such as, the third information group, for example, group 2 of CSI part 2) may indicate at least one of the following parameters/elements:
A bitmap (i_{1,7,r,t2}) (corresponding to the second set of TRPs different from the first set of TRPs comprising the first TRP);
   where the bitmap is to indicate whether the corresponding amplitude/phase coefficient corresponding to the set of TRPs is reported, and the field size may be

$$2 * {L}_{f} * ⌊ \frac{N}{2} ⌋ * {v}_{ri} * {M}_{v} or 2 * {L}_{f} * ⌈ \frac{N}{2} ⌉ * {v}_{ri} * {M}_{v}$$

An amplitude coefficient indicator (i_{2,4,r,t2}) (e.g. a plurality of amplitude coefficients corresponding to the second set of TRPs);
   where the number of the plurality of amplitude coefficients may be Y_{2_5_2}, e.g.

$${Y}_{2 \_ 5 \_ 2} = max ( 0 , {K}_{t 2}^{NZ} - ⌊ \frac{N}{2} ⌋ * {v}_{ri} ) or max ( 0 , {K}_{t 2}^{NZ} - ⌈ \frac{N}{2} ⌉ * {v}_{ri} )$$

(per TRP SCI reporting) or

$$Y2\_ 5 \_ 2 = {K}_{t 2}^{NZ}$$

(SCI among TRPs);
A phase coefficient indicator (i_{2,5,r,t2}) (e.g. a plurality of phase coefficients corresponding to the second set of TRPs);
   where the number of the plurality of phase coefficients may be Y_{3_5_2}, e.g.

$${Y}_{3 \_ 5 \_ 2} = max ( 0 , {K}_{t 2}^{NZ} - ⌊ \frac{N}{2} ⌋ * {v}_{ri} ) or max ( 0 , {K}_{t 2}^{NZ} - ⌈ \frac{N}{2} ⌉ * {v}_{ri} )$$

(per TRP SCI reporting) or

$${Y}_{3 \_ 5 \_ 2} = {K}_{t 2}^{NZ}$$

(SCI among TRPs);

As discussed above, the number of the information groups may be larger than three. In the following, some examples are discussed in case that the number of the information groups is larger than three.

In some embodiments, one other information group (such as, the fourth information group, for example, group 3 of CSI part 2) may indicate at least one of the following parameters/elements:
A plurality of lowest priority elements of the bitmap (i_{1,7,r,t}) (e.g. t≠s) (corresponding to the subset of TRPs, i.e. the plurality of TRPs with the first TRP excluded);
   where the bitmap is to indicate whether the corresponding amplitude/phase coefficient corresponding to the subset of TRPs is reported, and the field size may be 2*Lₜ*(N−1)*vᵣᵢ*Mᵥ,
   where the number of the plurality of lowest priority elements of the bitmap may be Y_{1_3_2}, e.g.

$${Y}_{1 \_ 3 \_ 2} = ⌊ \frac{{K}_{N - 1}^{NZ}}{2} ⌋ ,$$

A plurality of lowest priority elements of the amplitude coefficient indicator (i_{2,4,r,t}) (e.g. t≠s) (e.g. a subset of the plurality of amplitude coefficients corresponding to the subset of TRPs);
   where the number of the plurality of lowest priority elements of the subset of the plurality of amplitude coefficients may be Y_{2_3_2}, e.g.

$${Y}_{2 \_ 3 \_ 2} = min ( {K}_{N - 1}^{NZ} - ( N - 1 ) * {v}_{ri} , ⌊ \frac{{K}_{N - 1}^{NZ}}{2} ⌋ )$$

(per TRP SCI reporting) or

$${Y}_{2 \_ 3 \_ 2} = ⌊ \frac{{K}_{N - 1}^{NZ}}{2} ⌋$$

(SCI among TRPs);
A plurality of lowest priority elements of the phase coefficient indicator (i_{2,5,r,t}) (e.g. t≠s) (e.g. a subset of the plurality of phase coefficients corresponding to the subset of TRPs);
   where the number of the plurality of lowest priority elements of the subset of the plurality of phase coefficients may be Y_{3_3_2}, e.g.

$${Y}_{3 \_ 3 \_ 2} = min ( {K}_{N - 1}^{NZ} - ( N - 1 ) * {v}_{ri} , ⌊ \frac{{K}_{N - 1}^{NZ}}{2} ⌋ )$$

(per TRP SCI reporting) or

$$Y3\_ 3 \_ 2 = ⌊ \frac{{K}_{N - 1}^{NZ}}{2} ⌋$$

(SCI among TRPs).

Alternatively, in some embodiments, one other information group (such as, the fourth information group, for example, group 3 of CSI part 2) may indicate at least one of the following parameters/elements:
A plurality of highest priority elements of a bitmap (i_{1,7,r,t}) (e.g. t≠s) (corresponding to the subset of TRPs, i.e., the plurality of TRPs with the first TRP excluded);
   where the bitmap is to indicate whether the corresponding amplitude/phase coefficient corresponding to the subset of TRPs is reported, and the field size may be 2*Lₜ*(N−1)*vᵣᵢ*Mᵥ,
   where the number of the plurality of highest priority elements of the bitmap may be Y_{1_3_1}, e.g.

$${Y}_{1 \_ 3 \_ 1} = 2 * {L}_{t} * ( N - 1 ) * {v}_{ri} * {M}_{v} - ⌊ {K}_{N - 1}^{NZ} / 2 ⌋ ,$$

A plurality of highest priority elements of an amplitude coefficient indicator (i_{2,4,r,t}) (e.g. t≠s) (e.g. a subset of a plurality of amplitude coefficients corresponding to the subset of TRPs);
where the number of the plurality of highest priority elements of the subset of the plurality of amplitude coefficients may be Y_{2_3_1}, e.g.

$${Y}_{2 \_ 3 \_ 1} = max ( 0 , ⌈ \frac{{K}_{N - 1}^{NZ}}{2} ⌉ - ( N - 1 ) * {v}_{ri} )$$

(per TRP SCI reporting) or

$${Y}_{2 \_ 3 \_ 1} = ⌈ \frac{{K}_{N - 1}^{NZ}}{2} ⌉$$

(SCI among TRPs),
A plurality of highest priority elements of a phase coefficient indicator (i_{2,5,r,t}) (e.g. t≠s) (e.g. a subset of a plurality of phase coefficients corresponding to the subset of TRPs);
   where the number of the plurality of highest priority elements of the subset of third plurality of phase coefficients may be Y_{3_3_1}, e.g.

$${Y}_{3 \_ 3 \_ 1} = max ( 0 , ⌊ \frac{{K}_{N - 1}^{NZ}}{2} ⌋ - ( N - 1 ) * {v}_{ri} )$$

(per TRP SCI reporting) or

$${Y}_{3 \_ 3 \_ 1} = ⌈ \frac{{K}_{N - 1}^{NZ}}{2} ⌉$$

(SCI among TRPs).

Alternatively, in some embodiments, one other information group (such as, the fourth information group, for example, group 3 of CSI part 2) may indicate at least one of the following parameters/elements:
A plurality of lowest priority elements of the bitmap (i_{1,7,r,s}) (corresponding to the first TRP);
   where the bitmap is to indicate whether the corresponding amplitude/phase coefficient corresponding to the first TRP is reported, and the field size may be 2*Lₛ*vᵣᵢ*Mᵥ,
   where the number of the plurality of lowest priority elements of the bitmap may be Y_{1_2_2}, e.g.

$${Y}_{1 \_ 2 \_ 2} = ⌊ {K}_{s}^{NZ} / 2 ⌋ ,$$

A plurality of lowest priority elements of the amplitude coefficient indicator (i_{2,4,r,s}) (e.g. a subset of the plurality of amplitude coefficients corresponding to the first TRP);
   where the number of the plurality of lowest priority elements of the subset of the plurality of amplitude coefficients may be Y_{2_2_2}, e.g.

$${Y}_{2 \_ 2 \_ 2} = min ( {K}_{s}^{NZ} - {v}_{ri} , ⌊ \frac{{K}_{s}^{NZ}}{2} ⌋ )$$

A plurality of lowest priority elements of the phase coefficient indicator (i_{2,5,r,s}) (e.g. a subset of the plurality of phase coefficients corresponding to the first TRP);
   the number of the plurality of lowest priority elements of the subset of the plurality of phase coefficients may be Y_{3_2_2}, e.g.

$${Y}_{3 \_ 2 \_ 2} = min ( {K}_{s}^{NZ} - {v}_{ri} , ⌊ \frac{{K}_{s}^{NZ}}{2} ⌋ ) .$$

Alternatively, in some embodiments, one other information group (such as, the fifth information group, for example, group 4 of CSI part 2) may indicate at least one of the following parameters/elements:
A plurality of lowest priority elements of the bitmap (i_{1,7,r,t}) (e.g. t≠s) (corresponding to the subset of TRPs, i.e. the plurality of TRPs with the first TRP excluded);
   where the bitmap is to indicate whether the corresponding amplitude/phase coefficient corresponding to the subset of TRPs is reported, and the field size may be 2*Lₜ*(N−1)*vᵣᵢ*Mᵥ,
   where the number of the second plurality of lowest priority elements of the third bitmap may be Y_{1_3_2}, e.g.

$${Y}_{1 \_ 3 \_ 2} = ⌊ \frac{{K}_{N - 1}^{NZ}}{2} ⌋ ,$$

A plurality of lowest priority elements of the amplitude coefficient indicator (i_{2,4,r,t}) (e.g. t≠s) (e.g. a subset of the plurality of amplitude coefficients corresponding to the subset of TRPs);
   where the number of the plurality of lowest priority elements of the subset of the plurality of amplitude coefficients may be Y_{2_3_2}, e.g.

$${Y}_{2 \_ 3 \_ 2} = min ( {K}_{N - 1}^{NZ} - ( N - 1 ) * {v}_{ri} , ⌊ \frac{{K}_{N - 1}^{NZ}}{2} ⌋ )$$

(per TRP SCI reporting) or

$${Y}_{2 \_ 3 \_ 2} = ⌊ \frac{{K}_{N - 1}^{NZ}}{2} ⌋$$

A plurality of lowest priority elements of the phase coefficient indicator (i_{2,5,r,t}) (e.g. t≠s) (e.g. a subset of the plurality of phase coefficients corresponding to the subset of TRPs);
   where the number of the plurality of lowest priority elements of the subset of the plurality of phase coefficients may be Y_{3_3_2}, e.g.

$${Y}_{3 \_ 3 \_ 2} = min ( {K}_{N - 1}^{NZ} - ( N - 1 ) * {v}_{ri} , ⌊ \frac{{K}_{N - 1}^{NZ}}{2} ⌋ )$$

(per TRP SCI reporting) or

$${Y}_{3 \_ 3 \_ 2} = ⌊ \frac{{K}_{N - 1}^{NZ}}{2} ⌋$$

(SCI among TRPs).

The above examples are discussed with regards to a specific information group. In the followings, some examples are discussed with regards to a specific combination of information groups. Further, in the following example, priority levels comprise the highest priority and lowest priority. Specifically, the highest priority parameters refer to a plurality of highest priority elements (parameters) of codebook indication fields, the lowest priority parameters refer to a plurality of lowest priority elements of codebook indication fields, and all the parameters refers to all the elements (parameters) of codebook indication fields.

In some embodiments, the codebook indication fields may include at least one of: a bitmap, amplitude coefficient indication fields and phase coefficient indication fields.

In some embodiments, the terminal device 220 may calculate a priority of at least one codebook indicator (or a parameter corresponding to a layer index, a first basis index, a second basis index and a third basis index) based on an FD basis index or based on an SD basis index and/or based on layer index and calculate a further priority based on a TRP index, respectively. In some embodiments, the terminal device 220 may calculate a priority of at least one codebook indicator (or a parameter corresponding to a layer index, a first basis index, a second basis index and a third basis index) based on an FD basis index firstly and then calculate a further priority based on a TRP index, respectively.

In some embodiments, an SD basis index may correspond to a first basis index or a second basis index.

In some embodiments, an FD basis index may correspond to a third basis index or an FD basis index or an FD basis index corresponding to a TRP index.

In some embodiments, the terminal device 220 may calculate a priority of at least one codebook indicator (or a parameter corresponding to a layer index, a first basis index, a second basis index and a third basis index) based on a TRP index firstly and then calculate a further priority based on an SD basis index or based on an FD basis index, respectively. In some embodiments, the terminal device 220 may divide at least one of a bitmap (indicating non zero amplitude coefficients and/or non zero phase coefficients), a plurality of amplitude coefficients and a plurality of phase coefficients into two groups (e.g. a first group and a second group) based on priorities calculated based on a layer index, and a TRP index. For example, the first group may include a first subset of bits of the bitmap, a first subset of amplitude coefficients and a first subset of phase coefficients with higher priorities, and the second group may include a second subset (or the remaining) of bits of the bitmap, a second subset (or the remaining) of amplitude coefficients and a second subset (or the remaining) of phase coefficients with lower priorities. In some embodiments, the terminal device 220 may divide the first group into two sub-groups (e.g. a first sub-group and a second sub-group) based on priorities calculated based on an FD basis index and/or at least one of a layer index and an SD basis index.

In some embodiments, the terminal device 220 may divide the second group into two sub-groups (e.g. a third sub-group and a fourth sub-group) based on priorities calculated based on an FD basis index and/or at least one of a layer index and an SD basis index. For example, the first sub-group may include a first sub-group of the first subset of bits of the bitmap, a first sub-group of the first subset of amplitude coefficients and a first sub-group of the first subset of phase coefficients with higher priorities, and the second sub-group may include a second sub-group (or the remaining) of the first subset of bits of the bitmap, a second sub-group (or the remaining) of the first subset of amplitude coefficients and a second sub-group (or the remaining) of the first subset of phase coefficients with lower priorities.

For another example, the third sub-group may include a first sub-group of the second subset of bits of the bitmap, a first sub-group of the second subset of amplitude coefficients and a first sub-group of the second subset of phase coefficients with higher priorities, and the fourth sub-group may include a second sub-group (or the remaining) of the second subset of bits of the bitmap, a second sub-group (or the remaining) of the second subset of amplitude coefficients and a second sub-group (or the remaining) of the second subset of phase coefficients with lower priorities.

In some embodiments, the terminal device 220 may calculate a priority based on a layer index, an SD basis index and an FD basis index for the first group and second group by below equation (7-1).

$$Pri ( l , i , f ) = 2 \cdot L \cdot {v}_{ri} \cdot π ( f ) + {v}_{ri} \cdot i + r \qquad ( 7 - 1 )$$

In some embodiments, the terminal device 220 may calculate a priority for the first sub-group and the second sub-group and/or a priority for the third sub-group and the fourth sub-group based on a TRP index by below equation (7-2) or (7-3).

$$Pri ( l , i , md ) = 2 \cdot L \cdot {v}_{ri} \cdot t + {v}_{ri} \cdot i + r \qquad ( 7 - 2 )$$

$$Pri ( md ) = t \qquad ( 7 - 3 )$$

In some embodiments, the terminal device 220 may calculate a priority based on a layer index, an SD basis index and a TRP index for the first group and second group by below equation (7-4).

$$Pri ( l , i , f ) = 2 \cdot L \cdot {v}_{ri} \cdot t + {v}_{ri} \cdot i + r \qquad ( 7 - 4 )$$

In some embodiments, the terminal device 220 may calculate a priority for the first sub-group and the second sub-group and/or a priority for the third sub-group and the fourth sub-group based on an FD basis index by below equation (7-5) or (7-6).

$$Pri ( l , i , f ) = 2 \cdot L \cdot {v}_{ri} \cdot π ( f ) + {v}_{ri} \cdot i + r \qquad ( 7 - 5 )$$

$$Pri ( f ) = π ( f ) \qquad ( 7 - 6 )$$

In some embodiments, the terminal device 220 may calculate a priority based on a layer index, an FD basis index and a TRP index for the first group and second group by below equation (7-7).

$$Pri ( l , f , md ) = {v}_{ri} \cdot π ( f ) \cdot N + {v}_{ri} \cdot t + r \qquad ( 7 - 7 )$$

In some embodiments, the terminal device 220 may calculate a priority for the first sub-group and the second sub-group and/or a priority for the third sub-group and the fourth sub-group based on an SD basis index by below equation (7-8) or (7-9).

$$Pri ( l , i , f ) = 2 \cdot L \cdot {v}_{ri} \cdot π ( f ) + {v}_{ri} \cdot i + r \qquad ( 7 - 8 )$$

$$Pri ( i ) = i \qquad ( 7 - 9 )$$

In one specific example embodiment, the terminal device 220 may firstly calculate priorities based on the FD basis index and/or SD basis index and/or layer index. Based on the calculated priorities, the parameters may be divided into a highest/higher FD priority group (be presented as group #1) and a lowest/lower FD priority group (be presented as group #2). For each of the group #1 and group #2, the terminal device 220 may further calculate priorities based on the TRP index. For example, based on the calculated priorities, the parameters may be divided into a first sub-group (be represented as group #1-1) (for example, a sub-group with a highest/higher FD priority and a highest/higher TRP priority), a second sub-group (be represented as group #1-2) (for example, a sub-group with a highest/higher FD priority and a lowest/lower TRP priority), a third sub-group (be represented as group #2-1) (for example, a sub-group with a lowest/lower FD priority and a highest/higher TRP priority) and a fourth sub-group (be represented as group #2-2) (for example, a sub-group with a lowest/lower FD priority and a lowest/lower TRP priority).

In some embodiments, the terminal device 220 may calculate a priority based on an FD basis index by below equation (7-10).

$$Pri ( l , i , f ) = 2 \cdot L \cdot {v}_{ri} \cdot π ( f ) + {v}_{ri} \cdot i + r \qquad ( 7 - 10 )$$

The terminal device 220 also calculates a priority based on a TRP index by below equation (7-11).

$$Pri ( l , i , md ) = 2 \cdot L \cdot {v}_{ri} \cdot t + {v}_{ri} \cdot i + r \qquad ( 7 - 11 )$$

In one specific example embodiment, the terminal device 220 may firstly calculate priorities based on the TRP index and/or SD basis index and/or layer index. Based on the calculated priorities, the parameters may be divided into a highest/higher TRP priority group (be presented as group #1) and a lowest/lower TRP priority group (be presented as group #2). For each of the group #1 and group #2, the terminal device 220 may further calculate priorities based on the FD basis index. For example, based on the calculated priorities, the parameters may be divided into a first sub-group (be represented as group #1-1) (for example, a sub-group with a highest/higher TRP or SD priority and a highest/higher FD priority), a second sub-group (be represented as group #1-2) (for example, a sub-group with a highest/higher TRP or SD priority and a lowest/lower FD priority), a third sub-group (be represented as group #2-1) (for example, a sub-group with a lowest/lower TRP or SD priority and a highest/higher FD priority) and a fourth sub-group (be represented as group #2-2) (for example, a sub-group with a lowest/lower TRP or SD priority and a lowest/lower FD priority).

In one specific example embodiment, the terminal device 220 may firstly calculate priorities based on the TRP index and/or FD basis index and/or layer index. Based on the calculated priorities, the parameters may be divided into a highest/higher TRP or FD or layer priority group (be presented as group #1) and a lowest/lower TRP or FD or layer priority group (be presented as group #2). For each of the group #1 and group #2, the terminal device 220 may further calculate priorities based on the SD basis index. For example, based on the calculated priorities, the parameters may be divided into a first sub-group (be represented as group #1-1) (for example, a sub-group with a highest/higher FD or TRP priority and a highest/higher SD priority), a second sub-group (be represented as group #1-2) (for example, a sub-group with a highest/higher FD or TRP priority and a lowest/lower SD priority), a third sub-group (be represented as group #2-1) (for example, a sub-group with a lowest/lower FD or TRP priority and a highest/higher SD priority) and a fourth sub-group (be represented as group #2-2) (for example, a sub-group with a lowest/lower FD or TRP priority and a lowest/lower SD priority).

In one specific example embodiment, the terminal device 220 may firstly calculate priorities based on the SD basis index and/or layer index. Based on the calculated priorities, the parameters may be divided into a highest/higher SD or layer priority group (be presented as group #1) and a lowest/lower SD or layer priority group (be presented as group #2). For each of the group #1 and group #2, the terminal device 220 may further calculate priorities based on the FD basis index and/or the TRP basis index. For example, based on the calculated priorities, the parameters may be divided into a first sub-group (be represented as group #1-1) (for example, a sub-group with a highest/higher SD or layer priority and a highest/higher FD or TRP priority), a second sub-group (be represented as group #1-2) (for example, a sub-group with a highest/higher SD or layer priority and a lowest/lower FD or TRP priority), a third sub-group (be represented as group #2-1) (for example, a sub-group with a lowest/lower SD or layer priority and a highest/higher FD or TRP priority) and a fourth sub-group (be represented as group #2-2) (for example, a sub-group with a lowest/lower SD or layer priority and a lowest/lower FD or TRP priority).

In one specific example embodiment, the terminal device 220 may firstly calculate priorities based on the FD basis index and/or layer index. Based on the calculated priorities, the parameters may be divided into a highest/higher FD or layer priority group (be presented as group #1) and a lowest/lower FD or layer priority group (be presented as group #2). For each of the group #1 and group #2, the terminal device 220 may further calculate priorities based on the SD basis index and/or the TRP basis index. For example, based on the calculated priorities, the parameters may be divided into a first sub-group (be represented as group #1-1) (for example, a sub-group with a highest/higher FD or layer priority and a highest/higher SD or TRP priority), a second sub-group (be represented as group #1-2) (for example, a sub-group with a highest/higher FD or layer priority and a lowest/lower SD or TRP priority), a third sub-group (be represented as group #2-1) (for example, a sub-group with a lowest/lower FD or layer priority and a highest/higher SD or TRP priority) and a fourth sub-group (be represented as group #2-2) (for example, a sub-group with a lowest/lower FD or layer priority and a lowest/lower SD or TRP priority).

In one specific example embodiment, the terminal device 220 may firstly calculate priorities based on the TRP basis index and/or layer index. Based on the calculated priorities, the parameters may be divided into a highest/higher TRP or layer priority group (be presented as group #1) and a lowest/lower TRP or layer priority group (be presented as group #2). For each of the group #1 and group #2, the terminal device 220 may further calculate priorities based on the FD basis index and/or the SD basis index. For example, based on the calculated priorities, the parameters may be divided into a first sub-group (be represented as group #1-1) (for example, a sub-group with a highest/higher TRP or layer priority and a highest/higher FD or SD priority), a second sub-group (be represented as group #1-2) (for example, a sub-group with a highest/higher TRP or layer priority and a lowest/lower FD or SD priority), a third sub-group (be represented as group #2-1) (for example, a sub-group with a lowest/lower TRP or layer priority and a highest/higher FD or SD priority) and a fourth sub-group (be represented as group #2-2) (for example, a sub-group with a lowest/lower TRP or layer priority and a lowest/lower FD or SD priority).

In some embodiments, the terminal device 220 may firstly calculate priorities based on a first (or second) basis index (a third basis index or a TRP index) and/or layer index. Based on the calculated priorities, the parameters may be divided into a highest/higher priority group (be presented as group #1) and a lowest/lower priority group (be presented as group #2). For each of the group #1 and group #2, the terminal device 220 may secondly calculate priorities based on a third basis index (or a TRP index or a first (or second) basis index). For example, based on the calculated priorities, the parameters may be divided into a first sub-group (be represented as group #1-1), a second sub-group (be represented as group #1-2), a third sub-group (be represented as group #2-1) and a fourth sub-group (be represented as group #2-2). For each of the sub-group #1-1, sub-group #1-2, sub-group #2-1 and sub-group #2-2, the terminal device 220 may thirdly calculate priorities based on a TRP index (or a first (or second) basis index or a third basis index). For example, based on the calculated priorities, the parameters may be divided into a first subset (be represented as group #1-1-1), a second subset (be represented as group #1-1-2), a third subset (be represented as group #1-2-1), a fourth subset (be represented as group #1-2-2), a fifth subset (be represented as group #2-1-1), a sixth subset (be represented as group #2-1-2), a seventh subset (be represented as group #2-2-1) and an eighth subset (be represented as group #2-2-2).

In some embodiments, the terminal device 220 may firstly calculate priorities based on a TRP index and/or layer index. Based on the calculated priorities, the parameters may be divided into a highest/higher priority group (be presented as group #1) and a lowest/lower priority group (be presented as group #2). For each of the group #1 and group #2, the terminal device 220 may secondly calculate priorities based on an FD basis index (or SD basis index) and/or layer index. For example, based on the calculated priorities, the parameters may be divided into a first sub-group (be represented as group #1-1), a second sub-group (be represented as group #1-2), a third sub-group (be represented as group #2-1) and a fourth sub-group (be represented as group #2-2). For each of the sub-group #1-1, sub-group #1-2, sub-group #2-1 and sub-group #2-2, the terminal device 220 may thirdly calculate priorities based on an SD basis index (or an FD basis index) and/or layer index. For example, based on the calculated priorities, the parameters may be divided into a first subset (be represented as group #1-1-1), a second subset (be represented as group #1-1-2), a third subset (be represented as group #1-2-1), a fourth subset (be represented as group #1-2-2), a fifth subset (be represented as group #2-1-1), a sixth subset (be represented as group #2-1-2), a seventh subset (be represented as group #2-2-1) and an eighth subset (be represented as group #2-2-2).

In some embodiments, for a given CSI feedback, the correspondence between the parameters and the other information group of the second partition may be stipulated as below:
The second information group (such as, CSI Group 1): the highest priority parameters of first TRP;
The third information group (such as, CSI Group 2): the lowest priority parameters of the first TRP and all the parameters of the subset of TRPs (excluding the first TRP).

Alternatively, in some embodiments, for a given CSI feedback, the correspondence between the parameters and the other information group of the second partition (such as, CSI part 2) may be stipulated as below:
The second information group (such as, CSI Group 1): all the parameters of the first TRP;
The third information group (such as, CSI Group 2): all the parameters of the subset of TRPs (i.e., the plurality of TRPs excluding the first TRP).

Alternatively, in some embodiments, for a given CSI feedback, the correspondence between the parameters and the other information group of the second partition (such as, CSI part 2) may be stipulated as below:
The second information group (such as, CSI Group 1): all the parameters of the first set of TRPs (including the first TRP);
The third information group (such as, CSI Group 2): all the parameters of the second set of TRPs (not including the first TRP)

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of first TRP;
The third information group (such as, CSI Group 2): the lowest priority parameters of first TRP and highest priority of the subset of TRPs (i.e., the plurality of TRPs with the first TRP excluded);
The fourth information group (such as, CSI Group 3): the lowest priority parameters of the subset of TRPs.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of first TRP;
The third information group (such as, CSI Group 2): the lowest priority parameters of first TRP;
The fourth information group (such as, CSI Group 3): the highest priority parameters of the subset of TRP;
The fifth information group (such as, CSI Group 4): lowest priority of the subset of TRPs.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of first TRP;
The third information group (such as, CSI Group 2): the highest priority parameters of the subset of TRP (i.e., the plurality of TRPs with the first TRP excluded);
The fourth information group (such as, CSI Group 3): the lowest priority parameters of first TRP;
The fifth information group (such as, CSI Group 4): the lowest priority parameters of the subset of TRPs.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of first set of TRPs (i.e., a first set of TRPs including the first TRP);
The third information group (such as, CSI Group 2): the highest priority parameters of the second set of TRPs;
The fourth information group (such as, CSI Group 3): the lowest priority parameters of first set of TRPs;
The fifth information group (such as, CSI Group 4): the lowest priority parameters of the second set of TRPs.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of first set of TRPs (i.e., a first set of TRPs including the first TRP);
The third information group (such as, CSI Group 2): the lowest priority parameters of first set of TRPs;
The fourth information group (such as, CSI Group 3): the highest priority parameters of the second set of TRPs (i.e., a second set of TRPs different from the first set of TRPs);
The fifth information group (such as, CSI Group 4): the lowest priority parameters of the second set of TRPs.

In some embodiments, for a given CSI feedback, the correspondence between the parameters and the other information group of the second partition (such as, CSI part 2) may be stipulated as below to be:
The second information group (such as, CSI Group 1): the highest priority parameters of TRP with index 0;
The third information group (such as, CSI Group 2): the lowest priority parameters of TRP with index 0;
The fourth information group (such as, CSI Group 3): the highest priority parameters of TRP with index 1;
The fifth information group (such as, CSI Group 4): the lowest priority parameters of TRP with index 1;
The information group #(2*N) (such as, CSI Group 2*(N−1)+1): the highest priority parameters of TRP with index N−1;
The information group #(2*N−1) (such as, CSI Group 2*(N−1)): the lowest priority parameters of TRP with index N−1.

In some embodiments, for a given CSI feedback, the correspondence between the parameters and the other information group of the second partition (such as, CSI part 2) may be stipulated as below to be:
The second information group (such as, CSI Group 1): the highest priority parameters of TRP with index 0;
The third information group (such as, CSI Group 2): the highest priority parameters of TRP with index 1;
The information group #(N+1) (such as, CSI Group N): the highest priority parameters of TRP with index N−1;
The information group #(N+2) (such as, CSI Group N+1): the lowest priority parameters of TRP with index 0;
The information group #(N+3) (such as, CSI Group N+2): the lowest priority parameters of TRP with index 1;
The information group #(2*N−1) (such as, CSI Group 2*(N−1)): the lowest priority parameters of TRP with index N−1.

In some embodiments, for a given CSI feedback, the correspondence between the parameters and the other information group of the second partition (such as, CSI part 2) may be stipulated as below to be:
The second information group (such as, CSI Group 1): the highest priority parameters of TRP with index s, i.e., the first TRP;
The third information group (such as, CSI Group 2): the lowest priority parameters of TRP with index s;
The fourth information group (such as, CSI Group 3): the highest priority parameters of TRP with index t_s in increasing order (where t_s is {0,1,2, . . . N−1} excluding s);
The fifth information group (such as, CSI Group 4): lowest priority of TRP with index t_s in increasing order (where t_s is {0,1,2, . . . N−1} excluding s);
And the likes.

It is to be understood that the above examples are illustrated only for the purpose of illustration without suggesting any limitations.

In some embodiments, the CSI feedback comprises a plurality of CSI reports, each of the plurality CSI reports corresponding to a respective CSI-RS allocation of the plurality of CSI-RS allocations. FIG. 4B illustrates an example blocks of CSI feedback 450 according to some embodiments of the present disclosure, where the CSI feedback 450 comprises more than one CSI reports.

In some embodiments, each CSI report indicates at least one of the following:
at least one SD basis corresponding to the respective allocation,
at least one SD rotation factor corresponding to the respective CSI-RS allocation,
at least one amplitude coefficient corresponding to the respective CSI-RS allocation,
at least one phase coefficient corresponding to the respective CSI-RS allocation,
at least one co-amplitude coefficient corresponding to the respective CSI-RS allocation,
at least one co-phasing coefficient corresponding to the respective CSI-RS allocation,
the number of non-zero coefficients corresponding to the respective CSI-RS allocation,
a bitmap of the non-zero coefficients, or
a strongest coefficient for a layer corresponding to the respective allocation.

In some embodiments, if a CSI report of the plurality CSI reports corresponds to a first CSI-RS allocation (i.e., the first TRP), the CSI report further indicates at least one of the following: RI, CQI, and the number of the plurality of CSI-RS allocations.

In some embodiments, the terminal device 220 determines a third priority for a respective CSI report of the at least one CSI report, such that the at least one CSI report may be included into the plurality of partitions. In one specific embodiments, the third priority is determined based on an index of a CSI-RS allocation corresponding to the respective CSI report. Alternatively, in another specific embodiments, the third priority is determined based on a type of the respective CSI report.

In some embodiments, the type of the respective CSI report is one of the following: a CSI report for CJT, a CSI report for a single-TRP transmission hypothesis, a CSI report for a multi-TRP transmission hypothesis, or a CSI report for NCJT.

In one specific embodiment, for CJT CSI feedback, there may be a set of CSI/PMI reports, where the number of CSI/PMI reports may be N (i.e., the same as the number of TRPs), and each CSI/PMI report corresponds to one TRP. In this specific embodiment, each CSI/PMI report comprises at least one of the following: SD bases corresponding to one TRP, SD rotations corresponding to one TRP, amplitude/coefficients corresponding to the TRP, phase coefficients corresponding to the TRP, and at least one of the number of non-zero coefficients corresponding to the TRP, a bitmap of non-zero coefficients corresponding to the TRP, ab SCI corresponding to the TRP, a reference co-phasing/amplitude (related to the first TRP) corresponding to the TRP.

Further, in this specific embodiment, the CSI/PMI report corresponding to the first TRP may further comprise: CQI, RI, SCI corresponding to the first TRP and at least one of a strongest TRP index, the number of TRPs, an overall number of non-zero coefficients (the plurality of TRPs), a bitmap of non-zero coefficients (among TRPs), a reference co-phasing/amplitude coefficients corresponding to the subset of TRPs (i.e., the plurality of TRPs with the first TRP excluded).

In some specific embodiment, the CSI/PMI report corresponding to the first TRP has a higher priority than the other CSI/PMI reports, and the priorities of the other CSI/PMI reports may be based on their TRP indexes. Alternatively, the priorities of the other CSI/PMI reports may be based on a same priority level which is lower than priority of the first TRP.

In some embodiments, if the number of the plurality of CSI-RS allocations is equal to one, the terminal device 220 transmits the CSI feedback via a first uplink resource. Alternatively, if the number of the plurality of CSI-RS allocations is larger than one, the terminal device 220 transmits the CSI feedback via a second uplink resource, wherein any of the first and second the uplink resources is one of a PUSCH or a PUCCH resource.

In some embodiments, the at least one configuration for the CSI feedback indicates the first uplink resource and the second uplink resource.

In some embodiments, a first CSI report carrying CSI for CJT (or a first CSI report with the number of TRPs larger than one, or a first CSI report with an indicator indicating the multi-TRP) may have a higher priority than a second CSI report not carrying CSI for CJT (or a second CSI report with the number of TRPs equals to one, or a second CSI report with an indicator indicating the single-TRP).

Alternatively, in some embodiments, a first CSI report carrying CSI for CJT (or first a CSI report with the number of TRPs larger than one, or a first CSI report with an indicator indicating the multi-TRP) may have a higher priority (or a lower priority) than a third CSI report carrying L1-RSRP or L1-SINR (periodicity, semi-persistent, aperiodic).

In some embodiments, if the terminal device 220 is configured/indicated to report a first CSI for CJT, the terminal device 220 may not report a second CSI (not carrying CSI for CJT and/or not carrying L1-RSRP or L1-SINR), wherein the time resource for the first CSI and the time resource for the second CSI may collide or overlap and/or may be on same carrier.

In some embodiments, if a terminal device 220 is configured/indicated to report a first CSI for CJT, and if the first CSI for CJT indicates single-TRP hypothesis or indicates the number of TRPs to be 1, the first CSI may corresponds to a first priority, and if the first CSI for CJT indicates multi-TRP hypothesis or indicates the number of TRPs to be larger than 1, the first CSI may corresponds to a second priority.

In some embodiments, a parameter may be introduced for priority rules determination for CSI reports for CJT. Specifically, if the first CSI indicates single-TRP hypothesis or indicates that the number of TRPs is equal to 1, a first value is applied for the parameter, and if the first CSI for CJT indicates multi-TRP hypothesis or indicates that the number of TRPs is larger than one, a second value is applied for the parameter. In one specific embodiments, the first value is larger than or smaller than the second value. Alternatively, the first priority is higher than or lower than the second priority.

In some embodiments, the terminal device 220 may report the number of selected TRPs, or report an indication of single-TRP transmission or multi-TRP transmission (i.e., CJT). In some embodiments, the resource used for the CSI feedback (such as, the PUCCH resource ID and/or size of PUCCH/PUSCH time/frequency resource) depends on the number of selected TRPs or the indication of single-TRP or multi-TRP transmission.

In some embodiments, the first resource used for the CSI feedback in case of single-TRP hypothesis may be smaller than the second resource used for the CSI feedback in case of multi-TRP hypothesis.

In some embodiments, a first size of the first resource used for the CSI feedback in case of a first number of selected TRPs (be presented as S1, S1 is a positive integer) may be smaller than the second resource used for the CSI feedback in case of a second number of selected TRPs (be presented as S2, S2 is a positive integer), where S1≤S2.

In some embodiments, the terminal device 220 transmits a first portion of the parameters on a channel with a first type, and transmits a second portion of the parameters on a channel with a second type.

In some embodiments, a resource combination of PUCCH and PUSCH may be used for CSI feedback. In some embodiments, For CJT CSI feedback, a subset of PMIs or a subset of the CSI for CJT may be reported on PUCCH resource. In one specific embodiments, the subset of PMIs or the subset of the CSI may include at least one of CSI part 1, group 0 of CSI part 2. Alternatively, in another specific embodiments, the subset of PMIs or the subset of the CSI may include at least one of the SD basis indications, SD rotation indications, the number of selected TRPs, indexes of selected TRPs, an indication of single-TRP or multi-TRP, the strongest TRP index and an RI.

Accordingly, in some embodiments, the other PMIs or other subsets of CSI for CJT may be reported on PUSCH, and the CSI reports for CJT carried on the PUSCH can be calculated based on the latest CSI reports for CJT carried on PUCCH (e.g. PUCCH format 3 or 4.). Alternatively, in some embodiments, all PMIs or the whole CSI for CJT may be reported on PUSCH.

In some embodiments, if a terminal device reports a CSI feedback for CJT (e.g. reports a number of selected TRPs or reports an indicator of single-TRP or multi-TRP), the TCI state(s) indication for PDSCH scheduling and/or the TCI state(s) for downlink transmission may be based on the CSI (based on the number of selected TRPs or the indicator).

For example, if the number of selected TRPs is one or the indication indicates single-TRP hypothesis, the TCI state(s) indication for PDSCH scheduling and/or the TCI state(s) for downlink transmission may be single-TRP or one TCI state is indicated.

For another example, if the number of selected TRPs is larger than one or the indication indicates multi-TRP hypothesis, the TCI state(s) indication for PDSCH scheduling and/or the TCI state(s) for downlink transmission may be multi-TRP or more than one TCI state is indicated.

### Example of Methods

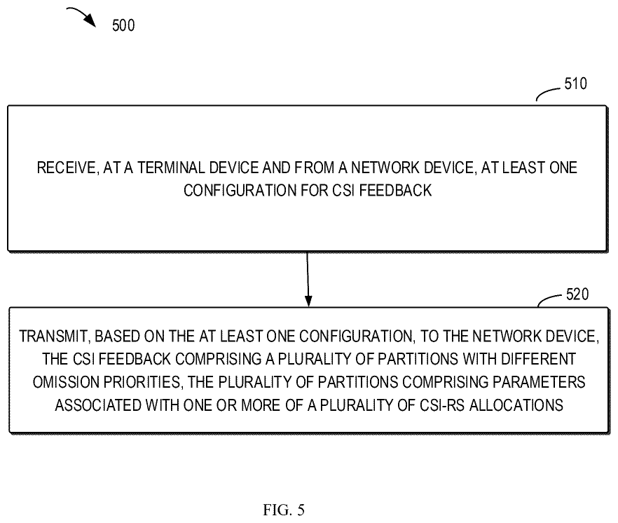

FIG. 5 illustrates a flowchart of an example method 500 in accordance with some embodiments of the present disclosure. For example, the method 500 can be implemented at the terminal device 220 as shown in FIG. 2A.

At block 510, the terminal device 220 receives at least one configuration for CSI feedback from a network device 210.

At block 520, the terminal device 220 transmits the CSI feedback to the network device 210 based on the at least one configuration. The CSI feedback comprises a plurality of partitions with different omission priorities, and the plurality of partitions comprise parameters associated with one or more of a plurality of CSI-RS allocations.

In some embodiments, the terminal device 220 determines, priorities comprising at least one of the following: a respective first priority for a CSI-RS allocation of the plurality of CSI-RS allocations, or a respective second priority for a parameter of the parameters comprised in the CSI feedback. the terminal device 220 generates the CSI feedback based on the priorities. In other words, the terminal device 220 generates the CSI feedback by including, based on the priorities, the parameters into the plurality of partitions of the CSI feedback.

In some embodiments, the terminal device 220 determines the priorities based on an index of a CSI-RS resource.

Alternatively, or in addition, in some embodiments, the terminal device 220 determines the priorities based on an index of a CSI-RS resource group.

Alternatively, or in addition, in some embodiments, the terminal device 220 determines the priorities based on an index of a group of CSI-RS ports.

Alternatively, or in addition, in some embodiments, the terminal device 220 determines the priorities based on an index of an SD basis.

In some embodiments, different factors are configured with different contributions when determining the priorities.

In some embodiments, the terminal device 220 prioritizes parameters associated with a first CSI-RS allocation of the plurality of CSI-RS allocations.

Alternatively, or in addition, in some embodiments, the terminal device 220 prioritizes parameters associated with a first CSI-RS allocation group comprising the first CSI-RS allocation.

Alternatively, or in addition, in some embodiments, the terminal device 220 prioritizes parameters associated with a first group of CSI-RS ports corresponding to the first CSI-RS allocation.

Alternatively, or in addition, in some embodiments, the terminal device 220 prioritizes parameters associated with a second group of CSI-RS ports corresponding to the first CSI-RS allocation group.

In some embodiments, the first CSI-RS allocation corresponds to a primary TRP.

Alternatively, or in addition, in some embodiments, the first CSI-RS allocation corresponds to a TRP with index value of 0.

Alternatively, or in addition, in some embodiments, the first CSI-RS allocation corresponds to a TRP with strongest amplitude coefficient.

Alternatively, or in addition, in some embodiments, the first CSI-RS allocation corresponds to a TRP with the maximum power.

In some embodiments, the plurality of partitions at least comprises a first partition and a second partition, and the first partition is configured with a higher omission priority compared with the second partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a payload size of the second partition is based on at least one indication in the first partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a second partition comprises a plurality of information groups, a first information group of the plurality of information groups configured with a higher omission priority compared with the other information groups of the plurality of information groups. The first information group of the second partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates a strongest coefficient for a layer corresponding to the first CSI-RS allocation.

Alternatively, or in addition, in some embodiments, the first information group of the second partition indicates respective strongest coefficient for a layer corresponding to the plurality of CSI-RS allocations.

Alternatively, or in addition, in some embodiments, the first information group of the second partition indicates at least one SD basis corresponding to the first CSI-RS allocation.

Alternatively, or in addition, in some embodiments, the first information group of the second partition indicates at least one SD rotation factor corresponding to the first CSI-RS allocation.

Alternatively, or in addition, in some embodiments, the first information group of the second partition indicates a fifth number of the non-zero coefficients corresponding to the plurality of CSI-RS allocations with the first CSI-RS allocation excluded.

In some embodiments, the other information groups of the plurality of information groups indicate at least one co-amplitude coefficient associated with the plurality of CSI-RS allocations with the first CSI-RS allocation included or excluded.

Alternatively, or in addition, in some embodiments, the other information groups of the plurality of information groups indicate at least one co-phasing coefficient associated with the plurality of CSI-RS allocations with the first CSI-RS allocation included or excluded.

Alternatively, or in addition, in some embodiments, the other information groups of the plurality of information groups indicate respective strongest coefficient for a layer corresponding to the plurality of CSI-RS allocations with the first CSI-RS allocation excluded.

Alternatively, or in addition, in some embodiments, the other information groups of the plurality of information groups indicate at least one spatial domain (SD) basis corresponding to each of the plurality of CSI-RS allocations with the first CSI-RS allocation excluded.

Alternatively, or in addition, in some embodiments, the other information groups of the plurality of information groups indicate at least one SD rotation factor corresponding to each of the plurality of CSI-RS allocations with the first CSI-RS allocation excluded.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first CSI-RS allocation of the plurality of CSI-RS allocations, the plurality of CSI-RS allocations with the first CSI-RS allocation excluded, a first CSI-RS allocation group comprising the first CSI-RS allocation, or a second CSI-RS allocation group different from the fist CSI-RS allocation group, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, the terminal device 220 determines a third priority for a respective CSI report of the at least one CSI report based on an index of a CSI-RS allocation corresponding to the respective CSI report.

Alternatively, or in addition, in some embodiments, the terminal device 220 determines a third priority for a respective CSI report of the at least one CSI report based on a type of the respective CSI report.

In some embodiments, the type of the respective CSI report is one of the following: a CSI report for CJT, a CSI report for a single-TRP transmission hypothesis, a CSI report for a multi-TRP transmission hypothesis, or NCJT.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: a RI, CQI, or the number of the plurality of CSI-RS allocations.

In some embodiments, if the number of the plurality of CSI-RS allocations is equals to one, the terminal device 220 transmits the CSI feedback via a first uplink resource.

In some embodiments, if the number of the plurality of CSI-RS allocations is larger than one, the terminal device 220 transmits the CSI feedback via a second uplink resource, wherein any of the first and second the uplink resources is one of a PUSCH resource or a PUCCH resource.

In some embodiments, the at least one configuration for the CSI feedback indicates at least one of the first uplink resource or the second uplink resource.

In some embodiments, the terminal device 220 transmits a first portion of the parameters on a channel with a first type.

In some embodiments, the terminal device 220 transmits a second portion of the parameters on a channel with a second type.

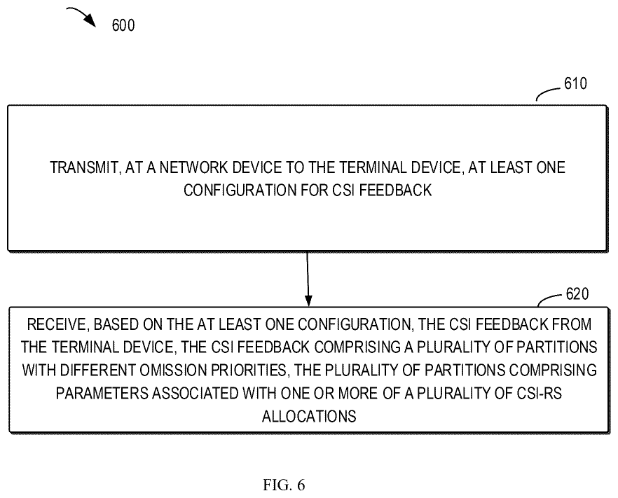

FIG. 6 illustrates a flowchart of an example method 600 in accordance with some embodiments of the present disclosure. For example, the method 600 can be implemented at the network device 210 as shown in FIG. 2A.

At block 610, the network device 210 transmits at least one configuration for CSI feedback to the terminal device 220.

At block 620, the network device 210 receives the CSI feedback from the terminal device 220 based on the at least one configuration. The CSI feedback comprises a plurality of partitions with different omission priorities, the plurality of partitions comprise parameters associated with one or more of a plurality of CSI-RS allocations.

In some embodiments, the plurality of partitions at least comprises a first partition and a second partition, and the first partition is configured with a higher omission priority compared with the second partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a payload size of the second partition is based on at least one indication in the first partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a second partition comprises a plurality of information groups, a first information group of the plurality of information groups configured with a higher omission priority compared with the other information groups of the plurality of information groups. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates a strongest coefficient for a layer corresponding to the first CSI-RS allocation.

Alternatively, or in addition, in some embodiments, the first information group of the second partition indicates respective strongest coefficient for a layer corresponding to the plurality of CSI-RS allocations.

Alternatively, or in addition, in some embodiments, the first information group of the second partition indicates at least one SD basis corresponding to the first CSI-RS allocation.

Alternatively, or in addition, in some embodiments, the first information group of the second partition indicates at least one SD rotation factor corresponding to the first CSI-RS allocation.

Alternatively, or in addition, in some embodiments, the first information group of the second partition indicates a fifth number of the non-zero coefficients corresponding to the plurality of CSI-RS allocations with the first CSI-RS allocation excluded.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first CSI-RS allocation of the plurality of CSI-RS allocations, the plurality of CSI-RS allocations with the first CSI-RS allocation excluded, a first CSI-RS allocation group comprising the first CSI-RS allocation, or a second CSI-RS allocation group different from the fist CSI-RS allocation group, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: RI, CQI or the number of the plurality of CSI-RS allocations.

In some embodiments, if the number of the plurality of CSI-RS allocations is equals to one, the network device 210 receives the CSI feedback via a first uplink resource.

In some embodiments, if the number of the plurality of CSI-RS allocations is larger than one, the network device 210 receives the CSI feedback via a second uplink resource, wherein any of the first and second the uplink resources is one of a physical uplink shared channel (PUSCH) resource or a physical uplink control channel (PUCCH) resource.

In some embodiments, the at least one configuration for the CSI feedback indicates at least one of the first uplink resource or the second uplink resource.

In some embodiments, the network device 210 receives a first portion of the parameters on a channel with a first type, and receives a second portion of the parameters on a channel with a second type.

### Example of Apparatuses and Devices

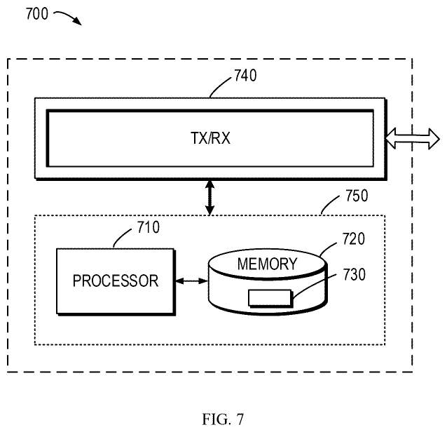

FIG. 7 is a simplified block diagram of a device 700 that is suitable for implementing embodiments of the present disclosure. The device 700 can be considered as a further example implementation of the terminal device 220 or the network device 210 as shown in FIG. 2. Accordingly, the device 700 can be implemented at or as at least a part of the terminal device 220 or the network device 210.

As shown, the device 700 includes a processor 710, a memory 720 coupled to the processor 710, a suitable transmitter (TX)/receiver (RX) 740 coupled to the processor 710, and a communication interface coupled to the TX/RX 740. The memory 710 stores at least apart of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 2 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 770 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device 220 comprises a circuitry configured to receive at least one configuration for CSI feedback from a network device 210; and transmit the CSI feedback to the network device 210 based on the at least one configuration. The CSI feedback comprises a plurality of partitions with different omission priorities, and the plurality of partitions comprise parameters associated with one or more of a plurality of CSI-RS allocations.

In some embodiments, the circuitry is further configured to determine, priorities comprising at least one of the following: a respective first priority for a CSI-RS allocation of the plurality of CSI-RS allocations, or a respective second priority for a parameter of the parameters comprised in the CSI feedback. the terminal device 220 generates the CSI feedback based on the priorities. In the other words, the terminal device 220 generates the CSI feedback by including, based on the priorities, the parameters into the plurality of partitions of the CSI feedback.

In some embodiments, the circuitry is further configured to determine the priorities based on an index of a CSI-RS resource.

Alternatively, or in addition, in some embodiments, the circuitry is further configured to determine the priorities based on an index of a CSI-RS resource group.

Alternatively, or in addition, in some embodiments, the circuitry is further configured to determine the priorities based on an index of a group of CSI-RS ports.

Alternatively, or in addition, in some embodiments, the circuitry is further configured to determine the priorities based on an index of an SD basis.

In some embodiments, different factors are configured with different contributions when determining the priorities.

In some embodiments, the circuitry is further configured to prioritize parameters associated with a first CSI-RS allocation of the plurality of CSI-RS allocations.

Alternatively, or in addition, in some embodiments, the circuitry is further configured to prioritize parameters associated with a first CSI-RS allocation group comprising the first CSI-RS allocation.

Alternatively, or in addition, in some embodiments, the circuitry is further configured to prioritize parameters associated with a first group of CSI-RS ports corresponding to the first CSI-RS allocation.

Alternatively, or in addition, in some embodiments, the circuitry is further configured to prioritize parameters associated with a second group of CSI-RS ports corresponding to the first CSI-RS allocation group.

In some embodiments, the first CSI-RS allocation corresponds to a primary TRP.

Alternatively, or in addition, in some embodiments, the first CSI-RS allocation corresponds to a TRP with index value of 0.

Alternatively, or in addition, in some embodiments, the first CSI-RS allocation corresponds to a TRP with strongest amplitude coefficient.

Alternatively, or in addition, in some embodiments, the first CSI-RS allocation corresponds to a TRP with the maximum power.

In some embodiments, the plurality of partitions at least comprises a first partition and a second partition, and the first partition is configured with a higher omission priority compared with the second partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a payload size of the second partition is based on at least one indication in the first partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a second partition comprises a plurality of information groups, a first information group of the plurality of information groups configured with a higher omission priority compared with the other information groups of the plurality of information groups. The first information group of the second partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates a strongest coefficient for a layer corresponding to the first CSI-RS allocation.

Alternatively, or in addition, in some embodiments, the first information group of the second partition indicates respective strongest coefficient for a layer corresponding to the plurality of CSI-RS allocations.

Alternatively, or in addition, in some embodiments, the first information group of the second partition indicates at least one SD basis corresponding to the first CSI-RS allocation.

Alternatively, or in addition, in some embodiments, the first information group of the second partition indicates at least one SD rotation factor corresponding to the first CSI-RS allocation.

Alternatively, or in addition, in some embodiments, the first information group of the second partition indicates a fifth number of the non-zero coefficients corresponding to the plurality of CSI-RS allocations with the first CSI-RS allocation excluded.

In some embodiments, the other information groups of the plurality of information groups indicate at least one co-amplitude coefficient associated with the plurality of CSI-RS allocations with the first CSI-RS allocation included or excluded.

Alternatively, or in addition, in some embodiments, the other information groups of the plurality of information groups indicate at least one co-phasing coefficient associated with the plurality of CSI-RS allocations with the first CSI-RS allocation included or excluded.

Alternatively, or in addition, in some embodiments, the other information groups of the plurality of information groups indicate respective strongest coefficient for a layer corresponding to the plurality of CSI-RS allocations with the first CSI-RS allocation excluded.

Alternatively, or in addition, in some embodiments, the other information groups of the plurality of information groups indicate at least one spatial domain (SD) basis corresponding to each of the plurality of CSI-RS allocations with the first CSI-RS allocation excluded.

Alternatively, or in addition, in some embodiments, the other information groups of the plurality of information groups indicate at least one SD rotation factor corresponding to each of the plurality of CSI-RS allocations with the first CSI-RS allocation excluded.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first CSI-RS allocation of the plurality of CSI-RS allocations, the plurality of CSI-RS allocations with the first CSI-RS allocation excluded, a first CSI-RS allocation group comprising the first CSI-RS allocation, or a second CSI-RS allocation group different from the fist CSI-RS allocation group, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, the circuitry is further configured to determine a third priority for a respective CSI report of the at least one CSI report based on an index of a CSI-RS allocation corresponding to the respective CSI report.

Alternatively, or in addition, in some embodiments, the circuitry is further configured to determine a third priority for a respective CSI report of the at least one CSI report based on a type of the respective CSI report.

In some embodiments, the type of the respective CSI report is one of the following: a CSI report for CJT, a CSI report for a single-TRP transmission hypothesis, a CSI report for a multi-TRP transmission hypothesis, or NCJT.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: a RI, CQI, or the number of the plurality of CSI-RS allocations.

In some embodiments, if the number of the plurality of CSI-RS allocations is equals to one, the terminal device 220 transmits the CSI feedback via a first uplink resource.

In some embodiments, if the number of the plurality of CSI-RS allocations is larger than one, the terminal device 220 transmits the CSI feedback via a second uplink resource, wherein any of the first and second the uplink resources is one of a PUSCH resource or a PUCCH resource.

In some embodiments, the at least one configuration for the CSI feedback indicates at least one of the first uplink resource or the second uplink resource.

In some embodiments, the circuitry is further configured to transmit a first portion of the parameters on a channel with a first type.

In some embodiments, the circuitry is further configured to transmit a second portion of the parameters on a channel with a second type.

In some embodiments, a network device 210 comprises a circuitry configured to: transmit at least one configuration for CSI feedback to the terminal device 220; and receive the CSI feedback from the terminal device 220 based on the at least one configuration. The CSI feedback comprises a plurality of partitions with different omission priorities, the plurality of partitions comprise parameters associated with one or more of a plurality of CSI-RS allocations.

In some embodiments, the plurality of partitions at least comprises a first partition and a second partition, and the first partition is configured with a higher omission priority compared with the second partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a payload size of the second partition is based on at least one indication in the first partition. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the plurality of partitions at least comprises a first partition and a second partition, and a second partition comprises a plurality of information groups, a first information group of the plurality of information groups configured with a higher omission priority compared with the other information groups of the plurality of information groups. The first partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates a strongest coefficient for a layer corresponding to the first CSI-RS allocation.

Alternatively, or in addition, in some embodiments, the first information group of the second partition indicates respective strongest coefficient for a layer corresponding to the plurality of CSI-RS allocations.

Alternatively, or in addition, in some embodiments, the first information group of the second partition indicates at least one SD basis corresponding to the first CSI-RS allocation.

Alternatively, or in addition, in some embodiments, the first information group of the second partition indicates at least one SD rotation factor corresponding to the first CSI-RS allocation.

Alternatively, or in addition, in some embodiments, the first information group of the second partition indicates a fifth number of the non-zero coefficients corresponding to the plurality of CSI-RS allocations with the first CSI-RS allocation excluded.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first CSI-RS allocation of the plurality of CSI-RS allocations, the plurality of CSI-RS allocations with the first CSI-RS allocation excluded, a first CSI-RS allocation group comprising the first CSI-RS allocation, or a second CSI-RS allocation group different from the fist CSI-RS allocation group, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: RI, CQI or the number of the plurality of CSI-RS allocations.

In some embodiments, if the number of the plurality of CSI-RS allocations is equals to one, the network device 210 receives the CSI feedback via a first uplink resource.

In some embodiments, if the number of the plurality of CSI-RS allocations is larger than one, the network device 210 receives the CSI feedback via a second uplink resource, wherein any of the first and second the uplink resources is one of a physical uplink shared channel (PUSCH) resource or a physical uplink control channel (PUCCH) resource.

In some embodiments, the at least one configuration for the CSI feedback indicates at least one of the first uplink resource or the second uplink resource.

In some embodiments, the circuitry is further configured to receive a first portion of the parameters on a channel with a first type, and receive a second portion of the parameters on a channel with a second type.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: receiving, at a terminal device and from a network device, at least one configuration for CSI feedback; and transmitting, based on the at least one configuration, the CSI feedback to the network device, the CSI feedback comprising a plurality of partitions with different omission priorities, the plurality of partitions comprising parameters associated with one or more of a plurality of CSI-RS allocations.

In some embodiments, the method further comprises: determining, priorities comprising at least one of the following: a respective first priority for a CSI-RS allocation of the plurality of CSI-RS allocations, or a respective second priority for a parameter of the parameters comprised in the CSI feedback; and generating the CSI feedback based on the priorities.

In some embodiments, transmitting the CSI feedback comprises: determining, priorities comprising at least one of the following: a respective first priority for a CSI-RS allocation of the plurality of CSI-RS allocations, or a respective second priority for a parameter of the parameters comprised in the CSI feedback; and generating, the CSI feedback by including, based on the priorities, the parameters into the plurality of partitions of the CSI feedback.

In some embodiments, determining the priorities comprises: determining the priorities based on factors including at least one of the following: an index of a CSI-RS resource, an index of a CSI-RS resource group, an index of a group of CSI-RS ports, or an index of an SD basis.

In some embodiments, different factors are configured with different contributions when determining the priorities.

In some embodiments, determining the priorities comprises: prioritizing parameters associated with one of the following: a first CSI-RS allocation of the plurality of CSI-RS allocations, a first CSI-RS allocation group comprising the first CSI-RS allocation, a first group of CSI-RS ports corresponding to the first CSI-RS allocation, or a second group of CSI-RS ports corresponding to the first CSI-RS allocation group.

In some embodiments, the first CSI-RS allocation corresponds to one of the following: a primary TRP, a TRP with index value of 0, a TRP with strongest amplitude coefficient, or a TRP with the maximum power.

In some embodiments, the plurality of partitions at least comprises a first partition and a second partition, wherein, the first partition is configured with a higher omission priority compared with the second partition, a payload size of the second partition is based on at least one indication in the first partition, or a second partition comprises a plurality of information groups, a first information group of the plurality of information groups configured with a higher omission priority compared with the other information groups of the plurality of information groups, and wherein one of the first partition and the first information group of the second partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates at least one of the following: a strongest coefficient for a layer corresponding to the first CSI-RS allocation, respective strongest coefficient for a layer corresponding to the plurality of CSI-RS allocations, at least one SD basis corresponding to the first CSI-RS allocation, at least one SD rotation factor corresponding to the first CSI-RS allocation, or a fifth number of the non-zero coefficients corresponding to the plurality of CSI-RS allocations with the first CSI-RS allocation excluded.

In some embodiments, the other information groups of the plurality of information groups indicate at least one of the following: at least one co-amplitude coefficient associated with the plurality of CSI-RS allocations with the first CSI-RS allocation included or excluded, at least one co-phasing coefficient associated with the plurality of CSI-RS allocations with the first CSI-RS allocation included or excluded, respective strongest coefficient for a layer corresponding to the plurality of CSI-RS allocations with the first CSI-RS allocation excluded, at least one SD basis corresponding to each of the plurality of CSI-RS allocations with the first CSI-RS allocation excluded, or at least one SD rotation factor corresponding to each of the plurality of CSI-RS allocations with the first CSI-RS allocation excluded.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first CSI-RS allocation of the plurality of CSI-RS allocations, the plurality of CSI-RS allocations with the first CSI-RS allocation excluded, a first CSI-RS allocation group comprising the first CSI-RS allocation, or a second CSI-RS allocation group different from the fist CSI-RS allocation group, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, and wherein the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, the method further comprises: determining a third priority for a respective CSI report of the at least one CSI report based on at least one of the following: an index of a CSI-RS allocation corresponding to the respective CSI report, or a type of the respective CSI report.

In some embodiments, the type of the respective CSI report is one of the following: a CSI report for CJT, a CSI report for a single-TRP transmission hypothesis, a CSI report for a multi-TRP transmission hypothesis, or a CSI report for NCJT.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: RI, CQI, or the number of the plurality of CSI-RS allocations.

In some embodiments, transmitting the CSI feedback to the network device comprises: if the number of the plurality of CSI-RS allocations is equals to one, transmitting the CSI feedback via a first uplink resource, and if the number of the plurality of CSI-RS allocations is larger than one, transmitting the CSI feedback via a second uplink resource, wherein any of the first and second the uplink resources is one of a PUSCH resource or a PUCCH resource.

In some embodiments, the at least one configuration for the CSI feedback indicates at least one of the first uplink resource or the second uplink resource.

In some embodiments, transmitting the CSI feedback to the network device comprises transmitting a first portion of the parameters on a channel with a first type, and transmitting a second portion of the parameters on a channel with a second type.

In one solution, a method of communication, comprising: transmitting, at a network device to the terminal device, at least one configuration for CSI feedback; and receiving, based on the at least one configuration, the CSI feedback from the terminal device, the CSI 1s feedback comprising a plurality of partitions with different omission priorities, the plurality of partitions comprising parameters associated with one or more of a plurality of CSI-RS allocations.

In some embodiments, the plurality of partitions at least comprises a first partition and a second partition, wherein the first partition is configured with a higher omission priority compared with the second partition, a payload size of the second partition is based on at least one indication in the first partition, or a second partition comprises a plurality of information groups, a first information group of the plurality of information groups configured with a higher omission priority compared with the other information groups of the plurality of information groups, and wherein one of the first partition and the first information group of the second partition indicates at least one of the following: a first index of a first CSI-RS allocation of the plurality of CSI-RS allocations, a second index of a first CSI-RS resource group comprising the first CSI-RS allocation, a plurality of respective third indexes of the plurality of CSI-RS allocations, a first number of the non-zero coefficients corresponding to the first CSI-RS allocation, a second number of the non-zero coefficients corresponding to the first CSI-RS group allocation, a third number of the non-zero coefficients corresponding to the plurality of CSI-RS allocations, a fourth number indication indicating the number of the plurality of CSI-RS allocations.

In some embodiments, the first information group of the second partition indicates at least one of the following: a strongest coefficient for a layer corresponding to the first CSI-RS allocation, respective strongest coefficient for a layer corresponding to the plurality of CSI-RS allocations, at least one SD basis corresponding to the first CSI-RS allocation, at least one SD rotation factor corresponding to the first CSI-RS allocation, or a fifth number of the non-zero coefficients corresponding to the plurality of CSI-RS allocations with the first CSI-RS allocation excluded.

In some embodiments, the other information groups of the plurality of information groups indicate at least one of the following: at least one co-amplitude coefficient associated with the plurality of CSI-RS allocations with the first CSI-RS allocation included or excluded, at least one co-phasing coefficient associated with the plurality of CSI-RS allocations with the first CSI-RS allocation included or excluded, respective strongest coefficient for a layer corresponding to the plurality of CSI-RS allocations with the first CSI-RS allocation excluded, at least one SD basis corresponding to each of the plurality of CSI-RS allocations with the first CSI-RS allocation excluded, or at least one SD rotation factor corresponding to each of the plurality of CSI-RS allocations with the first CSI-RS allocation excluded.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of CSI-RS allocations, the first allocation of the plurality of CSI-RS allocations, the plurality of CSI-RS allocations with the first CSI-RS allocation excluded, a first CSI-RS allocation group comprising the first CSI-RS allocation, or a second CSI-RS allocation group excluding the first CSI-RS allocation, amplitude coefficients corresponding to the non-zero coefficients, or phase coefficients corresponding to the non-zero coefficients.

In some embodiments, the other information groups of the plurality of information groups comprise a second information group and a third information group with a lower omission priority compared with the second information group, and wherein the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective CSI-RS allocation of the plurality of CSI-RS allocations.

In some embodiments, each CSI report indicates at least one of the following: at least one SD basis corresponding to the respective allocation, at least one SD rotation factor corresponding to the respective CSI-RS allocation, at least one amplitude coefficient corresponding to the respective CSI-RS allocation, at least one phase coefficient corresponding to the respective CSI-RS allocation, at least one co-amplitude coefficient corresponding to the respective CSI-RS allocation, at least one co-phasing coefficient corresponding to the respective CSI-RS allocation, the number of non-zero coefficients corresponding to the respective CSI-RS allocation, a bitmap of the non-zero coefficients, or a strongest coefficient for a layer corresponding to the respective allocation.

In some embodiments, if a CSI report of the plurality CSI reports corresponds to a first CSI-RS allocation of the plurality of CSI-RS allocations, the CSI report indicates at least one of the following: a RI, a CQI, or the number of the plurality of CSI-RS allocations.

In some embodiments, receiving the CSI feedback from the terminal device comprises: if the number of the plurality of CSI-RS allocations is equals to one, receiving the CSI feedback via a first uplink resource, and if the number of the plurality of CSI-RS allocations is larger than one, receiving the CSI feedback via a second uplink resource, wherein any of the first and second the uplink resources is one of a PUSCH resource or a PUCCH resource.

In some embodiments, the at least one configuration for the CSI feedback indicates at least one of the first uplink resource or the second uplink resource.

In some embodiments, receiving the CSI feedback from the terminal device comprises: receiving a first portion of the parameters on a channel with a first type, and receiving a second portion of the parameters on a channel with a second type.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, the method comprising:
receiving, from a network device, a configuration for a channel state information (CSI) report; and
transmitting, to the network device, a CSI report comprising a plurality of reported elements, wherein each reported element of the plurality of reported elements is indexed by an index of a CSI-reference signal (RS) resource in a first plurality of CSI-RS resources and the each reported element is associated with a priority value, the priority value is determined based on the index of the CSI-RS resource.

22. The method of claim 21, wherein the each reported element is further indexed by a layer index, an index associated with both of a first vector and the index of the CSI-RS resource, and an index of a second vector, the priority value is determined further based on the layer index, the index associated with both of the first vector and the index of the CSI-RS resource, and the index of the second vector.

23. The method of claim 21, wherein the priority value equals to 2·X·vᵣᵢ·π(f)+vᵣᵢ·(2·Y+iₜ)+r,
wherein X is a number of a first vector associated with the first plurality of CSI-RS resources, f is an index of a second vector, Y is a number of the first vector associated with the CSI-RS resource, it is an index associated with both of the first vector and the index of the CSI-RS resource, r is a layer index, r=1, 2, . . . , vᵣᵢ.

24. The method of claim 21, wherein the CSI report comprises a first part and a second part, the second part comprises a payload size determined based on the first part, and the first part comprises an indication of a first plurality of CSI-RS resources.

25. The method of claim 24, wherein the second part further comprises a first group, a second group and a third group, the first group has a higher priority than the second group, the second group has a higher priority than the third group, the plurality of reported elements comprises a plurality of reported elements of a bitmap, the second group comprises a first part of the plurality of reported elements of the bitmap with higher priority than a second part of the plurality of reported elements of the bitmap, the first part of the plurality of reported elements of the bitmap is determined based on the first plurality of CSI-RS resources.

26. The method of claim 25, wherein the second group comprises a plurality of offsets associated with the first plurality of CSI-RS resources.

27. The method of claim 21, wherein the CSI report comprises a precoding matrix indicator (PMI), the PMI is determined from a first number of a first vector and a second number of a second vector, the first number is associated with the first plurality of CSI-RS resources.

28. The method of claim 21, wherein the configuration indicates a second plurality of CSI-RS resources, a number of the first plurality of CSI-RS resources is less than or equal to a number of the second plurality of CSI-RS resources.

29. The method of claim 21, wherein the plurality of reported elements comprises at least one of:
a first plurality of reported elements of an amplitude coefficient indicator;
a second plurality of reported elements of a phase coefficient indicator; and
a third plurality of reported elements of a bitmap, the bitmap is used to indicate which coefficient in the amplitude coefficient indicator and the phase coefficient indicator is reported.

30. A method performed by a network device, the method comprising:
transmitting, to a terminal device, a configuration for a channel state information (CSI) report; and
receiving, from the terminal device, CSI report comprising a plurality of reported elements, wherein each reported element of the plurality of reported elements is indexed by an index of a CSI-reference signal (RS) resource in a first plurality of CSI-RS resources and the each reported element is associated with a priority value, the priority value is determined based on the index of the CSI-RS resource.

31. The method of claim 30, wherein the each reported element is further indexed by a layer index, an index associated with both of a first vector and the index of the CSI-RS resource, and an index of a second vector, the priority value is determined further based on the layer index, the index associated with both of the first vector and the index of the CSI-RS resource, and the index of the second vector.

32. The method of claim 30, wherein the priority value equals to 2·X·vᵣᵢ·π(f)+vᵣᵢ·(2·Y+iₜ)+r,
wherein X is a number of a first vector associated with the first plurality of CSI-RS resources, f is an index of a second vector, Y is a number of the first vector associated with the CSI-RS resource, iₜ is an index associated with both of the first vector and the index of the CSI-RS resource, r is a layer index, r=1, 2, . . . , vᵣᵢ.

33. The method of claim 30, wherein the CSI report comprises a first part and a second part, the second part comprises a payload size determined based on the first part, and the first part comprises an indication of a first plurality of CSI-RS resources.

34. The method of claim 33, wherein the second part further comprises a first group, a second group and a third group, the first group has a higher priority than the second group, the second group has a higher priority than the third group, the plurality of reported elements comprises a plurality of reported elements of a bitmap, the second group comprises a first part of the plurality of reported elements of the bitmap with higher priority than a second part of the plurality of reported elements of the bitmap, the first part of the plurality of reported elements of the bitmap is determined based on the first plurality of CSI-RS resources.

35. The method of claim 34, wherein the second group comprises a plurality of offsets associated with the first plurality of CSI-RS resources.

36. The method of claim 30, wherein the CSI report comprises a precoding matrix indicator (PMI), the PMI is determined from a first number of a first vector and a second number of a second vector, the first number is associated with the first plurality of CSI-RS resources.

37. The method of claim 30, wherein the configuration indicates a second plurality of CSI-RS resources, a number of the first plurality of CSI-RS resources is less than or equal to a number of the second plurality of CSI-RS resources.

38. The method of claim 30, wherein the plurality of reported elements comprises at least one of:
a first plurality of reported elements of an amplitude coefficient indicator;
a second plurality of reported elements of a phase coefficient indicator; and
a third plurality of reported elements of a bitmap, the bitmap is used to indicate which coefficient in the amplitude coefficient indicator and the phase coefficient indicator is reported.

39. A terminal device, comprising:
a processor configured to cause the terminal device to:
receive, from a network device, a configuration for a channel state information (CSI) report; and
transmit, to the network device, CSI report comprising a plurality of reported elements, wherein each reported element of the plurality of reported elements is indexed by an index of a CSI-reference signal (RS) resource in a first plurality of CSI-RS resources and the each reported element is associated with a priority value, the priority value is determined based on the index of the CSI-RS resource.
